(19) United States
(12) Patent Application Publication
(10) Pub. No.: US 2026/0134217 A1
(43) Pub. Date: May 14, 2026

(54) ERROR DETECTION IN OBJECT RECOGNITION INFERENCES USING NEURAL NETWORK GENERATED LABELS

(71) Applicant: NVIDIA Corporation, Santa Clara, CA (US)

(72) Inventors: Lukas Voegtle, Freiburg (DE); Ilia Karmanov, Zurich (CH); Philipp Fischer, Kronberg (DE); Karan Sapra, San Jose, CA (US); Amala Sanjay Deshmukh, Mountain View, CA (US)

(21) Appl. No.: 19/387,537

(22) Filed: Nov. 12, 2025

Related U.S. Application Data
(60) Provisional application No. 63/720,676, filed on Nov. 14, 2024.

(51) Int. Cl. G06F 40/30; G06F 40/284; G06N 3/0455

(52) U.S. Cl. CPC G06F 40/30; G06F 40/284; G06N 3/0455

(57) ABSTRACT

Apparatuses, systems, and techniques to detect errors in content recognized by neural networks. In at least one embodiment, respective document transcriptions of one or more document images are generated using one or more neural networks. The respective document transcriptions may include document content and descriptive information of the document content. An error may be detected in the document content of at least one document transcription of the respective document transcriptions based, at least in part, on a syntax error identified in the descriptive information of the at least one document transcription

### CLAIM OF PRIORITY

This application claims the benefit of U.S. Provisional Application No. 63/720,676 titled “NEURAL NETWORK OBJECT RECOGNITION ERROR DETECTION ACCORDING TO INFERENCED DESCRIPTION INFORMATION,” filed Nov. 14, 2024, the entire contents of which is incorporated herein by reference.

### TECHNICAL FIELD

At least one embodiment pertains to processing resources used to perform and facilitate artificial intelligence for identifying text. For example, at least one embodiment pertains to processors or computing systems that use neural networks to identify text.

### BACKGROUND

Object recognition techniques are performed to implement computer vision and other data processing. Generating the information to perform object recognition techniques can use significant memory, time, or computing resources. The amount of memory, time, or computing resources used to perform object recognition techniques can be improved.

### BRIEF DESCRIPTION OF DRAWINGS

FIG. 1 illustrates an example of a logical block diagram of neural network object recognition error detection according to inferenced descriptive information, in accordance with at least one embodiment;

FIG. 2 illustrates an example of a descriptive token evaluation as part of neural network object recognition error detection, in accordance with at least one embodiment;

FIG. 3 illustrates an example of a batch transcription system that implements neural network object recognition error detection according to inferenced descriptive information, in accordance with at least one embodiment;

FIG. 4 illustrates an example of a method or technique that implements neural network object recognition error detection according to inferenced descriptive information, in accordance with at least one embodiment;

FIG. 5 illustrates an example of a method or technique that implements descriptive token evaluation as part of neural network object recognition error detection, in accordance with at least one embodiment;

FIG. 6 illustrates an example data center system, in accordance with at least one embodiment;

FIG. 7 illustrates an system-on-a-chip (SOC), in accordance with at least one embodiment;

FIG. 8 illustrates a parallel processor, in accordance with at least one embodiment;

FIG. 9 illustrates an accelerator processor, in accordance with at least one embodiment;

FIG. 10A illustrate a central processing unit and a core of the central processing unit, in accordance with at least one embodiment;

FIG. 10B illustrates a core of the central processing unit in FIG. 10A, in accordance with at least one embodiment;

FIG. 11 illustrates a neuromorphic processor, in accordance with at least one embodiment;

FIG. 12 illustrates a supercomputer, in accordance with at least one embodiment;

FIG. 13 illustrates another accelerator processor, in accordance with at least one embodiment;

FIG. 14 illustrates another processor, in accordance with at least one embodiment;

FIG. 15 illustrates another accelerator processor, in accordance with at least one embodiment;

FIG. 16 illustrates a tensor processing unit, in accordance with at least one embodiment;

FIG. 17 illustrates a RISC-V-compatible processor, in accordance with at least one embodiment;

FIGS. 18A and 18B illustrate a language processing unit, in accordance with at least one embodiment;

FIG. 19 illustrates a software stack of a programming platform, in accordance with at least one embodiment;

FIG. 20 illustrates software that is supported by a programming platform, in accordance with at least one embodiment;

FIG. 21 illustrates compiling code to execute on programming platforms of FIG. 18, in accordance with at least one embodiment;

FIG. 22A illustrates inference and/or training logic, in accordance with at least one embodiment;

FIG. 22B illustrates training and deployment of a neural network, in accordance with at least one embodiment;

### DETAILED DESCRIPTION

Neural networks, such as Multimodal LLMs (MLLMs), used for document transcription may take an input image of a document and analyze text within the input image and generate corresponding textual output. However, these models can create errors in the document transcription, sometimes referred to as “hallucinations”, by erroneously inserting text or other content that does not actually appear in the original document. Current error detection methods assess the reliability of the transcribed text and other content using confidence scores generated by the neural network. When confidence scores fall below a certain threshold, the transcription is identified as erroneous. For example, when the neural network is choosing between different possible words to select the word depicted in a portion of the input image, the neural network may use a confidence score of the different possible words (e.g., the normalized logits of different words that correspond to different probabilities) to select the word with the highest (or near the highest) confidence score. These same confidence scores may be monitored to detect errors in the transcription. Hallucinated text, however, can still receive a high confidence score, making it difficult to detect and correct transcription errors effectively.

Various embodiments describe techniques for neural network object recognition error detection according to inferenced descriptive information. These techniques may detect an error in document content of a document transcription generated by a neural network using additional, descriptive information for the document content that is also included in the document transcription (e.g., a bounding box location for a paragraph, chart or other portion of a document, or content labels, such as “paragraph” or “heading”). Because descriptive information may conform to strict syntax patterns (e.g., pairs of braces and other symbols that are required to represent bounding box coordinates) or features (e.g., there is bounded set of possible semantic classes to label content), errors in this information (e.g., wrong or missing characters) can be easily identified (e.g., using pattern matching techniques). Hallucination errors in one portion of the neural network's output, such as the descriptive information, may be strongly correlated with errors in another portion of the neural network's output, the content of the document transcription. Therefore, description information errors in a document transcription can accurately indicate the presence of errors in the text of the document transcription, which improves the accuracy of hallucination detection over techniques that utilize confidence scores.

As one of ordinary skill in the art may appreciate, document processing techniques that use computer vision and similar technologies in order to process a large number of documents for various downstream tasks may rely upon the ability of accurate document transcriptions in order to make correct downstream decisions. If, for instance, a document is improperly transcribed, indexing techniques, such as database systems, may not store a document in a proper location rendering that document effectively lost if cannot be found because it is stored in a location based on erroneous content recognized in the document transcription. Accordingly, the ability to accurately detect errors in document transcriptions generated by neural networks may provide the ability to correct errors and prevent these errors from causing further areas in a wide variety of downstream systems that rely upon the accuracy of document transcriptions.

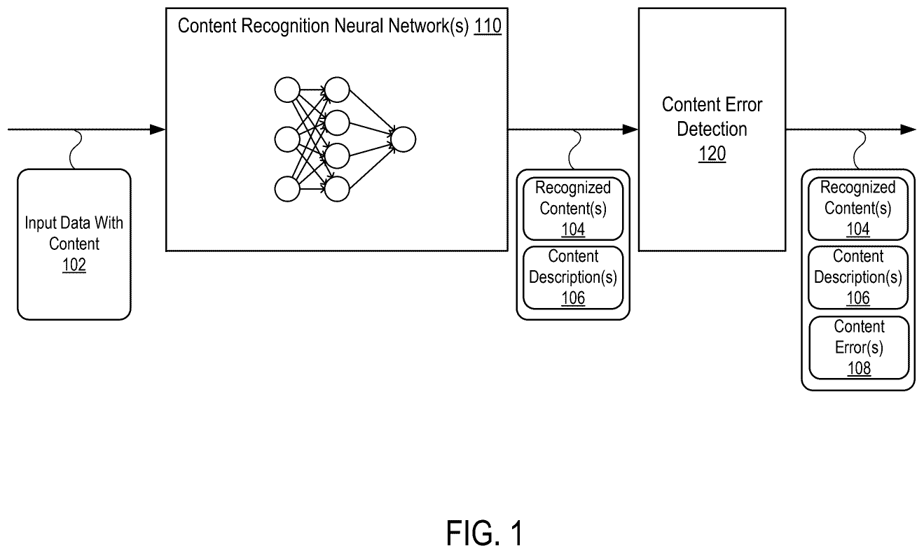

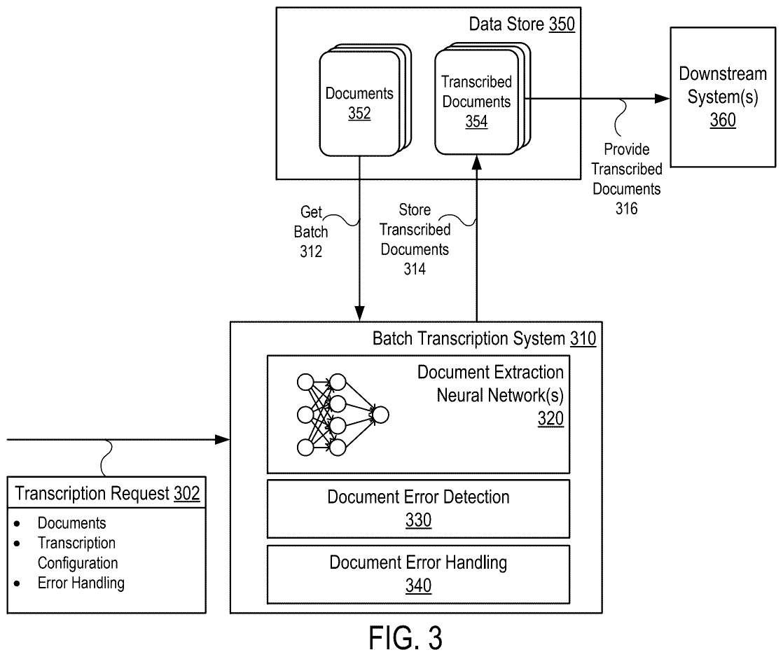

FIG. 1 illustrates an example of a logical block diagram of neural network object recognition error detection according to inferenced descriptive information, in accordance with at least one embodiment. In at least one embodiment, content recognition neural network(s) 110 may be trained to predict recognized content(s) (e.g., of objects) in input data with content 102 along with content description(s) 106. Neural networks, such as content recognition neural network(s) 110 in FIG. 1, and document extraction neural network(s) 320 in FIG. 3, can be various types of neural network machine learning models that use layers one or more nodes (sometimes called neurons) that represent a computation performed at each node, the output of which is passed to another node (e.g., in a next layer) connected by an edge to that node, which uses that value to perform a computation (e.g., usually in combination with outputs of other nodes also received from a previous layer). The computations performed at the nodes of various layers may be used to represent or perform various different AI or other machine learning tasks (e.g., computer vision tasks, such as image recognition, object detection, and image classification, natural language processing, such as machine translation, sentiment analysis, and text analysis, audio processing, such as speech recognition, automation, such as autonomous vehicle navigation, and generative tasks, such as language, image, audio, and video generation). For example, neural network computations may be performed to recognize patterns (e.g., in input data), make predictions given input data, or learn a task given input data.

In various embodiments, computations of a neural network at nodes may use various information, such as weights, bias, input data, as well as operations, such as an activation function to compute an output of a node. Weights and bias may be considered neural network parameters that are learned as part of training the neural network. Weights may be used to determine importance of an input feature in performing a task, by multiplying each input by a corresponding weight. Bias may be used to allow the neural network to shift an activation function, such as by adding a constant value to a weighted sum (e.g., weight multiplied by input) before performing the activation function. An activation function may be used to calculate the output (e.g., an activation) of a node according to particular activation function (which may be chosen and described as part of a neural network's architecture. Example of common activation functions include, but are not limited to, Rectified Linear Unit (ReLU), Sigmoid, Tanh, and SoftMax, each of which provides different properties useful for different tasks. When a node has multiple inputs (e.g., from multiple other nodes in a previous layer), then a weighted sum may be computed using the weight before adding bias and applying the activation function.

An architecture of a neural network may describe the number of nodes, layers, connections between nodes/layers, and computations performed by the neural network. Layers may sometimes be described as either an input layer, which includes one or more nodes to accept input data of various formats, hidden layer(s) of one or more nodes which perform computations in order to perform an AI or other machine learning task, or an output layer of one or more nodes which may provide a result (e.g., an inference or other output) of the AI or other machine learning task. Some neural networks may be referred to as a Deep Neural Networks (DNNs) when they include multiple hidden layers (e.g., 3 or more) between input and output layers.

Various different architectures of neural networks can be implemented. One example of a neural network architecture is a Feedforward Neural Network (FNN), where data moves in one direction through the network. Another example of a neural network architecture is a Convolutional Neural Network (CNN), which may process input data according to a grid topology (e.g., different portions of an image) using convolutional computations (e.g., applying a filter to create or update a feature map) at different layers to detect features like edges, textures, or other aspects of in the input data. Another example of a neural network architecture is a Recurrent Neural Network (RNN) architecture, which may have edges that loop back to be recursively used in computation. Another example of a neural network architecture is Long Short-Term Memory Network (LTSM), which may persist computation results for reuse over a period of time. Another example of a neural network architecture is a Generative Adversarial Network (GAN) that uses a generator network and a discriminator network to compete by having a generator attempt to generate new data given input data and the discriminator attempts to distinguish between generated new data and real data samples. Another example of neural network architecture is an autoencoder which includes an encoder to compress or otherwise represent encoded form input data and a decoder to then reconstruct with, or without augmentation or analysis, the input data from the encoded form.

Another example of a neural network architecture is a transformer network, which may use an attention mechanism to process sequential data. Transformer-based neural networks, such as MLLMs, Large Language Models (LLMs), Vision Language Models (VLMs), or various other types of artificial intelligence or machine learning models may utilize a transformer as part of generating inferences and/or other output. A transformer may be implemented to capture relationships between different data items in a sequence (e.g., tokens of data, such as tokens representing natural language, image data, time series data, audio data, and/or various other types of data). In various embodiments, tokens may provide an encoded representation of data (e.g., as an embedding of one or more vectors, where different dimensions of the vector corresponding to numerical representations of data attributes. These captured relationships may be used to iteratively predict and/or generate new data items in the sequence using auto-regressive techniques. Because transformers include features, such as self-attention, that may be efficiently performed in parallel, transformer-based neural networks have grown in popularity to perform a variety of artificial intelligence tasks as processors, such as Graphics Processing Units (GPUs), that can perform parallel operations efficiently may be used to speed up execution time and increase the predictive accuracy of artificial intelligence tasks.

In at least one embodiment, captured relationships may cover large amounts of input data that provides a context for generating and/or predicting new data. For example, captured relationships may include contexts ranging from a small number of previously entered or generated words to large numbers of documents or other data content. To avoid recomputing the relationships between data in contexts, such as large contexts, a Key-Value (KV) cache is implemented, in at least one embodiment, to store the captured relationships as KV values which can be accessed by a transformer and used to capture new relationship information when new input data is received (e.g., when a query or other prompt for an LLM is received, the KV cache that provides the context for the query or prompt can be retrieved to generate an answer or other response to the prompt).

In at least one embodiment, a transformer may be implemented in a variety of ways, which may include a self-attention stage and a feed-forward network stage. In at least one embodiment, a self-attention stage may be implemented as multi-head attention, which may use different attention heads to capture different types relationships that correspond to different aspects of a sequence of items (e.g., syntax, semantics, and coreference for a sequence of tokens representing words, or portions of words, in natural language). Each attention head may be computed independently from other attention heads of the same multi-head attention stage, providing an opportunity to execute multi-head attention in parallel.

In at least one embodiment, one (or more) feed-forward networks (FFNs) may be used to enrich attention values output from a self-attention stage in order to provide a hidden dimension representation (e.g., of a token) that is in a larger feature space than an initial hidden dimension representation of a token. For example, an FFN may expand a feature space to be 4 times larger than an initial hidden dimension, such as from an initial hidden dimension representation of 4096 parameters into a hidden dimension representation of 16384 parameters). In this way, an FFN can enhance the accuracy of a transformer-based neural network by capturing additional features to distinguish between different possible data items that could be predicted as next in an input sequence.

Similar to the examples given above with respect to transformer-based neural networks, different neural network architectures can be combined in various ways in order to perform different tasks. For instance, convolutional layer(s) can be combined with transformers in other neural network architectures.

Different neural network architectures may be developed, specialized, or otherwise used for particular tasks. For example, transformer-based neural networks may be used to implement MLLMs, LLMs, VLMs, or various other types of artificial intelligence or machine learning models to generate inferences and/or other output. Because a transformer may capture relationships between different data items in a sequence (e.g., tokens of data, such as tokens representing natural language, image data, time series data, audio data, and/or various other types of data), these captured relationships may be used to iteratively predict and/or generate new data items in the sequence using auto-regressive techniques. In another example, CNN-based neural networks may be used for various computer vision tasks as image data (or data that can be converted into image data, such as heat maps or spectrograms (for audio data)), can be processed in grid-like fashion in order to identify areas within the larger image for various task purposes. LSTM or RNNs may, in another example, be used for time-series data analysis and/or forecasting. GANs may be used in generative tasks (e.g., generating images, audio, video, or other data) to generate entirely new or augmented data.

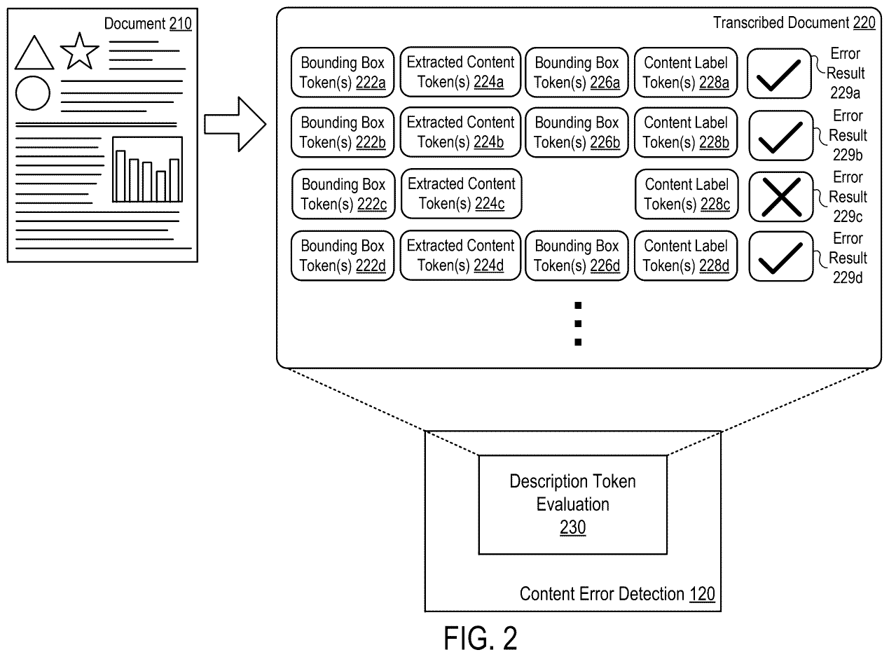

As shown in FIG. 1, content recognition neural network(s) 110 may generate content description(s) 106 may correspond to a specific one of recognized content(s) 104 (e.g., bounding boxes and class labels may be specified for particular objects, such as tables, text, or other objects recognized within an input document). For example, content description(s) 106 may be information that describes the structure of textual information in the input data with content 102 (e.g., where it is located as may be specified by a bounding box) and/or may be information that describes what the textual information is (e.g., a text block, a section header, etc.). In at least one embodiment, content recognition neural network(s) 110 may be trained to output corresponding description(s) 106 as tokens in a sequence along with content tokens, using their locations within a sequence to identify which content token is described by which description token (e.g., as illustrated in FIG. 2, bounding box tokens may surround a content token along with content label token that follows before a new bounding box token to be followed by a new content token, and so on). In at least one embodiment, missing or erroneous information in a sequence of tokens (e.g., in description tokens) may indicate that a corresponding content token has an error (as an error for a description token correlates strongly with an error in a content token, including errors that are repeating or stuck content token generation.

Content error detection 120 may use content description(s) 106 to evaluate whether recognized content(s) 104 have an error. In at least one embodiment, for example, an error can occur in content recognition neural networks 110 that are implemented using a transformer style of architecture (e.g., such as an MLLM, LLM, or VLM) which generate recognized content(s) 104 as a sequence of tokens. In at least one embodiment, content error detection 120 may use pattern recognition or other techniques to analyze content description(s) 106 with respect to a grammar, syntax, or other expected format. In at least one embodiment, an expected format of content descriptions may be a small combination of possible values allowing for quick and highly accurate error detection to be performed on corresponding recognized content(s) 104. In at least one embodiment, content error detection 120 may implement various ones of the error detection techniques discussed below with regard to FIGS. 2-5. In at least one embodiment, content error(s) 108 may be included as labels or other indicators by content error detection 120 which may allow for erroneous recognized content(s) 104 to be identified and removed or handled using various other error handling techniques, such as those discussed below with regard to FIG. 3.

FIG. 2 illustrates an example of a descriptive token evaluation as part of neural network object recognition error detection, in accordance with at least one embodiment. In at least one embodiment, content error detection 120 may implement description token evaluation 230. In at least one embodiment, transcription token evaluation 230 may evaluate tokens generated for document 210. In at least one embodiment, tokens may be content tokens, such as extracted content tokens 224a, 224b, 224c, and 224d (which include textual information, such as words, images, graphs, tables, charts, or various other kinds of content which may be present in a document), or descriptive tokens, such as bounding box token(s) 222a, 222b, 222c, 222d, 226a, 226b, and 226d and content label (e.g., semantic class label) tokens, such as tokens 228a, 228b, and 228d, or any other information that is descriptive of the content. A content token may, in some embodiments, provide an encoded representation of document content (e.g., an embedding of one or more vectors, where dimensions in the vector correspond to different features of a portion of the document content represented by the token).

In at least one embodiment, description token evaluation 230 may apply a syntax or other set of expected grammar or rules to structure or other descriptive information to be found in descriptive tokens or expected, but missing, descriptive tokens in a sequence of tokens (which may include both descriptive and content token(s)). Similar to content tokens, discussed above, in various embodiments, descriptive tokens may provide an encoded representation of descriptive information (e.g., an embedding of one or more vectors, where dimensions in the vector correspond to different features of a portion of the descriptive information, such as a bounding box or semantic class label, represented by the token). For example, in at least one embodiment, for extracted content token(s) 224c, it may be expected that there should be both bounding box tokens 222c and bounding box token(s) that follow after extracted content token(s) 224c. In at least one embodiment, missing tokens (e.g., missing for extracted content token(s) 224c such as missing bounding box tokens), may cause an error result 229c, indicating an error. Alternatively, although not illustrated, description tokens (e.g., bounding box tokens or content label tokens) may have erroneous values, content, or formatting that violates the syntax for description tokens which could also trigger the detection of an error. As shown in FIG. 2, other extracted content (e.g., 224a, 224b, and 224d) may have no-error results (e.g., indicated at 229a, 229b, and 229d). In at least one embodiment, by evaluating extracted content tokens individually, error evaluation and content recognition can continue for input data even if an error is found for one portion of extracted content, allowing content recognition and error evaluation to continue without error caused disruption. This can improve processing for systems, services, or applications, as errors can be identified without stopping error checks on the remainder of a document transcription after an error is discovered (e.g., a large document may only have one minor error and the remainder of the document transcription may be correct). Moreover, errors can be specified as occurring in a particular portion of the document (e.g., in a specific paragraph, heading, or sentence), which may allow for correction or other handling techniques to operate upon just the erroneous portion of the document transcription.

Batch processing systems are one example of a system for which techniques, such as those described above with regard to FIGS. 1 and 2, may improve the performance (e.g., throughput, computing resource utilization, and accuracy). FIG. 3 illustrates an example of a batch transcription system that implements neural network object recognition error detection according to inferenced descriptive information, in accordance with at least one embodiment. In at least one embodiment, batch transcription system 310 may implement document extraction neural network(s) 320, document error detection 330, and document error handling 340. In at least one embodiment, document extraction neural network(s) 320 may implement a transformer-based vision-encoder-decoder architecture. In at least one embodiment, a vision transformer encoder, denoted as ξ, may be a Vision-transformer neural network model (ViT) which maps an input image of a document, I∈ [symbol] ^{3×H×W} to a latent representation Z∈ [symbol] ^{N×d}, where H and W are respectively image height and width, and d is a hidden dimension and N is a sequence length. In at least one embodiment, a compressor may be implemented as part of document extraction neural network(s) 320, which may also be referred to as a “neck” denoted as [symbol] , which compresses dimensionality and sequence length of a latent space as text. In at least one embodiment, data may be more correlated within lines than blocks, thus the compressor may employ horizontal-kernel convolutions rather than square or rectangular convolutions resulting a reduced sequence length. In at least one embodiment, a decoder may be implemented as part of document extraction neural network(s) 320, denoted as [symbol] , and may use mBart to predict text-tokens, T={t_{P+1}, t_{P+2}, . . . , t_{L}} by conditioning on a latent encoder representation, Z, and the context P(tᵢ∈N(Z),t_{<i}), where Z=ξ(1) and {t₁, t₂, . . . , t_{P}} are the prompt tokens and where L is the prompt-augmented sequence length. In at least one embodiment, document extraction neural network(s) 320 may be implemented as auto-regressive architectures that scale linearly during inference with respect to decoder and sequence length, using an encoder with a greater number of parameters than the decoder (e.g., a heavy-weight encoder with a light-weight decoder).

In at least one embodiment, a transcription of a document may be performed using document extraction neural network(s) 320 according to a prompt that includes one or more options. In at least one embodiment, options may be specified in the form of a M-dimensional tuple. For example, in at least one embodiment, options may include an output format option, with structured and plain text as options, a bounding box option, with enabled and disabled options, and a class option, also with enabled and disabled options. It should be understood that that this is merely an example and is not intended to be limiting, as any number of options and values of options may be envisioned. In a least one embodiment, for example, a prompt may then include a three-dimensional tuple of options where eleven possible combinations may exist, which may be described as:

$$( < structured\_text \text{>\vert <} plain\_text \text{>\vert <} no\_text > ) ( < bbox \text{>\vert <} no\_bbox > ) ( < classes \text{>\vert <} no\_classes > )$$

In at least one embodiment, within each group, information to be predicted may be reduced as options progress. In at least one embodiment, a maximal-information prompt may be specified as:

$$< structured\_text > < bbox > < classes >$$

In at least one embodiment, document extraction neural network(s) 320 may process transcriptions according to any combination of possible task prompts. In at least one embodiment, document extraction neural network(s) 320 may have been pre-trained on a custom dataset which has labels for a maximal-information setting and then with some probability decreasing a required information for each group. In at least one embodiment, fine-tuning on datasets with varying information-density allows for a dataset with partial annotations, with an encoder trained and improved if the dataset is visually diverse.

In at least one embodiment, document extraction neural network(s) 320 may implement a token stream generated by a decoder. In at least one embodiment, document extraction neural network(s) 320 may predict bounding boxes in the form of discrete coordinates. In at least one embodiment, an example regular expression shows a prediction format for each box:

$$< x\_ ( \backslash d + ) \text{><} y\_ ( \backslash d + ) > ( . * ? ) < x\_ ( \backslash d + ) \text{><} y\_ ( \backslash d + ) \text{><} class\_ ( {[}^{∧} > ] + ) >$$

In at least one embodiment, a first set of coordinates denotes a top-left corner and a second, a bottom-right corner. In at least on embodiment, bounding box coordinates may be optimized using cross-entropy loss in a same way as regular text tokens, and so it is up to a token-embedding layer to approximate spatial similarity. In at least one embodiment, H+W tokens may be added for bounding boxes, C tokens for semantic classes, and special-tokens for the input-prompts to the vocabulary.

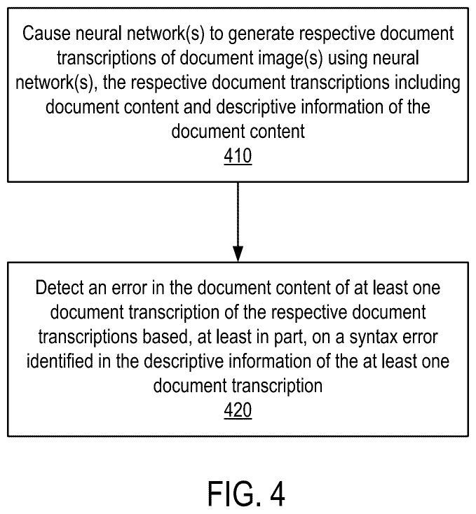

In at least one embodiment, document error detection 330 (which may be similar to content error detection 120), may evaluate description information of transcribed or extracted content from document extraction neural network(s) 320, according to various techniques discussed above with regard to FIGS. 1-2 and below with regard to FIGS. 3-4. In at least one embodiment, document error detection may evaluate description information for missing or erroneous content (e.g., missing bounding box information or erroneous class/semantic labels).

In at least one embodiment, batch transcription system 310 may implement document error handling 340. In at least one embodiment, document error handling 340 may direct or process detected errors at document error detection 330. For example, in at least one embodiment, document error handling 340 may perform operations to redact, filter, or otherwise remove detected errors from transcriptions. In at least one embodiment, document error handling may store an error for analysis or correction by another system (e.g., including a human analysis interface). In at least one embodiment, document error handling 340 may halt a transcription of a document or a batch of documents if a number of errors exceeds a threshold number of errors).

In at least one embodiment, batch transcription system 310 may implement an interface (e.g., an Application Programming Interface (API), graphical user interface (GUI), or command line) that supports transcription requests, such as transcription request 302. In at least one embodiment, transcription request 302 may include various parameters, features, or other information. In at least one embodiment, transcription request 302 may include an identifier of documents or a batch of documents for transcription, according to storage location, storage object, data store, or other information (e.g., an identifier for a storage location or container in data store 350 storing documents 352). In at least one embodiment, batch transcription request 302 may include a transcription configuration parameter which may indicate, for example, which descriptive information to include (e.g., bounding boxes, class labels, etc.), further examples of which are discussed above. In at least one embodiment, transcription request 302 may include error handling configuration or information which may direct performance of document error handling 340 for a specified batch.

In at least one embodiment, as specified at 312, batch transcription system 310 may get a batch 312 of documents 312 from data store 350, generate transcribed documents using document extraction neural network(s) 320 and perform error detection 330. In at least one embodiment, batch transcription system 310 may store transcribed documents 354 in data store 350, as indicated at 314. In at least one embodiment, transcribed documents 354 may be provided, as indicated at 316, to one or more downstream system(s) 360 for further processing (e.g., analysis, display, indexing, etc.).

The examples of neural network object recognition error detection according to inferenced descriptive information discussed above with regard to FIGS. 1-3 have been given in regard to different examples systems, services, or applications. Various other types systems may implement these techniques which seek to perform error detection in neural network generated document transcriptions. FIG. 4 illustrates an example of a method or technique that implements neural network object recognition error detection according to inferenced descriptive information, in accordance with at least one embodiment. These techniques may also be implemented using various components as described above with regard to FIGS. 1-3.

In at least one embodiment, one or more neural network(s) may be caused to generate respective document transcriptions of document image(s), as indicated at 410. The document transcriptions may include both document content and descriptive information of the document content. In at least one embodiment, for example, one or more neural networks may be similar to content recognition neural network(s) 110 in FIG. 1 and/or document extraction neural network(s) 320 in FIG. 3. In at least one embodiment, a document transcription may be generated given an input document (e.g., an image of a document in an image file format). In at least one embodiment, a document transcription may include many different objects or other content recognized from an input document, including, but not limited to, section headers, footnotes, text, tables, list items, page headers, pictures, formulas, captions, page footers, table of contents and bibliographies. In at least one embodiment, a document transcription may include one or multiple portions of recognized content (e.g., represented as tokens, text statements, image descriptions, formula or other descriptions in markup languages such as LaTeX). In at least one embodiment, a document transcription may include descriptive information, separate from recognized content (e.g., represented as tokens, text strings, or other description formats) according to a specified syntax (e.g., a set of rules that describe how a description may be formatted, in what order, and using particular words or characters). In at least one embodiment, descriptive information may be linked, mapped, or otherwise associated with particular content that it describes (e.g., as tokens surrounding or next content tokens as depicted in FIG. 4).

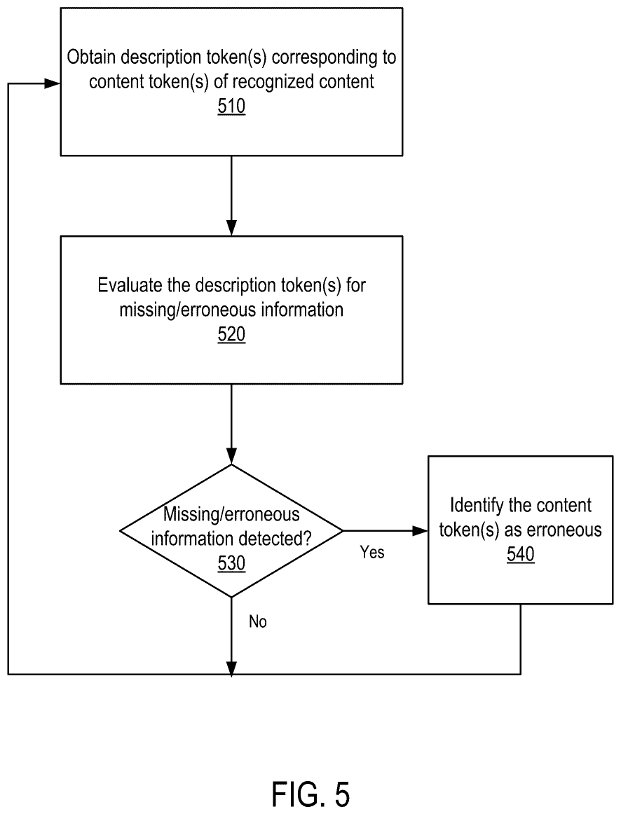

In at least one embodiment, one or more errors in the document content of at least one of the document transcriptions may be detected based, at least in part, on a syntax error identified in the descriptive information of the at least one document transcription, as indicated at 420. In at least one embodiment, an error evaluation may identify syntax errors according to incorrect or missing information in descriptive information, which may indicate an error in corresponding content recognized in a document transcription. In at least one embodiment, a regular expression or other pattern statement may be applied by a character parser or other interpreter of a pattern statement to search for existence of a specified pattern in given characters (e.g., in descriptive information and/or recognized content). In at least one embodiment, as discussed above with regard to FIG. 2 and below with regard to FIG. 5, a regular expression pattern or other pattern statement may be applied to a sequence of tokens that correspond to a recognized object in a document transcription (e.g., a paragraph, heading, graph, table, formula, etc.). In at least one embodiment, a heuristic or rules-based engine may apply or search for correct syntax with respect to a sequence of tokens that correspond to a recognized object in a document transcription. In at least one embodiment, a light-weight machine learning model or finite state machine may be used to apply or search for correct syntax. In at last one embodiment, a list of correct semantic class labels, such as, but not limited to, section headers, footnotes, text, tables, list items, page headers, pictures, formulas, captions, page footers, table of contents and bibliographies, may be checked with respect to semantic class labels in the descriptive information. If a new or unknown semantic class label is found (e.g., does not match one of the labels in the list), then semantic class label syntax error may be identified.

In at least one embodiment, an occurrence of one error with respect to one object or portion of content recognized in a document transcription may not prohibit transcription or error analysis for another object or portion of other content. In at least one embodiment, partially transcribed documents with content or objects identified as erroneous according to an evaluation of descriptive information having been filtered, removed, or redacted from a document. In at least one embodiment, error handling techniques, including thresholds for handling a number of detected errors may be implemented.

The techniques described above may, in some embodiments, applied to a document transcription as it is being generated as a stream of tokens output by the neural network(s) or as a set or batch of tokens in the document transcription. FIG. 5 illustrates an example of a method or technique that implements descriptive token evaluation as part of neural network object recognition error detection, in accordance with at least one embodiment. In at least one embodiment, one or more description token(s) corresponding to one or more content tokens of recognized content may be obtained, as indicated at 510. In at least one embodiment, an LLM or other transformer-based neural network may be used to recognize content in input data as a sequence of tokens. In at least one embodiment, for a given input data (e.g., a document) individual objects may be recognized as a sequence of tokens, which may include a pattern or set of one or more tokens, including description token(s), like bounding box tokens and content label tokens illustrated in FIG. 2, and content token(s), like extract content tokens illustrated in FIG. 2. In at least one embodiment, different tokens for recognized content may be different types of data (e.g., text tokens, including descriptive information formatted according to a particular syntax for labels or bounding boxes) may be mixed with tokens that are image, audio, or other types of data).

In at least one embodiment, description token(s) may be evaluated for missing or erroneous information, as indicated at 520. For example, one or more description token(s) may indicate a number of subsequent tokens that are to be expected (e.g., a bounding box token may indicate that a second bounding box token describing an opposite corner of a bounding box may be described). In at least one embodiment, if an expected number of tokens were missing (e.g., a second bounding box token), then description token(s) may indicate an error in content token(s). In at least one embodiment, if a description token includes an error (e.g., in form or content, such as in correct content label or a missing delimiter, character or other formatting mistake), then an error in content token(s) described by description token(s) may be indicated.

In at least one embodiment, as indicated by positive exit from 530, for missing or erroneous information determined according to evaluation 520, content token(s) described by description token(s) may be identified as erroneous, as indicated at 540, in at least one embodiment. In at least one embodiment, identifying a content token as erroneous may include adding an additional token, label, or other indicator that identifies content token(s) as erroneous. In at least one embodiment, erroneous content token(s) and corresponding description token(s) that describe content token(s) may be stored separately from a transcription or other output of content recognition. In at least one embodiment, erroneous content token(s) and corresponding description token(s) that describe content token(s) may be filtered or removed from a transcription or other output of content recognition. In at least one embodiment, techniques depicted in FIG. 5 may be repeated multiple times for separate sets of description token(s) and content token(s) generated for an input data (e.g., for a same document recognizing content of different portions of a document). In at least one embodiment, evaluating content token(s) individually using descriptive tokens specific to particular content token(s) may allow for errors found in one portion of an input data (e.g., a document) not to affect content recognition in another portion of input data (e.g., a partially or mostly correct document may be stored with correctly recognized content with incorrectly recognized content being removed, redacted, or indicated as erroneous).

### Data Center

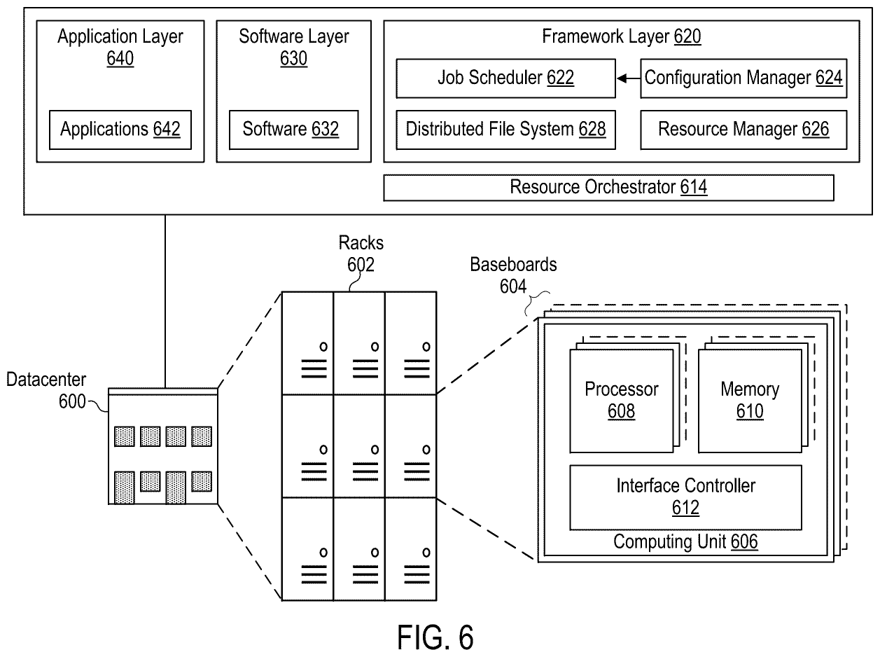

FIG. 6 illustrates an example data center 600, in which at least one embodiment may be used. Data center 600 may include one or more rooms having racks 602 and auxiliary equipment used to house one or more racks 602 and one or more baseboards 604. Rack 602 can include one or more baseboards 604. Rack 602 can include a housing that receives and supports individual baseboards 604. Operational aspects of rack 602 may be regulated at a rack level, corresponding to a group of baseboards 604, or at a baseboard level, corresponding to individual baseboards 604, among other options. Rack 602 or baseboards 604 can have particularly selected maximum operating parameters, such as, but not limited to, power consumption, operating frequencies, and others. Data center 600 can be supported by various cooling systems, such as, but not limited to, cooling towers, cooling loops, pumps, and other support systems. Cooling systems may include sensors and controllers to monitor and managing cooling properties for racks 602. Baseboards 604 within racks 602 can get operational power from one or more power distribution units (PDUs; not shown). PDUs may be arranged within racks 602, for example between racks 602 including baseboards 604, or within racks 602 that also house baseboards 604.

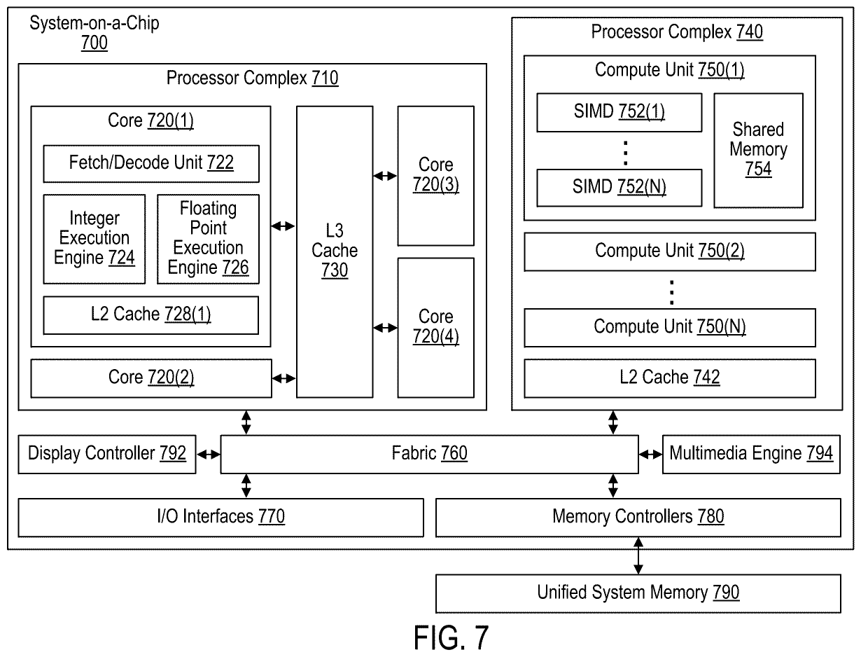

Racks 602 and baseboards 604 can include sub-systems, modules, add-in cards, and other semiconductor components. Baseboards 604 can include one or more computing units 606 that can include one or more processors 608, one or more memory 610, and an interface controller 612. Computing units 606 may include any number of processors, such as, but not limited to, central processing units (“CPUs”), graphics processing units (“GPUs”), or other processors (including accelerators, field programmable gate arrays (FPGAs), graphics processors, etc.), including any processors described herein, such as, but not limited to, the processors in FIGS. 7-18. Computing units 606 can include one or more memory storage devices 610 (e.g., dynamic read-only memory, solid state storage or disk drives), as well as network input/output (“NW I/O”) devices, network switches, virtual machines (“VMs”), power modules, and cooling modules, etc. One or more computing units 606 may be a server having one or more of above-mentioned computing resources.

Computing units 606 can include separate groupings of computing units housed within one or more racks (not shown), or many racks housed in data centers at various geographical locations (also not shown). Separate groupings of computing units may include grouped compute, network, memory or storage resources that may be configured or allocated to support one or more workloads. Several computing units (e.g., including CPUs and/or other processors) may be grouped within one or more racks to provide compute resources to support one or more workloads. A resource orchestrator 614 may configure or otherwise control one or more computing units 606 or groups of computing units. Resource orchestrator 614 may include a software design infrastructure (“SDI”) management entity for data center 600. Resource orchestrator 614 may include hardware, software or some combination thereof.

Data center 600 can include any one of or any combination of a framework layer 620, a software layer 630 and an application layer 6340. As shown in FIG. 6, framework layer 620 includes a job scheduler 622, a configuration manager 624, a resource manager 626 and a distributed file system 628. Framework layer 620 may include a framework to support software 632 of software layer 630 and/or one or more application(s) 642 of application layer 640. Software 632 or application(s) 642 may respectively include web-based service software or applications, such as, but not limited to, those provided by Amazon Web Services, Google Cloud and Microsoft Azure. Framework layer 620 may be a type of free and open-source software web application framework such as, but not limited to, Apache Spark™ (hereinafter “Spark”) that may utilize distributed file system 628 for large-scale data processing (e.g., “big data”). Job scheduler 622 may include a Spark driver to facilitate scheduling of workloads supported by various layers of data center 600. Configuration manager 624 may be capable of configuring different layers such as, but not limited to, software layer 630 and framework layer 620 including Spark and distributed file system 628 for supporting large-scale data processing. Resource manager 626 may be capable of managing clustered or grouped computing units 606 mapped to or allocated for support of distributed file system 628 and job scheduler 622. Resource manager 626 may coordinate with resource orchestrator 614 to manage these mapped or allocated computing resources.

Software 632 can be included in software layer 630 and may include software used by at least portions of a computing unit 606, one or more computing units 606, groups of computing units 606, and/or distributed file system 628 of framework layer 620. One or more types of software may include, but are not limited to, Internet web page search software, e-mail virus scan software, database software, and streaming video content software.

Application(s) 642 can be included in application layer 640 and may include one or more types of applications used by at least portions of a computing unit 606, one or more computing units 606, groups of computing units 606, and/or distributed file system 628 of framework layer 620. One or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

Any of configuration manager 624, resource manager 626, and resource orchestrator 614 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

Data center 600 may include tools, services, software or other resources to train one or more machine learning models or predict or infer information using one or more machine learning models in accordance with one or more embodiments described herein. For example, a machine learning model may be trained by calculating weight parameters in accordance with a neural network architecture using software and computing resources described above with respect to data center 600. Trained machine learning models corresponding to one or more neural networks may be used to infer or predict information using resources described above with respect to data center 600 by using weight parameters calculated through one or more training techniques described herein.

Data center 600 may use CPUs, application-specific integrated circuits (ASICs), GPUs, FPGAs, or other hardware (e.g., embodiments in FIGS. 7-18) to perform some or all of processes and techniques described elsewhere herein, such as, but not limited to, training and/or inferencing using above-described resources. Moreover, one or more software and/or hardware resources described above may be configured as a service to allow users to train or performing inferencing of information, such as, but not limited to, image recognition, speech recognition, or other artificial intelligence services.

In at least one embodiment, processor 608 can include one of the processors below and/or comprises one or more circuits to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. In at least one embodiment, processor 608 is configured by software 632 to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. Data center 600 may use logic, CPUs, application-specific integrated circuits (ASICs), GPUs, FPGAs, or other hardware (e.g., embodiments in FIGS. 7-18) to perform any of the operations described above or elsewhere herein.

### Processors

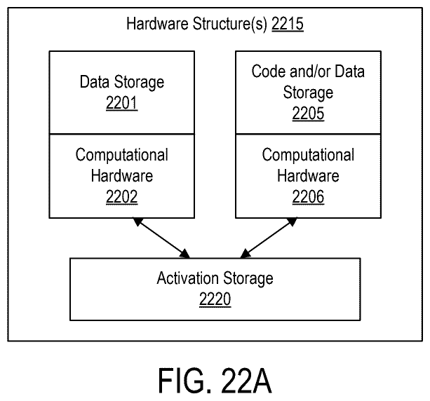

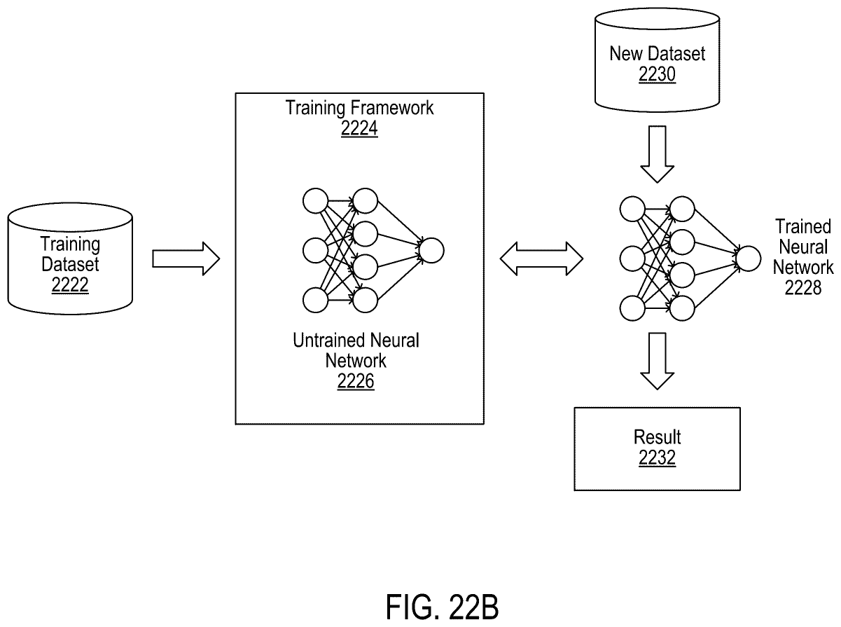

The following figures set forth, without limitation, example processors and processing systems that can be used to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform some or all of processes, operations and/or and techniques described elsewhere herein. Example processors and processing systems can be configured by software to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. Processors and processing systems can include logic, central processing units (CPUs), application-specific integrated circuits (ASICs), graphics processing units (GPUs), field programmable arrays (FPGAs), XPUs (i.e., any compute architecture that best fits the need of an application) or other hardware (e.g., embodiments in FIGS. 7-18) to perform any of the operations described above, below, or elsewhere herein. Processors and/or processing systems described herein can include one or more circuits that can be used to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. As used herein, one or more circuits can be configured by software to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. FIGS. 22A and 22B illustrate logic 2215 which, as described elsewhere herein, can be used in one or more devices to perform operations such as, but not limited to, those discussed herein in accordance with at least one embodiment. Logic can refer, for example, to any combination of software logic, hardware logic, and/or firmware logic to provide functionality and/or operations described herein, wherein logic may be, collectively or individually, embodied as circuitry that forms part of a larger system, for example, an integrated circuit (IC), an application-specific integrated circuit (ASIC), a field programmable array (FPGA), system-on-chip (SoC), or one or processors (e.g., CPU, GPU).

FIG. 7 illustrates a processor which is a system-on-a-chip (SOC) 700 (which may be referred to as system-on-chip, a superchip, or another name), in accordance with at least one embodiment. SOC 700 can include processor complex 710 and processor complex 740. SOC 700 can include any number of processor complexes 710 and/or processor complexes 740 that may include any number of processors that are described herein, such as, but not limited to, those in FIGS. 7-18, in any combination. For example, processor 710 may include a central processing unit (CPU), and processor 740 may include a graphics processor. Alternatively, processor 710 may include a graphics processor, and processor 740 may include a graphics processor. SOC 700 may include any number of display controllers 792, any number of multimedia engines 794, any number of I/O Interfaces 770, any number of memory controllers 780, and any number of fabrics 760 in any combination. For explanatory purposes, multiple instances of like objects are denoted herein with reference numbers identifying the object and parenthetical numbers identifying the instance where needed. SOC 700 can include a processor from Broadcom in Palo Alto, CA.

Processor complex 710 can include a CPU, processor complex 740 can include a GPU, and SOC 700 can be a processing unit that integrates 710 and 740 onto a single chip. Some tasks may be assigned to processor complex 710 and other tasks may be assigned to processor complex 740. Processor complex 710 can be configured to execute main control software associated with SOC 700, such as, but not limited to, an operating system. Processor complex 710 can be the master processor of SOC 700, controlling and coordinating operations of other processors. Processor complex 710 can issue commands that control the operation of processor complex 740 to perform some or all of the operations described herein. Processor complex 710 can be configured to execute host executable code derived from CUDA or other source code (e.g., HIP source code), and processor complex 740 can be configured to execute device executable code derived from CUDA or other source code in order to perform any of the operations described herein.

Processor complex 710 can include cores 720(1)-720(4) and a cache (e.g., L3 cache) 730 to store information to perform operations described herein. Processor complex 710 may include any number of cores 720 and any number and type of caches in any combination. Cores 720 can be configured to execute instructions of a particular instruction set architecture (“ISA”) to perform some or all of the operations described herein. Each core 720 can include a CPU core. Core 720(1)-720(4) can be referred to as a computing units or compute units. SOC 700 can include any number of processor complexes 710, fabric 760, I/O interfaces 770, and memory controllers 780.

Each core 720 can include a fetch/decode unit 722, an integer execution engine 724, a floating point execution engine 726, and an L2 cache 728. Fetch/decode unit 722 can fetch instructions to perform some or all of the operations described herein (such as, but not limited to, an API that is compiled into instructions) and decode such instructions, generate micro-operations, and dispatch separate micro-instructions to integer execution engine 724 and/or floating point execution engine 726. Fetch/decode unit 722 can concurrently dispatch one micro-instruction to integer execution engine 724 and another micro-instruction to floating point execution engine 726. Integer execution engine 724 can execute integer and memory operations. Floating point engine 726 can execute floating point and vector operations. Fetch-decode unit 722 can dispatch micro-instructions to one or more execution engines that replaces both integer execution engine 724 and floating point execution engine 726.

Each core 720(i), where i is an integer representing a particular instance of core 720, may access L2 cache 728(i) included in core 720(i). Each core 720 included in core complex 710(j), where j is an integer representing a particular instance of core complex 710, can be connected to other cores 720 included in core complex 710(j) via L3 cache 730(j) included in core complex 710(j). Cores 720 included in core complex 710(j), where j is an integer representing a particular instance of core complex 710, can access all of L3 cache 730(j) included in core complex 710(j). L3 cache 730 may include any number of slices.

Processor complex 740 can be a graphics complex that can be configured to perform compute operations (e.g., compute operations involved in operations described herein) in a highly-parallel fashion. Processor complex 740 can be configured to execute graphics pipeline operations such as, but not limited to, draw commands, pixel operations, geometric computations, and other operations associated with rendering an image to a display. Processor complex 740 can be configured to execute operations unrelated to graphics, such as, but not limited to, neural network training and/or simulations. Processor complex 740 can be configured to execute both operations related to graphics and operations unrelated to graphics.

Processor complex 740 can include any number of compute units 750(1)-750(N), where N is any integer greater than 1, and an L2 cache 742. Compute units 750 can share L2 cache 742, which may store information to be used to perform some or all of the operations described herein. L2 cache 742 can be partitioned. Processor complex 740 can include any number of compute units 750 and any number (including zero) and type of caches. Processor complex 740 can include any amount of dedicated graphics hardware.

Each compute unit 750 can include any number of SIMD units 752(1)-752(N), where N is any integer greater than 1, and a shared memory 754. Each SIMD unit 752 can implement a SIMD architecture and can be configured to some or all of the operations described herein, in parallel. Each compute unit 750 may execute any number of thread blocks, but each thread block can execute on a single compute unit 750, although in some embodiments a thread block can execute on multiple compute units. A thread block can include any number of threads of execution. A workgroup can be a thread block. Each SIMD unit 752 can execute a group of threads. A group of threads (e.g., 16 threads), which can also be referred to as a warp, or subgroup, or wavefront (e.g., as used by AMD and Intel), where each thread in the warp, wave, subgroup, or wavefront can belong to a single thread block and is configured to process a different set of data based on a single set of instructions. Predication can be used to disable one or more threads in a warp, subgroup, or wavefront. A lane can be a thread. A work item can be a thread, such as, but not limited to, e.g., with OpenCL. Different warps, subgroups, or wavefronts in a thread block may synchronize together and communicate via shared memory 754. Each compute unit 750 can include one or more thread block clusters, where a thread block cluster can enable programmatic control of locality at a granularity larger than a single thread block of a single streaming multiprocessor (SM). Thread block clusters (also referred to as “clusters”) can enable multiple thread blocks running concurrently across streaming multiprocessors to synchronize and collaboratively fetch, exchange, or otherwise use data. In at least one embodiment, streaming multiprocessors (“SMs”) can be referred to streaming microprocessors, stream processors (“SPs”), stream processing units (“SPUs”), compute units (“CUs”), execution units (“EUs”), and/or slices, where a slice in this context can refer to a portion of processing resources in a processing unit (e.g., 16 cores, a ray tracing unit, a thread director or scheduler).

Fabric 760 can be a system interconnect that facilitates data and control transmissions across processor complex 710, processor complex 740, I/O interfaces 770, memory controllers 780, display controller 792, and multimedia engine 794, e.g., to perform some or all of the operations described herein. SOC 700 may include any amount and type of system interconnect in addition to or instead of fabric 760 that facilitates data and control transmissions across any number and type of directly or indirectly linked components that may be internal or external to SOC 700. I/O interfaces 770 can be representative of any number and type of I/O interfaces (e.g., PCI, PCI-Extended (“PCI-X”), PCIe, gigabit Ethernet (“GBE”), USB, etc.). Various types of peripheral devices can be coupled to I/O interfaces 770. Peripheral devices that can be coupled to I/O interfaces 770 may include keyboards, mice, printers, scanners, joysticks or other types of game controllers, media recording devices, external storage devices, network interface cards, and so forth.

Display controller 792 may display images on one or more display device(s), such as, but not limited to, a liquid crystal display (“LCD”) device. Multimedia engine 794 can include any amount and type of circuitry that is related to multimedia, such as, but not limited to, a video decoder, a video encoder, an image signal processor, etc. Memory controllers 780 may facilitate data transfers between SOC 700 and a unified system memory 790. Processor complex 710 and processor complex 740 may share unified system memory 790. Unified system memory 790 can include various types of memory devices, including dynamic random access memory (DRAM) or graphics random access memory, such as, but not limited to, synchronous graphics random access memory (SGRAM), including graphics double data rate (GDDR) memory. Unified system memory 790 may include 3D stacked memory, including but not limited to high bandwidth memory (HBM), HBM2e, or HDM3.

SOC 700 may implement a memory subsystem that includes any amount and type of memory controllers 780 and memory devices (e.g., shared memory 754) that may be dedicated to one component or shared among multiple components in order to perform any of the operations described herein. SOC 700 can implement a cache subsystem that includes one or more cache memories (e.g., L2 caches 728, L3 cache 730, and L2 cache 742) that may each be private to or shared between any number of components (e.g., cores 720, core complex 710, SIMD units 752, compute units 750, and processor complex 740).

In at least one embodiment, SOC 700 can include one or more circuits to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. One or more circuits can be configured by software to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein.

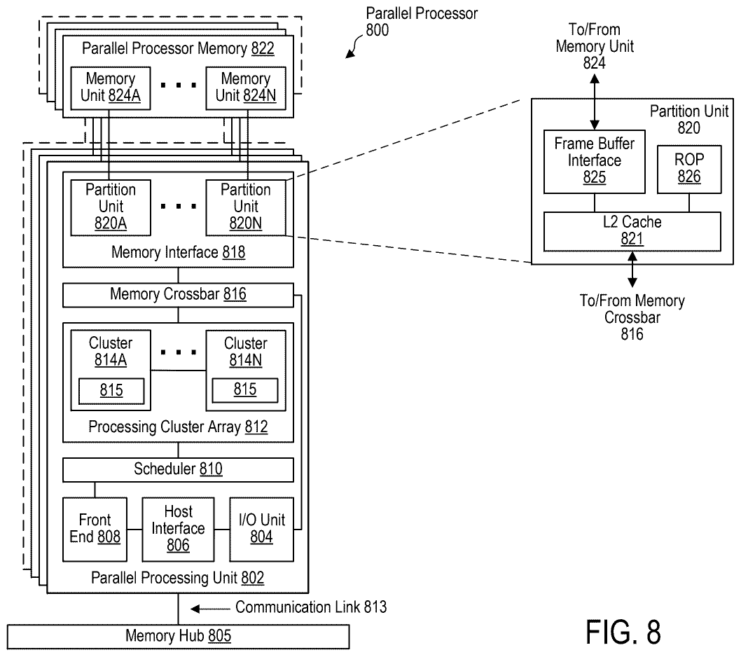

FIG. 8 illustrates a parallel processor 800, in accordance with at least one embodiment. Parallel processor 800 may be implemented using one or more circuits and may be referred to as a programmable processor (e.g., a CPU and/or GPU), logic, an application specific integrated circuit (ASIC), a field programmable gate array (FPGA) or other hardware (e.g., embodiments in FIGS. 7-17) to perform any of the operations described above or elsewhere herein.

Parallel processor 800 can include a parallel processing unit 802 to perform any of the operations described above or elsewhere herein. Parallel processing unit 802 can include an I/O unit 804 that enables communication with other devices, including other instances of parallel processing unit 802. I/O unit 804 may be directly connected to other devices. I/O unit 804 may connect with other devices via use of a hub or switch interface, such as, but not limited to, a memory hub 805. Connections between memory hub 805 and I/O unit 804 can form a communication link 813. I/O unit 804 may connect with a host interface 806 and a memory crossbar 816, where host interface 806 receives commands directed to performing processing operations and memory crossbar 816 receives commands directed to performing memory operations.

When host interface 806 receives a command buffer via I/O unit 804, host interface 806 can direct work operations to perform those commands to a front end 808. Front end 808 can couple with a scheduler 810 (which may be referred to as a sequencer), which is configured to distribute commands or other work items to a processing cluster array 812. Scheduler 810 can ensure that processing cluster array 812 is properly configured and in a valid state before tasks may be distributed to a cluster of processing cluster array 812. Scheduler 810 may be implemented via firmware logic executing on a microcontroller. Microcontroller-implemented scheduler 810 can be configurable to perform complex scheduling and work distribution operations at coarse and fine granularity, enabling rapid preemption and context switching of threads executing on processing array 812. Host software can prove workloads for scheduling on processing cluster array 812 via one of multiple graphics processing paths. Workloads can then be automatically distributed across processing array cluster 812 by scheduler 810 logic within a microcontroller including scheduler 810.

Processing cluster array 812 can perform any of the operations described above or elsewhere herein and can include up to “N” processing clusters (e.g., cluster 85A, cluster 85B, through cluster 85N), where “N” represents a positive integer (which may be a different integer “N” than used in other figures). Each cluster 85A-85N of processing cluster array 812 can execute a large number of concurrent threads. Scheduler 810 can allocate work to clusters 814A-814N of processing cluster array 812 using various scheduling and/or work distribution algorithms, which may vary depending on workload arising for each type of program or computation. Scheduling can be handled dynamically by scheduler 810, or can be assisted in part by compiler logic during compilation of program logic configured for execution by processing cluster array 812. Different clusters 814A-814N of processing cluster array 812 can be allocated for processing different types of programs or for performing different types of computations.

Processing cluster array 812 can be configured to perform various types of parallel processing operations, such as, but not limited to, any of the operations described above or elsewhere herein. Processing cluster array 812 can be configured to perform general-purpose parallel compute operations. For example, processing cluster array 812 can include logic to execute processing tasks including filtering of video and/or audio data, performing modeling operations, including physics operations, and performing data transformations.

Processing cluster array 812 can be configured to perform parallel graphics processing operations. Processing cluster array 812 can include additional logic to support execution of such graphics processing operations, including but not limited to, texture sampling logic to perform texture operations, as well as tessellation logic and other vertex processing logic. Processing cluster array 812 can be configured to execute graphics processing related shader programs such as, but not limited to, vertex shaders, tessellation shaders, geometry shaders, and pixel shaders. Parallel processing unit 802 can transfer data from system memory via I/O unit 804 for processing. During processing, transferred data can be stored to on-chip memory (e.g., parallel processor memory 822) during processing, then written back to system memory.

When parallel processing unit 802 is used to perform graphics processing, scheduler 810 can be configured to divide a processing workload into approximately equal sized tasks, to better enable distribution of graphics processing operations to multiple clusters 814A-814N of processing cluster array 812. Portions of processing cluster array 812 can be configured to perform different types of processing. For example, a first portion may be configured to perform vertex shading and topology generation, a second portion may be configured to perform tessellation and geometry shading, and a third portion may be configured to perform pixel shading or other screen space operations, to produce a rendered image for display. Intermediate data produced by one or more of clusters 814A-814N may be stored in buffers to allow intermediate data to be transmitted between clusters 814A-814N for further processing.

Processing cluster array 812 can receive processing tasks to be executed via scheduler 810, which receives commands defining processing tasks from front end 808. Processing tasks can include indices of data to be processed, e.g., surface (patch) data, primitive data, vertex data, and/or pixel data, as well as state parameters and commands defining how data is to be processed (e.g., what program is to be executed). Scheduler 810 may be configured to fetch indices corresponding to tasks or may receive indices from front end 808. Front end 808 can be configured to ensure processing cluster array 812 is configured to a valid state before a workload specified by incoming command buffers (e.g., batch-buffers, push buffers, etc.) is initiated.

Each of one or more instances of parallel processing unit 802 can couple with a parallel processor memory 822 to perform any of the operations described above or elsewhere herein. Parallel processor memory 822 can be accessed via memory crossbar 816, which can receive memory requests from processing cluster array 812 as well as I/O unit 804. Memory crossbar 816 can access parallel processor memory 822 via a memory interface 818. Memory interface 818 can include multiple partition units (e.g., partition unit 820A, partition unit 820B, through partition unit 820N) that can each couple to a portion (e.g., memory unit) of parallel processor memory 822. A number of partition units 820A-820N can be configured to be equal to a number of memory units, such that a first partition unit 820A has a corresponding first memory unit 824A, a second partition unit 820B has a corresponding memory unit 824B, and an N-th partition unit 820N has a corresponding N-th memory unit 824N. A number of partition units 820A-820N may not be equal to a number of memory units.

Memory units 824A-824N can include various types of memory devices, including dynamic random access memory (DRAM) or graphics random access memory, such as, but not limited to, synchronous graphics random access memory (SGRAM), including graphics double data rate (GDDR) memory. Memory units 824A-824N may also include 3D stacked memory, including but not limited to high bandwidth memory (HBM), HBM2e, or HDM3. Render targets, such as, but not limited to, frame buffers or texture maps may be stored across memory units 824A-824N, allowing partition units 820A-820N to write portions of each render target in parallel to efficiently use available bandwidth of parallel processor memory 822. A local instance of parallel processor memory 822 may be excluded in favor of a unified memory design that utilizes system memory in conjunction with local cache memory.

Any one of clusters 814A-814N of processing cluster array 812 can process data that will be written to any of memory units 824A-824N within parallel processor memory 822. Memory crossbar 816 can be configured to transfer an output of each cluster 814A-814N to any partition unit 820A-820N or to another cluster 814A-814N, which can perform additional processing operations on an output. Each cluster 814A-814N can communicate with memory interface 818 through memory crossbar 816 to read from or write to various external memory devices. Memory crossbar 816 can have a connection to memory interface 818 to communicate with I/O unit 804, as well as a connection to a local instance of parallel processor memory 822, enabling processing units within different processing clusters 814A-814N to communicate with system memory or other memory that is not local to parallel processing unit 802. Memory crossbar 816 can use virtual channels to separate traffic streams between clusters 814A-814N and partition units 820A-820N.

Multiple instances of parallel processing unit 802 can be provided on a single add-in card, or multiple add-in cards can be interconnected. Different instances of parallel processing unit 802 can be configured to interoperate even if different instances have different numbers of processing cores, different amounts of local parallel processor memory, and/or other configuration differences. For example, some instances of parallel processing unit 802 can include higher precision floating point units relative to other instances. Systems incorporating one or more instances of parallel processing unit 802 or parallel processor 800 can be implemented in a variety of configurations and form factors, including but not limited to desktop, laptop, or handheld personal computers, servers, workstations, game consoles, and/or embedded systems.

FIG. 8 further includes a block diagram of a partition unit 820, in accordance with at least one embodiment. Partition unit 820 is an instance of one of partition units 820A-820N of FIG. 8. Partition unit 820 can include an L2 cache 821, a frame buffer interface 825, and a ROP 826 (raster operations unit). L2 cache 821 can be a read/write cache that is configured to perform load and store operations received from memory crossbar 816 and ROP 826. Read misses and urgent write-back requests can be output by L2 cache 821 to frame buffer interface 825 for processing. Updates can also be sent to a frame buffer via frame buffer interface 825 for processing. Frame buffer interface 825 may interface with one of memory units in parallel processor memory, such as, but not limited to, memory units 824A-824N of FIG. 8 (e.g., within parallel processor memory 822).

ROP 826 can be a processing unit that performs raster operations such as, but not limited to, stencil, z test, blending, etc. ROP 826 can then output processed graphics data that is stored in graphics memory. ROP 826 can include compression logic to compress depth or color data that is written to memory and decompress depth or color data that is read from memory. Compression logic can be lossless compression logic that makes use of one or more of multiple compression algorithms. A type of compression that is performed by ROP 826 can vary based on statistical characteristics of data to be compressed. For example, delta color compression is performed on depth and color data on a per-tile basis.

ROP 826 can be included within each processing cluster (e.g., cluster 814A-814N of FIG. 8) instead of within partition unit 820. Read and write requests for pixel data may be transmitted over memory crossbar 816 instead of pixel fragment data. Processed graphics data may be displayed on a display routed for further processing by processor(s) 1502, or routed for further processing by one of processing entities within parallel processor 800 of FIG. 8.

In at least one embodiment, parallel processor 800 can include one or more circuits to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. One or more circuits can be configured by software to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein.

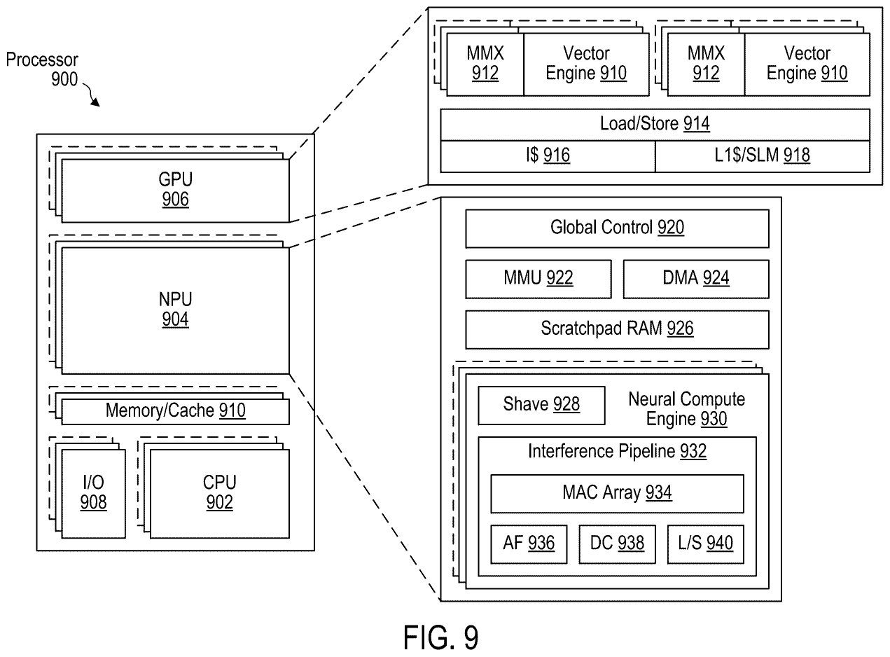

FIG. 9 shows a processor 900, in accordance with at least one embodiment. Processor 900 can include a processor with hybrid architecture (e.g., Lunar Lake or Meteor Lake) from Intel Corporation in Santa Clara, CA or another processor that shares at least some of the components described herein. Processor 900 can include one or more Central Processing Unit(s) (CPU 902), one or more Graphics Processing Unit(s) (GPU 906), and/or one or more Neural Processing Unit(s) (NPU 908) that can be, e.g., a dedicated AI accelerator that offloads artificial intelligence (AI) workloads from the CPU and GPU. Processor 900 can use instructions that, if executed, cause processor 900 and/or any of its components to perform some or all of processes and techniques described elsewhere herein. Processor 900 may include any number of memory and cache units 910 to facilitate processing amongst the different components. Memory and cache 910 on processor 900 may include one or more levels of cache (e.g., L1, L2, L3, and/or last-level cache) and high-bandwidth memory (e.g., HBM2e or HBM3) in any combination. With respect to processor 900 and any of its components described above or elsewhere herein, one or more of APIs described herein can, for example, get compiled into instructions, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of the processor (e.g., in cache and/or memory). A result of API(s) can then be stored in storage within or outside of the processor, including registers, DRAM, flash, SRAM, cache, or other memory. One or more of APIs described herein can include a call.

Processor 900 can include compute engines such as CPUs 902 and can include any number of cores, such as, but not limited to, up to 16 cores/22 threads. Cores in CPU 902 can include P-cores (Performance), E-cores (Efficient) & LP-E cores (Low-power Efficient). Performance-cores can be used for low latency single-threaded, compute-intensive workloads, while Efficient-cores can be used for multi-threaded, less compute-intensive workloads. Low-power Efficient cores can be used for scalable multithreaded performance and offloading background tasks. P-cores can be used for single & limited threading performance, whereas E- and LP-E cores can be used for multi-threaded throughput and power efficiency.

GPU 906 can include any number of graphics engines, such as, but not limited to, Intel® Arc™ graphics engines (Xe LPG) with 8 Xe cores (up to 128 Execution Units or EUs). As shown in FIG. 9, GPU 906 can include vector engines 910 and matrix engines 912, that, for example, can run FP, INT, and matrix operation tasks all at the same time or separately or in batches. GPU 906 can include a load/store unit 914, as well as other memory, such as, but not limited to, an instruction cache (I$) 916 and L1 cache/subsystem local memory (SLM) 918 that can, e.g., store instructions to perform any of the operations described above or elsewhere herein.

NPU 904 can include one or more Intel® AI Boost built-in neural processing unit(s) (NPUs). NPU 904 can be enumerated to the host processor as an integrated PCIe device. NPU 904 can include one or more (e.g., two) Neural Compute Engine (NCE) tiles 930. Each tile can be configured with any combination of, but not limited to, (e.g., 2000) Multiply Accumulate (MAC) Engines 934, a Post Processing Engine (not shown), a AI DSP Processor (not shown), and memory (2 MB of dedicated SRAM) per tile as shown in FIG. 9. For general compute needs, Neural Compute Engines 930 can include Streaming Hybrid Architecture Vector Engines (SHAVE) 928 for high performance parallel computing, which can include DMA (Direct Memory Access) engines 924 to shuttle the data between system memory DRAM (Dynamic Random Access Memory) 926 and a software managed cache. Built-in device MMU (Memory Management Unit) 922 plus IOMMU (Input-Output Memory Management Unit) (not shown) can support multiple simultaneous hardware contexts and provide security isolation between execution contexts as per MCDM (Microsoft Compute Driver Model) architecture. Processor 900 can also include a media unit (not shown) that is included on or separately from the XCDs or other components of the processor to enable video playback and video processing of compressed or non-compressed data, such using HEVC, AV1, VP9 and AVC HW accelerated decode support and HEVC, VP9 and AVC HW accelerated encode support.

An Intel® Thread Director, which includes firmware that is built into the processor, can prioritize and manage distribution of workloads, sending tasks to optimized cores. For example, Thread Director can tie P-cores, E-cores and/or LP-E cores (described above) together with task-scheduling capabilities and ability to send less-demanding tasks to the E-cores or LP-E cores. Intel® Deep Learning Boost (Intel® DL Boost) (not shown) can provide built in AI acceleration for training and inference workloads, and may include VNNI (for CPU) and DP4a (for GPU) instruction set support. This instruction set may be optimized with OpenVINO™ Toolkit and oneAPI to accelerate INT8 inferencing. A software stack, e.g., as described elsewhere herein, can be used to enable AI inference using OpenVINO™ toolkit. Processor 900 can be configured to execute an application program, such as, but not limited to, a CUDA program.

In at least one embodiment, processor 900 can include one or more circuits to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. One or more circuits can be configured by software to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein.

Processor 900 can alternatively include a processor based on AI Engine Direct architecture from Qualcomm Corporation in Santa Clara, CA or another processor that shares at least some of the components described herein. that may include any number of NPUs, GPUs, CPUs and other related components, such as, but not limited to, NPU 904 as a Hexagon NPU, GPU 906 as a Adreno GPU, CPU 902 as a Kryo or Qualcomm Oryon CPU, as well as a Qualcomm Sensing Hub (not shown) and a memory subsystem 910, in any combination. Hexagon NPU 904 can include a power rail a micro-tile inferencing unit, a hardware acceleration unit, a tensor unit, a scalar unit, and a vector unit (all not shown), which can have dedicated memory or share memory (e.g., cache or memory, such HBM3) for, e.g., storing instructions to perform any of the operations described above or elsewhere herein. Adreno GPU 906 can provide graphics and parallel processing for AI in formats, such as, but not limited to, 32-bit floating point (FP32), 16-bit floating point (FP16), and 8-bit integer (INT8). Kryo or Qualcomm Oryon CPUs 902 can perform AI workloads, and can handle contextualization for pervasive generative AI applications. CPU 902 can also include an instruction fetch unit, a rename and retire unit, a memory management unit, a vector execution unit, an integer execution unit, and a load and store unit for processing and instruction management. With respect to processor 900 and any of its components described above or elsewhere herein, one or more of APIs described herein can, for example, get compiled into instructions, which may be fetched by the instruction fetch unit, decoded by a processor decoder or equivalents, scheduled (e.g., in order or out of order) for execution by a scheduler or equivalents, executed by execution logic or equivalents, reordered, and then retired by the rename and retire unit. API(s) (and/or compiled instructions including API(s)) can be stored in any storage outside or inside of the processor (e.g., in cache and/or memory). Any number of CPU cores 902 may be included in any number of CPU cluster(s) that can be coupled to memory and/or cache, such as, but not limited to a shared L2 cache. Memory can be separate or shared, e.g., CPU clusters of CPU cores 902 can couple to memory subsystem 910 that can include fabric, system level cache and any number of memory management units that can, for example, read and write memory (e.g., DRAM). Qualcomm Sensing Hub (not shown) includes micro NPUs, a power rail, and traditional sensors (a gyrometer, accelerometer, even a barometer) with voice and data streams. Memory subsystem 910 can include memory and cache on processor 900, which may include one or more levels of cache (e.g., L1, L2, L3, and/or last-level cache) and high-bandwidth memory (e.g., HBM2e or HBM3) in any combination, e.g., for storing information and/or instructions to perform any of the operations described above or elsewhere herein. All or some of the memory and/or cache in memory subsystem 910 can be shared or used individually by any one or combinations of components (e.g., GPU 906, NPU 904, and CPU 902) on processor 900.

Qualcomm AI Engine 900 may be programmed and controlled with an a software stack to perform some or all of the operations described herein, and include, e.g., a Qualcomm® Neural Processing SDK for inferencing with versions for Android, Linux, and Windows. Developer libraries and services support the latest programming languages, virtual platforms, and compilers. At a lower level of the software stack, system software includes the basic real-time operating system (RTOS), system interfaces, and drivers. Software stack supports different operating systems, including Android, Windows, Linux, and QNX, and deployment and monitoring infrastructure like Prometheus, Kubernetes, and Docker. For direct cross-platform access to the GPU, OpenCL and DirectML may be supported. For the CPU, a LLVM compiler infrastructure optimizations enable accelerated and efficient AI inference. With respect to Qualcomm AI Engine 900 and any of its components described above or elsewhere herein, one or more of APIs described herein can, for example, get compiled into instructions, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of the processor (e.g., in cache and/or memory). A result of API(s) can then be stored in storage within or outside of the processor, including registers, DRAM, flash, SRAM, cache, or other memory.

In at least one embodiment, processor 900 or Qualcomm AI Engine 900 can include one or more circuits to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. One or more circuits can be configured by software to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein.

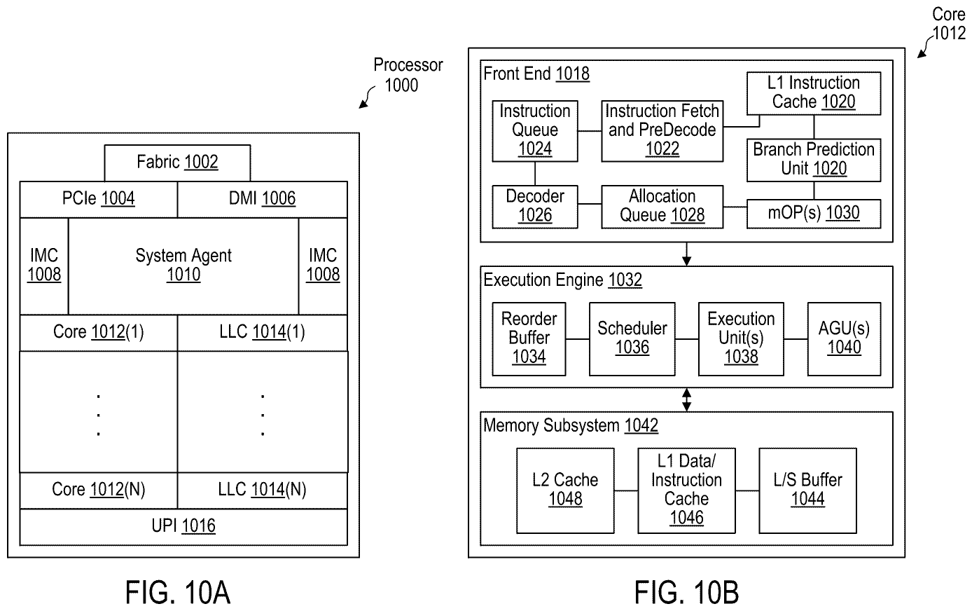

FIG. 10A illustrates a processor 1000, in accordance with at least one embodiment. Processor 1000 can include an processor with scalable family from Intel Corporation in Santa Clara, CA or another processor that shares at least some of the components described herein. Processor 1000 can include one or more cores 1012(1)-1012(N), where N is any integer greater than 1 that can perform the operations described elsewhere herein. Cores 1012(1)-1012(N) can be interlinked together using ring and/or mesh interconnects. With the mesh interconnects architecture, an array of vertical and horizontal communication paths may allow traversal from one core to another 1012(1)-1012(N) through a shortest path (hop on vertical path to correct row, and hop across horizontal path to correct column). For mesh interconnects, a die can house cores 1012(1)-1012(N) and can include a grid of converged mesh stops (CMS) that may be associated (e.g., 1:1) with cores 1012(1)-1012(N). Each core can be associated with one lower level cache (LLC) slice 1014(1)-1014(N), or cores 1012(1)-1012(N) can share cache, e.g., lower level cache. LLCs 1014(1)-1014(N) can be inclusive by incorporating blocks in higher level cache (e.g., L2 cache) or non-inclusive (having blocks that may be not present in higher level cache). Each core and LLC slice can include a Caching and Home Agent (CHA) (not shown) that can maintain cache coherency by providing scalability of resources across mesh interconnects for Intel® Ultra Path Interconnect (Intel® UPI 1016) cache coherency functionality. UPI 1016 can provide a coherent interconnect for scalable systems and can allow for multiple processors to share a single shared address space through links, such as, but not limited to, two or three UPI links per processor.

Processor 1000 can also include the System Agent 1010 that can house and/or perform various functionalities, such as, but not limited to, memory management, display functions, and/or input/output (I/O) functions. For example, processor 1000 can include one or more integrated memory controller(s) (IMC) 1008. IMC 1008 can control and manage memory, such as, but not limited to, different memory types e.g., DDR ram, like DDR4 or others described elsewhere herein. System Agent 1010 can include a display controller (not shown) to support display(s). System Agent 1010 can also incorporate PCIe 1004 (e.g., up to 20 lanes of PCIe), e.g., that can connect with an external dedicated graphics hookup over DMI bus (e.g., Intel's DMI 3.0 bus) 1006. System Agent 1010 can include an Image Processing Unit (IPU) (not shown) which incorporates an image signal processor (ISP) on-die. Fabric 702 can provide scalability for connecting

FIG. 10B illustrates components within core 1012, in accordance with at least one embodiment. Core 1012 can include front-end 1018, back-end or execution engine 1032, and memory subsystem 1042. Front-end 1018 can provide execution engine 1032 with operations (e.g., operations described elsewhere herein) by decoding instructions stored in memory. For example, front-end 1018 can include a micro-operations (μOps) cache path and/or a legacy path, along with branch prediction unit 1020 that can determine paths instructions. A legacy path for instructions may include fetching variable-length (e.g., x86) instructions from L1 instruction cache, queuing the instructions in instruction queue 1024, and decoding instructions using decoder 1026 into μOps that can be provided to allocation queue 1028. In the alternative, a μOPs cache path may include a cache containing already decoded μOps (μOps 1030) that can be sent to allocation queue 1028. Allocation queue 1028 can perform as an interface between front-end 1018 and execution engine 1032, and can provide instructions to execution engine 1032. One or more of API(s) described herein can, for example, get compiled into instructions that can be stored, processed, and executed by front-end 1018, execution engine 1032, and stored in memory subsystem 1042.

Execution engine 1032 can receive micro-operations into reorder buffer 1034, which can register allocation, rename, and retire μOPs. From the reorder buffer, μOPs can be sent to scheduler 1036 that can be connected one or more different execution units 1038. Execution units 1038 can perform, e.g., basic arithmetic logic unit (ALU) operations, multiplication, division, and/or more complex operations, such as, but not limited to, various vector operations. Scheduler 1036 may manage queuing μOPs for one or more of execution units 1038 depending, e.g., on operations needed to be performed.

Memory subsystem 1042 can process load and store requests as well as ordering operations. For example, μOPs may relate to memory access (e.g. load and store), and those can be sent on dedicated scheduler ports that can perform those memory operations. Store and load operations, for example, can be sent to load and store buffer(s) 1044. Memory subsystem 1042 can also include shared or separate L1 data and instruction cache 1046, as well as L2 cache 1048 that can be used and shared by L1 data and instruction cache 1046. As described above for FIG. 10A, each core 1012 can be connected to a slice of a third level of cache (e.g., LLC 1014) that can be shared by all core 1012.

In at least one embodiment, processor 1000 can include one or more circuits to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. One or more circuits can be configured by software to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein.

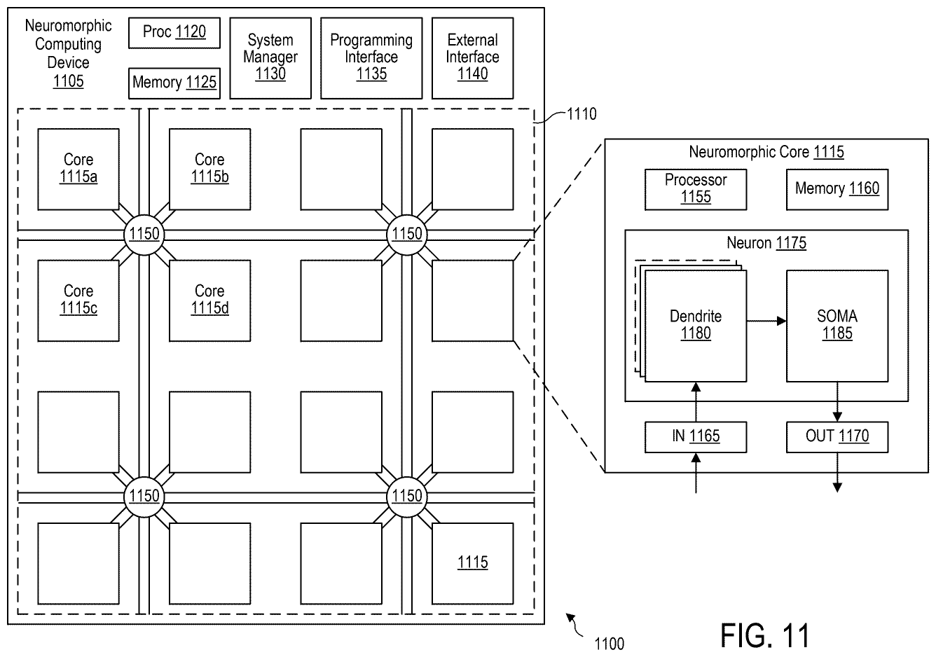

A neuromorphic computing system is described that adopts a multicore architecture where each core houses the computing elements including neurons, synapses with on-chip learning capability, and local memory to store synaptic weights and routing tables. FIG. 11 is a simplified block diagram 1100 illustrating an example of at least a portion of such a neuromorphic computing device 1105, in accordance with at least one embodiment. Neuromorphic computing device 1105 can include a neuromorphic processor from Intel Corporation in Santa Clara, CA or another processor that shares at least some of the components described herein. As shown in this example, a device 1105 may be provided with a network 1110 of multiple neural network cores interconnected by an on-device network such that multiple different connections may be potentially defined between the cores. For instance, a network 1110 of spiking neural network cores may be provided in the device 1105 and may each communicate via short packetized spike messages sent from core to core over the network channels. Each core (e.g., 1115) may possess processing and memory resources and logic to implement some number of primitive nonlinear temporal computing elements, such as, but not limited to, multiple (e.g., 1000+) distinct artificial neurons (referred to herein as “neurons”). For instance, each core may be capable of concurrently implementing multiple neurons such that the collection of neuromorphic cores may implement many multiples of neurons using the device. With respect to neuromorphic computing device 1105 and any of its components described above or elsewhere herein, one or more of APIs or equivalents described herein can, for example, get compiled into instructions or equivalents, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of the processor (e.g., in cache and/or memory). A result of API(s) can then be stored in storage within or outside of the processor, including registers, DRAM, flash, SRAM, cache, or other memory equivalents.

Continuing with the example of FIG. 11, a neuromorphic computing device 1105 may additionally include a processor 1120 and system memory 1125 to implement one or more components to manage and provide functionality of the device. For instance, a system manager 1130 may be provided to manage global attributes and operations of the device (e.g., attributes affecting the network of cores 1110, multiple cores in the network, interconnections of the device 1105 with other devices, manage access to global system memory 1125, among other potential examples). In one example, a system manager 1130 may manage the definition and provisioning of a specific routing tables to the various routers in the network 1110, orchestration of a network definition and attributes (e.g., weights, decay rates, etc.) to be applied in the network, core synchronization and time multiplexing management, routing of inputs to the appropriate cores, among other potential functions.

As another example, a neuromorphic computing device 1105 may additionally include a programming interface 1135 through which a user or system may specify a neural network definition to be applied (e.g., through a routing table and individual neuron properties) and implemented by the mesh 1110 of neuromorphic cores. A software-based programming tool may be provided with or separate from the neuromorphic computing device 1105 through which a user may provide a definition for a particular neural network to be implemented using the network 1110 of neuromorphic cores. The programming interface 1135 may take the input of the programmer to then generate corresponding routing tables and populate local memory of individual neuromorphic cores (e.g., 1115) with the specified parameters to implement a corresponding, customized network of artificial neurons implemented by the neuromorphic cores.

In some cases, a neuromorphic computing device 1105 may advantageously interface with and interoperate with other devices, including general purpose computing devices, to realize certain applications and use cases. Accordingly, external interface logic 1140 may be provided in some cases to communicate (e.g., over one or more defined communication protocols) with one or more other devices. An external interface 1140 may be utilized to accept input data from another device or external memory controller acting as the source of the input data. An external interface 1140 may be additionally or alternatively utilized to allow results or output of computations of a neural network implemented using the neuromorphic computing device 1105 to be provided to another device (e.g., another general purpose processor implementing a machine learning algorithm) to realize additional applications and enhancements, among other examples.

As shown in FIG. 11, a network 1110 of multiple neural network cores interconnected by an on-device network is shown illustrating a portion of a network fabric interconnecting multiple neuromorphic cores (e.g., 1115 a-d). For instance, a number of neuromorphic cores (e.g., 1115 a-d) may be provided in a mesh, with each core being interconnected by a network including a number of routers (e.g., 1150). In one implementation, each neuromorphic core (e.g., 1115 a-d) may be connected to a single one of the routers (e.g., 1150) and each of the routers may be connected to at least one other router (as shown at 1110 in FIG. 11). As an example, in one particular implementation, four neuromorphic cores (e.g., 1115 a-d) may be connected to a single router (e.g., 1150) and each of the routers may be connected to two or more other routers to form a manycore mesh, allowing each of the neuromorphic cores to interconnect with each other neuromorphic core in the device. Moreover, as each neuromorphic core may be configured to implement multiple distinct neurons, the router network of the device may similarly enable connections, or artificial synapses (or, simply, “synapses”), to be defined between any two of the potentially many (e.g., 30,000+) neurons defined using the network of neuromorphic cores provided in a neuromorphic computing device.

FIG. 11 shows a block diagram illustrating internal components of one example implementation of a neuromorphic core 1115. In one example, a single neuromorphic core may implement some number of neurons (e.g. 1024) that share architectural resources of the neuromorphic core in a time-multiplexed manner. In one example, each neuromorphic core 1115 may include a processor block 1155 capable of performing arithmetic functions and routing in connection with the realization of a digitally implemented artificial neuron, such as, but not limited to, explained herein. Each neuromorphic core 1115 may additionally provide local memory in which a routing table may be stored and accessed for a neural network, accumulated potential of each soma of each neuron implemented using the core may be tracked, parameters of each neuron implemented by the core may be recorded, among other data and usage. Components, or architectural resources, of a neuromorphic core 1115 may further include an input interface 1165 to accept input spike messages generated by other neurons on other neuromorphic cores and an output interface 1170 to send spike messages to other neuromorphic cores over the mesh network. In some instances, routing logic for the neuromorphic core 1115 may be at least partially implemented using the output interface 1170. Further, in some cases, a core (e.g., 1115) may implement multiple neurons within an example SNN and some of these neurons may be interconnected. In such instances, spike messages sent between the neurons hosted on the particular core may forego communication over the routing fabric of the neuromorphic computing device and may instead be managed locally at the particular neuromorphic core.

Each neuromorphic core may additionally include logic to implement, for each neuron 1175, an artificial dendrite 1180 and an artificial soma 1185 (referred to herein, simply, as “dendrite” and “soma” respectively). The dendrite 1180 may be a hardware-implemented process that receives spikes from the network. The soma 1185 may be a hardware-implemented process that receives each dendrite's accumulated neurotransmitter amounts for the current time and evolves each dendrite and soma's potential state to generate outgoing spike messages at the appropriate times. A dendrite 1180 may be defined for each connection receiving inputs from another source (e.g., another neuron). In one implementation, the dendrite process 1180 may receive and handle spike messages as they serially arrive in time-multiplexed fashion from the network. As spikes are received, the neuron's activation (tracked using the soma 1185 (and local memory 1160)) may increase. When the neuron's activation exceeds a threshold set for the neuron 1175, the neuron may generate a spike message that is propagated to a fixed set of fanout neurons via the output interface 1170. The network distributes the spike messages to all destination neurons, and in response those neurons, in turn, may update their activations in a transient, time-dependent manner, and so on, potentially causing the activation of some of these destination neurons to also surpass corresponding thresholds and trigger further spike messages, as in real biological neural networks.

As noted above, a neuromorphic computing device may reliably implement a spike-based model of neural computation. Such models may also be referred to as Spiking Neural Networks (SNNs). In addition to neuronal and synaptic state, SNNs also incorporate the concept of time. For instance, in an SNN, communication occurs over event-driven action potentials, or spikes, that convey no explicit information other than the spike time as well as an implicit source and destination neuron pair corresponding to the transmission of the spike. Computation occurs in each neuron as a result of the dynamic, nonlinear integration of weighted spike input. In some implementations, recurrence and dynamic feedback may be incorporated within an SNN computational model. Further, a variety of network connectivity models may be adopted to model various real world networks or relationships, including fully connected (all-to-all) networks, feed-forward trees, fully random projections, “small world” networks, among other examples. A homogeneous, two-dimensional network of neuromorphic cores, such as, but not limited to, shown in the example of FIG. 11 may advantageously supports all of these network models. As all cores of the device may be connected, all neurons defined in the cores may be therefore also fully connected through some number of router hops. The device may further include fully configurable routing tables to define a variety of different neural networks by allowing each core's neurons to distribute their spikes to any number of cores in the mesh to realize fully arbitrary connectivity graphs.

In an improved implementation of a system capable of supporting SNNs, such as, but not limited to, the very large scale integration (VLSI) hardware device illustrated in the example of FIG. 9, high speed and reliable circuits may be provided to implement SNNs to model the information processing algorithms as employed by the brain, but in a more programmable manner. For instance, while a biological brain can only implement a specific set of defined behaviors, as conditioned by years of development, a neuromorphic processor device may provide the capability to rapidly reprogram all neural parameters. Accordingly, a single neuromorphic processor may be utilized to realize a broader range of behaviors than those provided by a single slice of biological brain tissue. This distinction may be realized by adopting a neuromorphic processor with neuromorphic design realizations that differ markedly from those of the neural circuits found in nature.

As an example, a neuromorphic processor may utilize time-multiplexed computation in both the spike communication network and the neuron machinery of the device to implement SNNs. Accordingly, the same physical circuitry of the processor device may be shared among many neurons to realize higher neuron density. With time multiplexing, the network can connect N cores with O(N) total wiring length, whereas discrete point-to-point wiring would scale as O(N2), realizing a significant reduction in wiring resources to accommodate planar and non-plastic VLSI wiring technologies, among other examples. In the neuromorphic cores, time multiplexing may be implemented through dense memory allocation, for instance, using Static Random Access Memory (SRAM), with shared buses, address decoding logic, and other multiplexed logic elements. A state of each neuron may be stored in the processor's memory, with data describing each neuron state including state of each neuron's collective synapses, all currents and voltages over its membrane, among other example information (such as, but not limited to, configuration and other information).

A neuromorphic processor may adopt a “digital” implementation that diverts from other processors adopting more “analog” or “isomorphic” neuromorphic approaches. For instance, a digital implementation may implement the integration of synaptic current using digital adder and multiplier circuits, as opposed to the analog isomorphic neuromorphic approaches that accumulate charge on capacitors in an electrically analogous manner to how neurons accumulate synaptic charge on their lipid membranes. The accumulated synaptic charge may be stored, for instance, for each neuron in local memory of the corresponding core. Further, at the architectural level of an example digital neuromorphic processor, reliable and deterministic operation may be realized by synchronizing time across the network of cores such that any two executions of the design, given the same initial conditions and configuration, will produce identical results. Asynchrony may be preserved at the circuit level to allow individual cores to operate as fast and freely as possible, while maintaining determinism at the system level. Accordingly, the notion of time as a temporal variable may be abstracted away in the neural computations, separating it from the “wall clock” time that the hardware utilized to perform the computation. Accordingly, in some implementation, a time synchronization mechanism may be provided that globally synchronizes the neuromorphic cores at discrete time intervals. The synchronization mechanism allows the system to complete a neural computation as fast as the circuitry allows, with a divergence between run time and the biological time that the neuromorphic system models.

In operation, the neuromorphic mesh device may begin in an idle state with all neuromorphic cores inactive. As each core asynchronously cycles through its neurons, it generates spike messages that the mesh interconnect routes to the appropriate destination cores containing all destination neurons. As the implementation of multiple neurons on a single neuromorphic core may be time-multiplexed, a time step may be defined in which all spikes involving the multiple neurons may be processed and considered using the shared resources of a corresponding core. As each core finishes servicing its neurons for a respective time step, the cores may, in some implementations, communicate (e.g., using a handshake) with neighboring cores using synchronization messages to flush the mesh of all spike messages in flight, allowing the cores to safely determine that all spikes have been serviced for the time step. At that point all cores may be considered synchronized, allowing them to advance their time step and return to the initial state and begin the next time step.

Given this context, and as introduced above, a device (e.g., 1105) implementing a mesh 1110 of interconnected neuromorphic cores may be provided, with the core implementing potentially multiple artificial neurons capable of being interconnected to implement an SNN. Each neuromorphic core (e.g., 1115) may provide two loosely coupled asynchronous processes: an input dendrite process (e.g., 1180) that receives spikes from the network and applies them to the appropriate destination dendrite compartments at the appropriate future times, and an output soma process (e.g., 1185) that receives each dendrite compartment's accumulated neurotransmitter amounts for the current time and evolves each dendrite and soma's membrane potential state, generating outgoing spike messages at the appropriate times (e.g., when a threshold potential of the soma has been reached). Note that, from a biological perspective, the dendrite and soma names used here only approximate the role of these functions and should not be interpreted too literally.

In at least one embodiment, neuromorphic computing device 1105 can include one or more circuits to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. One or more circuits can be configured by software to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein.

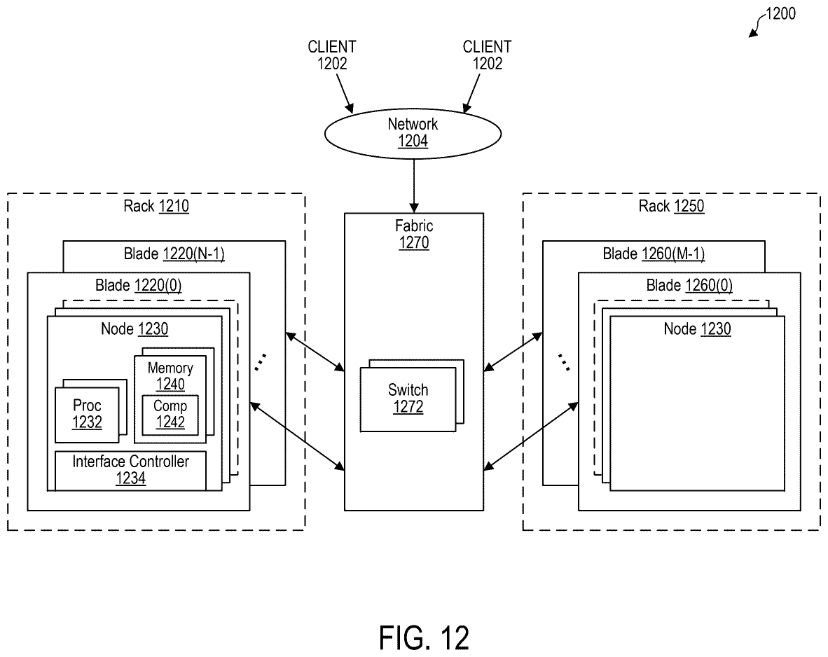

FIG. 12 is a block diagram of an embodiment of a multi-node network in which remote memory computation can be implemented, in accordance with any embodiment. System 1200 may represent a network of nodes described herein that can, e.g., be used to perform some or all of the operations described herein. System 1200 can represent a data center. System 1200 may represent a server farm. System 1200 may represent a data cloud or a processing cloud. System 1200 can represent a supercomputer. System 12 may include tens, hundreds, or thousands of nodes. The nodes of system 1200 may include processors, such as, but not limited to, central processing units (CPUs), graphics processing units (GPUs), or any combination of processors described herein, such as, but not limited to, other processors in FIGS. 7-18. With respect to any of the processors in system 1200 and any of its components described above or elsewhere herein, one or more of APIs or equivalents described herein can, for example, get compiled into instructions or equivalents, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of the processor (e.g., in cache and/or memory). A result of API(s) can then be stored in storage within or outside of the processor, including registers, DRAM, flash, SRAM, cache, or other memory equivalents. System 1200 may include over nine thousand nodes, with each node including two Intel Xeon Max processors, six Intel Max series GPUs and a unified memory architecture, such as, but not limited to, that used in the Intel Aurora Supercomputer from the Intel Corporation in Santa Clara, CA or another supercomputer that shares at least some of the components described herein.

One or more clients 1202 make requests over network 1204 to system 1200. Network 1204 represents one or more local networks, or wide area networks, or a combination. Clients 1202 can be human or machine clients, which generate requests for the execution of operations by system 1200. System 1200 executes applications or data computation tasks requested by clients 1202.

System 1200 can include one or more racks, which represent structural and interconnect resources to house and interconnect multiple computation nodes. Rack 1210 can include multiple nodes 1230. rack 1210 may host multiple blade components 1220. Hosting can refer to providing power, structural or mechanical support, and interconnection. Blades 1220 can refer to computing resources on printed circuit boards (PCBs), where a PCB houses the hardware components for one or more nodes 1230. Blades 1220 may or may not include a chassis or housing or other “box” other than that provided by rack 1210. Blades 1220 may include housing with exposed connector to connect into rack 1210. System 1200 may or may not include rack 1210, and each blade 1220 can include a chassis or housing that can stack or otherwise reside in close proximity to other blades and allow interconnection of nodes 1230. System 1200 may include 10,624 compute blades, which include 63,744 Intel Max Series GPUs and 21,248 Intel Xeon Max CPUs across 166 racks.

System 1200 can include fabric 1270, which represents one or more interconnectors for nodes 1230. Fabric 1270 can include multiple switches 1272 or routers or other hardware to route signals among nodes 1230. Additionally, fabric 1270 can couple system 1200 to network 1204 for access by clients 1202. In addition to routing equipment, fabric 1270 can be considered to include the cables or ports or other hardware equipment to couple nodes 1230 together. Fabric 1270 can have one or more associated protocols to manage the routing of signals through system 1200. The protocol or protocols is at least partly dependent on the hardware equipment used in system 1200.

As illustrated, rack 1210 can include N blades 1220. In addition to rack 1210, system 1200 can include rack 1250. As illustrated, rack 1250 may include M blades 1260. M is not necessarily the same as N; thus, it will be understood that various different hardware equipment components could be used, and coupled together into system 1200 over fabric 1270. Blades 1260 can be the same or similar to blades 1220. Nodes 1230 can be any type of node as described herein, and may not be necessarily all the same type of node. System 1200 is not limited to being homogenous, nor is it limited to not being homogenous.

A node in blade 1220(0) is illustrated in detail. However, other nodes in system 1200 can be the same or similar. At least some nodes 1230 may be computation nodes, with processor 1232 and memory 1240. A computation node refers to a node with processing resources (e.g., one or more processors) that executes an operating system and can receive and process one or more tasks. At least some nodes 1230 can include storage server nodes with a server as processing resources 1232 and memory 1240. A storage server refers to a node with more storage resources than a computation node, and rather than having processors for the execution of tasks, a storage server includes processing resources to manage access to the storage nodes within the storage server.

Node 1230 can include interface controller 1234, which can represent logic to control access by node 1230 to fabric 1270. Logic can include hardware resources to interconnect to the physical interconnection hardware. Logic can include software or firmware logic to manage the interconnection. Interface controller 1234 can be or includes a host fabric interface, which can be a fabric interface in accordance with any embodiment described herein.

Node 1230 may include memory subsystem 1240. Memory 1240 can include memory computation resources (comp) 1242, which represent one or more capabilities by memory 1240 to perform memory computations. System 1200 enables remote memory operations, such as, but not limited to, the operations described elsewhere herein. Thus, nodes 1230 can request memory computations by remote nodes, where data for the computation remains local to the executing node instead of being sent over fabric 1270 or instead of being sent from the memory to the fabric interface. In response to execution of the memory computation, the executing node can provide a result to the requesting node.

Processor 1232 can include one or more separate processors. Each separate processor can include a single processing unit, a multicore processing unit, or a combination. The processing unit can be a primary processor such as, but not limited to, a CPU (central processing unit), a peripheral processor such as, but not limited to, a GPU (graphics processing unit), or a combination. Memory 1240 can be or include memory devices and a memory controller.

Reference to memory devices can apply to different memory types. Memory devices generally refer to volatile memory technologies. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random access memory), or some variant such as, but not limited to, synchronous DRAM (SDRAM). A memory subsystem as described herein may be compatible with a number of memory technologies, such as, but not limited to, DDR3 (dual data rate version 3, original release by JEDEC (Joint Electronic Device Engineering Council) on Jun. 27, 2007, currently on release 21), DDR4 (DDR version 4, initial specification published in September 2012 by JEDEC), DDR4E (DDR version 4, extended, currently in discussion by JEDEC), LPDDR3 (low power DDR version 3, JESD209-3B, August 2013 by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (currently in discussion by JEDEC), HBM2 (HBM version 2), currently in discussion by JEDEC), or others or combinations of memory technologies, and technologies based on derivatives or extensions of such specifications.

In addition to, or alternatively to, volatile memory, in one embodiment, reference to memory devices can refer to a nonvolatile memory device whose state is determinate even if power is interrupted to the device. In one embodiment, the nonvolatile memory device is a block addressable memory device, such as, but not limited to, NAND or NOR technologies. Thus, a memory device can also include a future generation nonvolatile device(s), such as, but not limited to, a three dimensional crosspoint (3DXP) memory device, other byte addressable nonvolatile memory devices, or memory devices that use chalcogenide phase change material (e.g., chalcogenide glass). In one embodiment, the memory device can be or include multi-threshold level NAND flash memory, NOR flash memory, single or multi-level phase change memory (PCM) or phase change memory with a switch (PCMS), a resistive memory, nanowire memory, ferroelectric transistor random access memory (FeTRAM), magnetoresistive random access memory (MRAM) memory that incorporates memristor technology, or spin transfer torque (STT)-MRAM, or a combination of any of the above, or other memory.

In at least one embodiment, system 1200 can include one or more circuits to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. One or more circuits can be configured by software to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein.

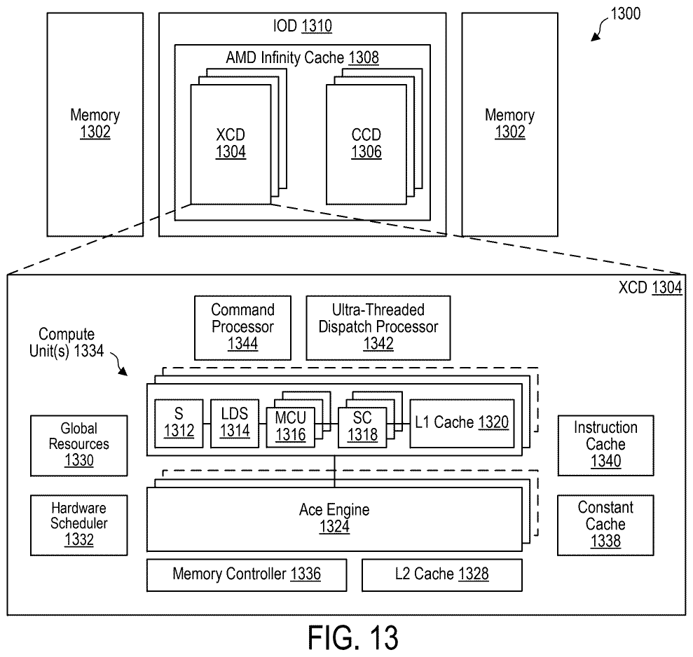

FIG. 13 illustrates accelerated processing unit 1300, in accordance with at least one embodiment. Accelerated processing unit 1300 can include a processor based on CDNA architecture from AMD Corporation in Santa Clara, CA or another processor that shares at least some of the components described herein. Accelerated processing unit 1300 can include one or more accelerator complex dies (XCDs) 1304 for performing operations described elsewhere herein, such as, but not limited to, graphics processing and/or parallel processing as well as computations with instruction-level parallelism, including support for a broad range of precisions (INT8, FP8, BF16, FP16, TF32, FP32, and FP64) and sparse matrix data (i.e. sparsity). XCDs may, in some instances, be referred to as Graphics Compute Dies (GCDs). Accelerated processing unit 1300 can include one or more complex compute dies (CCDs) 1306 for performing operations described elsewhere herein, such as, but not limited to, those operations performed by host processors. CCDs may, in some instances, be referred to as core complexes or CCXs, such as, but not limited to, CCXs used in AMD Ryzen processors. XCDs and CCDs can share any type of cache or memory (e.g., one or more memory units 1302), or have cache or memory allocated to each XCD or CCD or groups of XCDs or CCDs. For example, on-package AMD Infinity Fabric connects XCDs and CCD into shared AMD Infinity Cache 1308 and, in some embodiments, high-bandwidth memory (e.g., HMB3). Accelerated processing unit 1300 can be an AMD MI300a processor that includes three CPU chiplets (or CCDs) and six accelerator chiplets (XCDs) on top of four input-output dies (IODs) that may be layered on a piece of silicon that links them together (e.g., via AMD Infinity Fabric) to eight stacks of high-bandwidth DRAM that ring the superchip. An AMD MI300x processor substitutes the CCDs for two more XCDs, for an accelerator-only system.

Accelerated processing unit 1300 can include one or more input/output (I/O) interfaces. For example, XCDs 1304 and CCDs 1306 can be together on one or more input-output dies (IODs) 1310 that can include one or more I/O interfaces. IODs 1310 can include of any number and type of I/O interfaces (e.g., PCI, PCI-Extended (“PCI-X”), PCIe, gigabit Ethernet (“GBE”), USB, etc.). Various types of peripheral devices can be coupled to I/O interfaces 770. I/O interfaces from IODs 1310 can also be used for connected one or more accelerated processing units 1300, e.g., in a server architecture.

Accelerated processing unit 1300 can include one or more memory units 1302 for storing instructions and other information used to perform operations described elsewhere herein. Memory units 1302 can include any volatile memory, such as, but not limited to, memory types described elsewhere herein and can include, e.g., high-bandwidth memory (e.g., HMB3) or high-bandwidth DRAM. Memory associated with accelerated processing unit 1300 (e.g., memory units 1302) can include system memory that can be used, for example, for commands, instructions and constants, and inputs and outputs. Memory units 1302 can also include device memory that can be used as storage and, for example, for commands, instructions and constants, and inputs and outputs, as return buffer(s) and for private data. Memory units 1302 can be linked to one or more IODs 1310. In at least on embodiment, L1 cache 1320 starts a memory hierarchy that includes shared L2 cache 1328, e.g., within the XCDs. AMD Infinity Cache™, which is a last level cache (LLC) located on an active I/O die (IOD). CCDs 1306 and XCDs 1304 may have separate or shared memory. AMD Infinity Architecture and AMD Infinity Fabric™ technology can enable coherent, high-throughput unification of GPU and CPU chiplet technologies (e.g., XCDs, CCDs, and/or CCXs) with memory (e.g., stacked HBM3 memory) in single devices and across multi-device platforms.

As shown in FIG. 13, an XCD 1304 can include a shared set of global resources 1330, which can include hardware scheduler 1312 and Asynchronous Compute Engines (ACE) 1324 that send tasks (e.g., compute shader workgroups) to Compute Units (CUs or cores) 1330. ACEs 1324 (e.g., four) can be each associated with CUs 1330 (e.g., 40 CUs), and some of the CUs can be disabled for yield management. CUs 1330 can have dedicated cache or share cache (e.g., L2 cache) 1328 that may be used to coalesce all the memory traffic for the die. CUs 1330 can include threaded and parallel processor cores including instruction fetching and scheduling with Scheduler (S) 1312, matrix core unit (MCU) 1316 and shader core (SC) 1318 (e.g., execution units for scalar, vector and matrix data types), as well as load/store pipelines with an L1 cache 1320 and Local Data Share (LDS) 1314. Local data share can include, for example, a scratch RAM with built-in arithmetic capabilities that allow data to be shared between threads in a workgroup. An instruction cache 1340 (e.g., for storing and providing the instructions for performing operations described elsewhere herein) can be connected to one or more CUs and can be shared between two CUs. Matrix cores 1316 can process a variety of data types, such as, but not limited to, INT8, FP8, FP16, BF16 and TF32 data types. Accelerated processing unit 1300 can include compute units 1330 that may be arranged in an array format, e.g., as a data-parallel-processor (DPP) array. Ultra-threaded dispatch processor 1342 can communicate with compute units 1330, and command processor 1344 can read commands that the host has written to memory-mapped registers in a system-memory address space (not shown). Command processor 1344 can send hardware-generated interrupts to a host processor (e.g., a CCD) when the command is completed. Memory controller 1336 can also have direct access to all device memory and the host-specified areas of system memory. To satisfy read and write requests, memory controller 1336 can perform functions of a direct-memory access (DMA) controller, including computing memory-address offsets based on the format of the requested data in memory. For example, one or more of APIs described herein can, for example, get compiled into instructions that can be stored in instruction cache 1340 and then fetched by instruction fetch logic in processor 1340, decoded by a processor decoder or equivalents, scheduled (e.g., in order or out of order) for execution by a scheduler or equivalents, executed by execution logic or equivalents, reordered, and then retired by the retirement logic or equivalents. API(s) (and/or compiled instructions including API(s)) can be stored in any storage outside or inside of processor 1300 (e.g., in cache and/or memory). A result of API(s) can then be stored in storage within or outside of the processor, including registers, DRAM, flash, SRAM, cache, or other memory equivalents.

An application can include a program running on a host processor (e.g., a CCD) and programs, called kernels, running on one or more XCDs. Programs can be controlled by host commands that set internal base-address and other configuration registers, specify a data domain on which the accelerated processing unit 1300 can operate, invalidate and flush caches on accelerated processing unit 1300, and cause accelerated processing unit 1300 to begin execution of a program. Kernels can be referred to as programs executed by accelerated processing unit 1300. A kernel can be executed independently on every work item, or as groups of work-items that can be referred to as a wavefront, which can execute the kernel on all work-items in the group (e.g., 64) in one pass. Compute units 1330 can include a scalar arithmetic logic unit (ALU), which can operates on one value per wavefront (common to all work items), a vector ALU, which can operate on unique values per work-item, a local data share 1314, which can allow work-items within a workgroup to communicate and share data, a scalar memory (not shown), which can transfer data between scalar general-purpose registers (SGPRs) and memory through a cache, and vector memory, which can transfer data between vector general-purpose registers (VGPRs) and memory, including sampling texture maps. Kernel control flow can be handled using scalar ALU instructions, which can includes if/else, branches and looping. Scalar ALU (SALU) and memory instructions can work on an entire wavefront and operate on one or more SGPRs. Vector memory and ALU instructions can operate on all work-items in the wavefront at one time.

In at least one embodiment, accelerated processing unit 1300 can include one or more circuits to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. One or more circuits can be configured by software to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein.

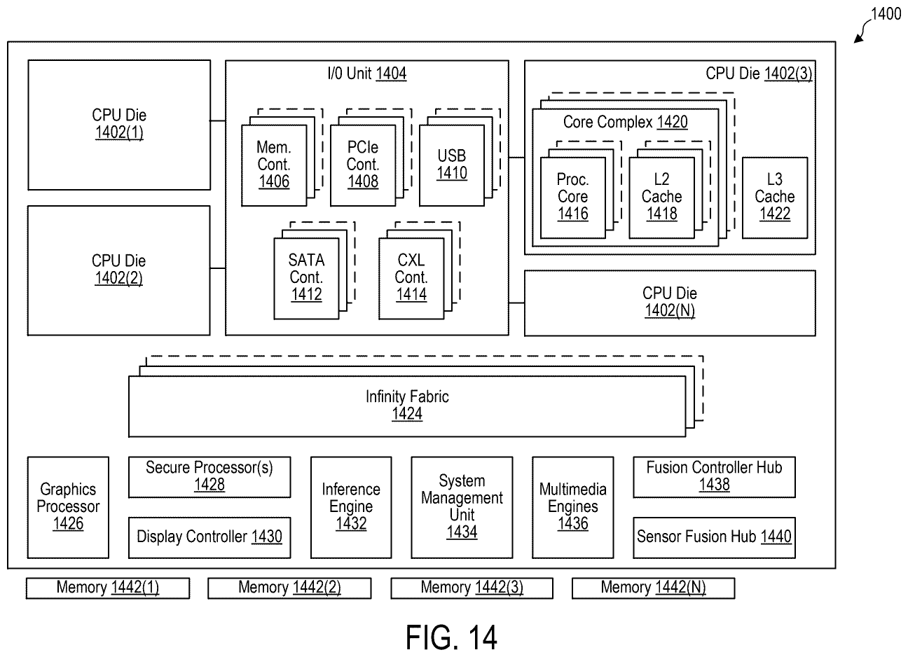

FIG. 14 illustrates a processor 1400, such as, but not limited to, a processor based on a Zen architecture (such as, e.g., Zen 1, 2, 3, 4, 5 or other) from AMD Corporation in Santa Clara, CA or another processor that shares at least some of the components described herein. Processor 1400 includes one or more CPU dies 1402(1)-1402(N), where N is any integer greater than 1. CPU die 1402 can include any number of processor cores 1416 (e.g., to perform any of the operations described elsewhere herein) and any number of cache memories (e.g., to store instructions and other information to perform any of the operations described elsewhere herein), in any combination. For example, L2 Cache units 1418 can be coupled to processor core(s) 1416, which can share and/or couple individually to L2 Cache units 1418. Processor cores 1416 can couple to L3 cache 1422 individually and/or share L3 Cache, which can be a lowest level cache (LLC) 1422 for access to data and other information used by the processor cores 1416. One or more processor cores 1416 and one or more L2 Cache units 1418 can be included in a core complex (CCX) 1420 that can include (e.g., a 32 MB) shared cache (e.g., L3 cache 1422). Core complex 1420 can be fabricated onto a die (CCD or CPU die) 1402. For example, up to 12 core complexes 1420 can be configured into a processor along with 8 CPU dies 1402 to provide up to 96 processor cores 1416 for the processor. A ‘Zen 4c’ core complex 1420, for example, can include up to eight cores 1416 and a shared 16 MB L3 cache 1422. Two of these core complexes 1420 can be combined onto a single CPU die 1402 for 16 cores per die and a total of 32 MB of L3 cache 1422 per die. Up to eight CPU dies 1402 may be combined with an I/O unit 1404 to provide CPUs with up to 128 processor cores 1416. Up to four ‘Zen 4c’ dies described above can be combined to provide CPUs with up to 64 processor cores 1416.

Processor 1400 can include a variety of configurations for input/output operations that are described further herein. I/O unit 1404 can include one or more memory controllers 1406 that can manage memory usage (e.g., DDR5 memory) for processor 1400. I/O unit 1404 may include one or more SATA disk controllers for managing storage 1412 and one or more Compute Express Link (CXL™) 1.1+ memory controllers 1414 that can provide CPU-to-device and CPU-to-memory connections and can be flexibly assigned to specific functions at server design time. I/O unit 1404 may include PCIe controller 1408 for connecting peripherals and other components connected to processor 1400. I/O unit 1404 may include USB ports 1410 for connecting to other components separate from processor 1400. CPU dies 1402 can support any number of connections, e.g., one or two connections, to I/O unit 1404. As shown, I/O unit 1404 includes the components described further herein, and I/O unit 1404 can be a I/O die that houses several different components. Memory controller 1406, PCIe controller 1408, USB ports 1410, SATA controller 1412, and/or CXL controller 1414 can be integrated anywhere within processor 1400 either separately or in any groups or combinations thereof.

Processor 1400 can include Infinity Fabric 1424 interconnects (which can be similar to or based on PCIe architectures) that can provide connections among CPUs (e.g., CPU dies 1402(1)-1402(N)), graphics processor(s) 1426, inference engine(s) 1432, and other components in the multi-chip architecture, such as secure processor(s) 1428 and I/O unit 1404. One or more AMD Infinity Fabric™ interconnects 1410 can connect to CPU dies 1402(1)-1402(N) and serve as a connection that is used between CPUs. One or more Infinity Fabric connections 1410 can connect each CPU die 1402 to the I/O unit 1410.

In at least one embodiment, processor 1400 can include central processing units (CPUs) and other associated hardware and software described above and further herein. Processor 1400 can also include graphics processor(s) 1426. Graphics processor 1426 can be used for image generation and processing, as well as other computations and operations described further herein. Graphics processor 1426 can be based on RDNA 3 or 3.5 architecture from AMD in Santa Clara, CA. Graphics processor 1426 can include graphics compute dies (GCDs) and memory cache dies (MCDs). GCDs can include any number of compute units (CUs) for graphics or other processing, such as operations performed by arithmetic logic units (ALUs) that are described further herein. Graphics processor 1426 can include L2 cache that can be used by compute units. MCDs (not shown) can include any number of memory units and can include cache, such as L3 cache, as well as memory interfaces for coupling to memory, such as memory 1442(1)-(N), where N is an integer. Components within graphics processor 1426 can be connected using various approaches, such as using Infinity Fabric 1424 interconnects outside or within graphics processor 1426.

Inference engine 1432 can provide neural processing capabilities for processor 1400 for computational processes that are used for neural networks, deep learning, and other artificial intelligence-related operations described further herein. Processor 1400 can include secure processor(s) 1428 for managing security of the processor, display controller 1430 for controlling displays, a system management unit 1434 for managing and operating some or all of the components on processor 1400, multimedia engines 1436 for audio and video operations, fusion controller hub 1438 for managing USB, SATA and PCIe connections to the processor, and sensor fusion hub 1440 for managing sensors, such as accelerometers. Processor 1400 can also include memory 1442(1)-(N), where N is any integer. Memory can include different memory types, such as LPDDR5 and/or DDR5, or others described elsewhere herein.

For performing operations described further herein, processor 1400 can include an execution pipeline including a front-end that can include a cache (e.g., L1 cache) that stores instructions (not shown). Flow of instructions can be modified by a branch predictor. Instructions can be decoded by a decoder, dispatched to a back-end for execution, and renamed. Instruction fetch and decode pipes, for example, can be dispatched to integer or floating point execution operations that can be scheduled by a scheduler and transferred to vector and/or general-purpose registers. Floating point multiplier and/or add operations can be processed, and arithmetic logic units (ALUs) can also be used to perform computations, such as arithmetic and logic operations. Outputs from the computation units can be coupled to a load/store queue, which can be connected to cache, such as L1 cache and/or L2 cache.

With respect to processor 1400 and any of its components described above or elsewhere herein, one or more of APIs or equivalents described herein can, for example, get compiled into instructions or equivalents (e.g., AVX-512 instructions based on an SIMD model), which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of the processor (e.g., in cache and/or memory). A result of API(s) can then be stored in storage within or outside of the processor, including registers, DRAM, flash, SRAM, cache, or other memory equivalents.

In at least one embodiment, processor 1400 can include one or more circuits to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. One or more circuits can be configured by software to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein.

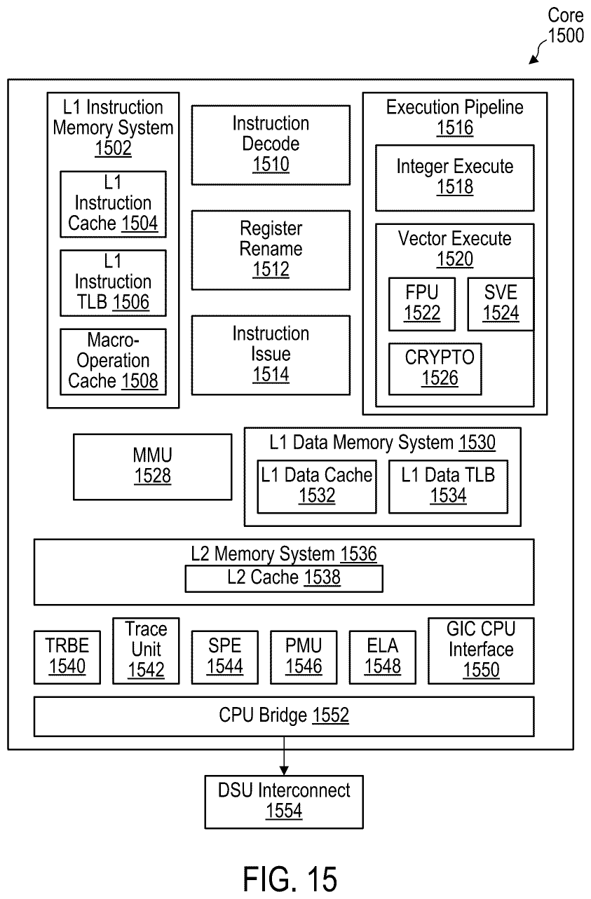

FIG. 15 illustrates an example of a processing core 1500 that may implement Arm architecture (e.g., v9.0-A) or another processor that shares at least some of the components described herein. Neoverse™ V2 core 1500 can be implemented inside a DynamIQ Shared Unit (DSU) cluster via DSU-110 interconnect 1554 for connected one or more cores, e.g., for parallel processing. Neoverse™ V2 core may be implemented as a single core in a DSU cluster that is configured for Direct connect, with or without L3 cache, snoop filter, or Snoop Control Unit (SCU) logic (not shown). Neoverse™ V2 core can include a CPU bridge 1552 that connects core 1500 to DSU-110 interconnect, which can also connect core 1500 to an external memory system and the rest of a system-on-a-chip. The L1 instruction memory system 1502 can fetch instructions from an instruction cache 1504 and deliver the instructions (e.g., one or more APIs described herein that may be compiled into instructions) to an instruction decode unit 1510, e.g., to perform some or all of the operations described above or elsewhere herein. L1 instruction memory system 1502 may include L1 instruction cache 1504, e.g., with 64-byte cache lines, L1 instruction Translation Lookaside Buffer (TLB) 1506, e.g., with native support for 4 KB, 16 KB, 64 KB, and 2 MB page sizes, Macro-Operation Cache (MOP) 1508 (e.g., 1536-entry, 4-way skewed associative L0 MOP cache), which can contain decoded and optimized instructions for higher performance. Instruction decode unit 1510 can decode AArch64 instructions into internal format. Register rename unit 1512 can perform register renaming to facilitate out-of-order execution and dispatches decoded instructions to various issue queues. Instruction issue unit 1514 can control when decoded instructions may be dispatched to the execution pipelines, and it can include issue queues for storing instructions pending dispatch to execution pipelines. Integer execution pipeline 1516 can be included in an execution pipeline and include integer execute unit 1518 that can perform arithmetic and logical data processing operations. Vector execute unit 1520 can be included in an execution pipeline and can perform Advanced SIMD and floating-point operations (FPU) 1522, execute Scalable Vector Extension (SVE) and Scalable Vector Extension 2 (SVE2) instructions 1524, and can optionally execute the cryptographic instructions (Crypto) 1526. Advanced SIMD can include media and signal processing architecture that adds instructions primarily for audio, video, 3D graphics, image, and speech processing. A floating-point architecture provides support for single-precision and double-precision floating-point operations. L1 data memory system 1530 can execute load and store instructions, as well as service memory coherency requests. L1 data memory system 1530 can include an L1 data cache 1532 and a fully associative L1 data TLB 1534 with native support for 4 KB, 16 KB and 64 KB page sizes and 2 MB and 512 MB block sizes. Memory Management Unit (MMU) 1528 can provide fine-grained memory system control through a set of virtual-to-physical address mappings and memory attributes that can be held in translation tables, which can be saved into TLB 1534 when an address is translated. L2 memory system 1536 can include L2 cache 1538, and it can be connected to DSU-110 1554 through an asynchronous CPU bridge 1552. Neoverse™ V2 core 1500 can support a range of debug, test, and trace options including a trace unit 1542 and a trace buffer 1540, and an Embedded Logic Analyzer (ELA) 1548. Neoverse™ V2 core 1500 can implement the Statistical Profiling Extension (SPE) 1544 to provide a statistical view of the performance characteristics of executed instructions that software writers can use to optimize their code for better performance. Performance Monitoring Unit (PMU) 1546 can provide performance monitors that can be configured to gather statistics on the operation of each core and the memory system. The information can be used for debug and code profiling. Generic Interrupt Controller (GIC) CPU interface 1550, when integrated with an external distributor component, can be a resource for supporting and managing interrupts in a cluster system. In a cluster, there can be one CPU bridge 1552 between each Neoverse™ V2 core 1500 and DSU-110 1554. CPU bridge 1552 can control buffering and synchronization between core 1500 and the DSU-110 1554. CPU bridge 1552 can be asynchronous to allow different frequency, power, and area implementation points for each core 1500. CPU bridge 1552 can run synchronously without affecting the other interfaces such as, but not limited to, debug and trace which can be asynchronous.

In at least one embodiment, core 1500 can include one or more circuits to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. One or more circuits can be configured by software to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein.

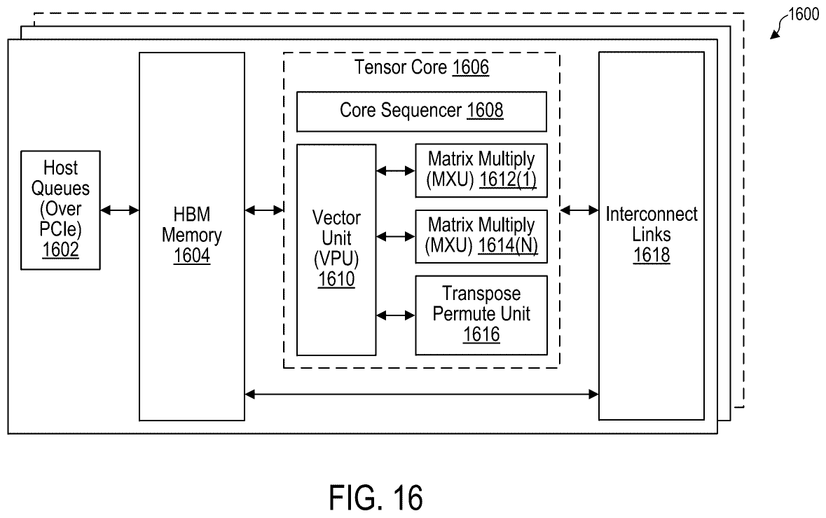

FIG. 16 illustrates one or more chips including one or more tensor processing units (TPUs) 1600, in accordance with at least one embodiment. TPUs 1600 in FIG. 16 can include application specific integrated circuits (ASICs), e.g., to perform some or all of the operations described above or elsewhere herein, such as, but not limited to, accelerate machine learning workloads performing matrix operations. TPUs 1600 may be ASICs from Alphabet Corporation in Mountain View, CA. Cloud TPU includes a cloud service that makes TPUs available as a scalable resource for processing tasks, such as, but not limited to, machine learning workloads that can run on frameworks such as, but not limited to, TensorFlow, Pytorch, and JAX.

Chip 1600 can include any number of TPUs that can include tensor cores 1606. Tensor core 1606 can include one or more core sequencer 1608, vector processing unit (VPU) 1610, matrix multiply unit (MXU) 1612(A)-1614(N), where N is any integer greater than 1, and a transpose permute unit 1616. Core Sequencer 1608 can fetch (e.g., VLIW (Very Long Instruction Word)) instructions from core's 1606 Instruction Memory (Imem), execute scalar operations using a scalar data memory (Smem) and scalar registers (Sregs) (not shown), and forward vector instructions to Vector Processing Unit (VPU) (1610. The instructions can, for example, launch eight operations: two scalar, two vector ALU, vector load and store, and a pair of slots that queue data to and from the matrix multiply and transpose units. VPU 1610 can perform vector operations using a large on-chip vector memory (Vmem), and vector registers (Vregs). VPU 1610 can stream data to and from the MXU through decoupling FIFOs. VPU 1610 can collect and distribute data to Vmem via data-level parallelism (2D matrix and vector functional units) and instruction-level parallelism (8 operations per instruction). A large two-dimensional matrix multiply unit (MXU) 1612(A)-1612(N) can, e.g., use a systolic array to reduce area and energy plus large, software-controlled on-chip memories instead of caches. Transpose Reduction Permute Unit 1616 can do (e.g., 128×128) matrix transposes, reductions, and permutations of the VPU 1610 lanes. High Bandwidth Memory 1604 can be used for applications on chip. One or more chips 1600 can be connected together for computing. For example, one or more chips 1600 can be connected as a torus, e.g., a 2D torus. Chip 1600 can also include any number (e.g., four) Inter-Core Interconnect (ICI) links 1618 that can enable direct connections between chips to form a supercomputer.

With respect to any of the processors in chip 1600 and any of its components described above or elsewhere herein, one or more of APIs or equivalents described herein can, for example, get compiled into instructions or equivalents, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of the processor (e.g., in cache and/or memory). A result of API(s) can then be stored in storage within or outside of the processor, including registers, DRAM, flash, SRAM, cache, or other memory equivalents.

In at least one embodiment, chip 1600 can include one or more circuits to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. One or more circuits can be configured by software to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein.

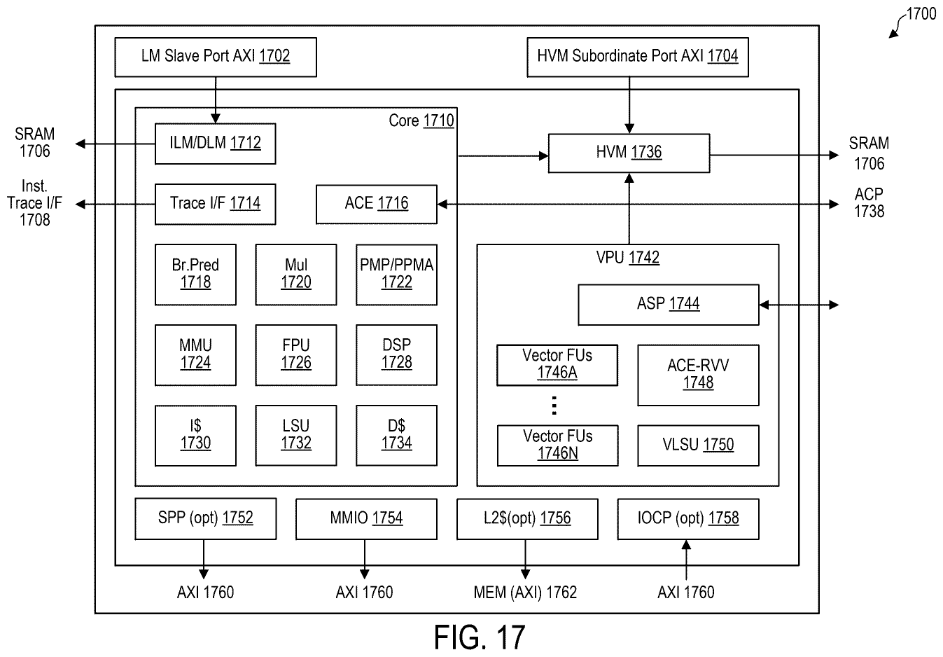

FIG. 17 illustrates a vector processor, in accordance with at least one embodiment. Vector processor 1700 may support a RISC-V standard. Vector processor 1700 can include one more cores 1710 (e.g., scalar units) with one or more Vector Processing Units (VPUs) 1742 (e.g., vector units) that can, e.g., perform some or all of the operations described above or elsewhere herein. Core 1710 may include Andes Custom Extension (ACE) 1716 that can be used for communication of customized instructions for the processor 1700. Core 1710 may include 1-cycle multiplier and 1-cycle instruction/data local memory (ILM/DLM) for increased parallelism by allowing simultaneous instruction fetches and data accesses. Memory management unit (MMU) 1724 may manage system memory and cache, and provide for branch execution, issuance of instruction pairs, L1 instruction/data caches and local memory storage. Core 1710 can include Physical memory protection and programmable physical memory attribute unit (PMP/PPMA) 1722. Core 1710 can include a digital signal processor (DSP) 1728, and a floating-point unit (FPU) 1726 as well as load-store unit (LSU) 1732 to interface with the memory hierarchy (D$ 1734 and I$ 1730). Core 1710 can include branch prediction unit 1718 and multiplier unit 1720.

Vector processing unit (VPU) 1742 can include one or more vector functional units (FUs) 1746(A)-1746(N) that can be chained together for parallel processing, independent memory paths for RISC-V vector (RVV) load/store via ACE-RVV 1748 and Andes Streaming port (ASP) 1744 load/store, and a vector load/store unit (VLSU) 1750.

Vector processor 1700 can include bus interfaces, such as, but not limited to, L2 cache memory port 1756 for cacheable access, a MMIO port 1754 for non-cacheable access, an input-output coherence Port (IOCP) 1758 for cacheless bus master, local memory access ports for ILM/DLM 1712 and high-bandwidth vector memory (HVM) 1736 access, a shared peripheral port (SPP) 1752 for external peripherals. Other memory ports include LM slave port AXI 1702 and HVM subordinate port AXI 1704.

With respect to any of the processors in processor 1700 and any of its components described above or elsewhere herein, one or more of APIs or equivalents described herein can, for example, get compiled into instructions or equivalents, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of the processor (e.g., in cache and/or memory). A result of API(s) can then be stored in storage within or outside of the processor, including registers, DRAM, flash, SRAM, cache, or other memory equivalents.

In at least one embodiment, vector processor 1700 can include one or more circuits to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. One or more circuits can be configured by software to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein.

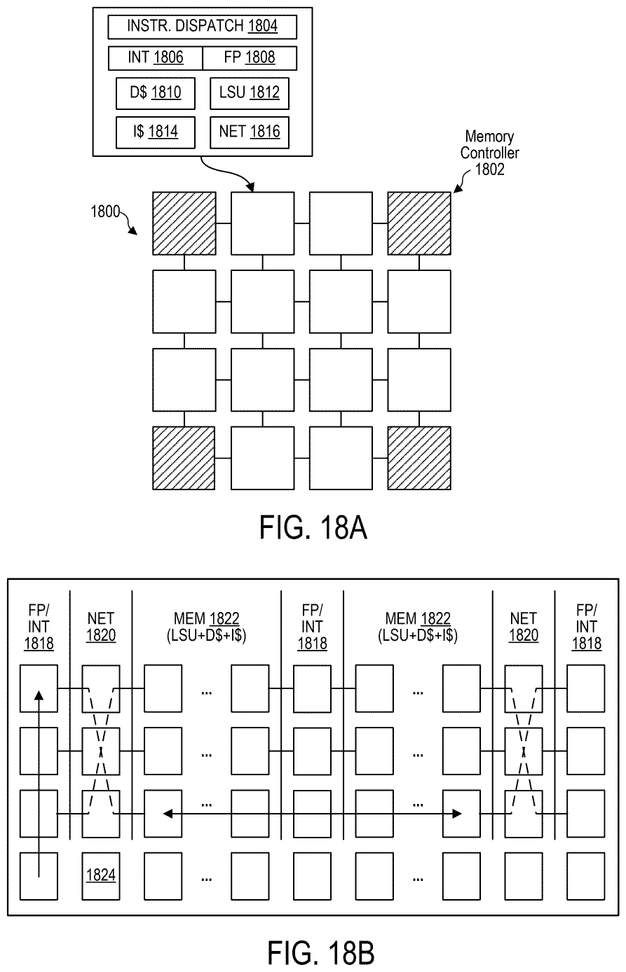

FIG. 18A illustrates a diagram of an example many-core tiled processor microarchitecture. Many-core tiled processor in FIG. 18 can include a language processing processor. As illustrated in FIG. 18A, each “tile” of the processor architecture is a processing element tied together using a network-on-chip (NoC) that can be used, e.g., to perform some or all of the operations described above or elsewhere herein. For example, each tile may have an instruction dispatch 1804 and an integer (INT) 1806 and floating-point (FP) unit 1808 as well as load-store unit (LSU) 1812 to interface with the memory hierarchy (data cache (D$) 1810 and instruction cache (I$) 1814) and a network (NET) 1816 interface for communication with other tiles of the architecture. Some tiles in processor 1800 may include memory controller 1802 for managing and controlling memory, as described further herein. Processor 1800 can have a functional slice architecture. Processor 1800 may be located on an application specific integrated circuit (ASIC), and FIG. 18A may represent the layout of the ASIC. Processor 1800 can include a co-processor that is designed to execute instructions for a predictive model. The predictive model is any model that is configured to make a prediction from input data. The predictive model can use a classifier to make a classification prediction. The predictive model may be a machine learning model such as, but not limited to, a tensor flow model, and the processor 1800 is a tensor streaming processor.

Processor 1800 can employ different microarchitectures, which disaggregates the functional units shown in each tile in FIG. 18B. Instead, the functional tiles of the processor 1800 may be aggregated into a plurality of functional process units (hereafter referred to as “slices”) 1804, each corresponding to a particular function type (e.g., FP/INT, NET, MEM). For example, as illustrated in FIG. 18B, each slice may correspond to a column of functional tiles extending in a north-south direction. In addition, the processor also includes communication lanes to carry data between the tiles of different slices, each running horizontally in an east-west direction. Each communication lane may be connected to each of the slices 1804 of the processor 1800.

The slices 1804 of the processor 1800 may each correspond to a different function, and may include arithmetic logic slices (e.g., FP/INT), lane switching slices (e.g., NET), and memory slices (e.g., MEM). The arithmetic logic units execute one or more arithmetic and/or logic operations on the data received via the communication lanes to generate output data. Examples of arithmetic logic units may be matrix multiplication units and vector multiplication units. The memory slices include memory cells that store data. The memory slices can provide the data to other slices through the communication lanes. The memory slices can also receive data from other slices through the communication lanes. The lane switching slices can configurably route data from one communication lane to any other communication lane. For example, data from a first lane can be provided to a second lane through a lane switching slice. In some embodiments, the lane switching slice can be implemented as a crossbar switch. Each slice 1804 also includes its own instruction queue (not shown) that stores instructions, and an instruction control unit (ICU) to control execution of the instructions. The instructions in a given instruction queue may be executed only by tiles in its associated functional slice and may not be executed by the other slice of the processor.

By arranging the tiles of the processor 1800 into different functional slices 1804, the on-chip instruction and control flow of the processor 1800 can be decoupled from the data flow. For example, one arrow in FIG. 18B illustrates the flow of instructions within the processor architecture, in accordance with some embodiments. Another arrow in FIG. 18B illustrates data flow within the processor architecture, in accordance with at least one embodiment. As illustrated, the instructions and control flow flows in a first direction across the tiles of the processor 1800 (e.g., north-south, along the length of the functional slices, as shown by the first arrow), while the data flows flow in a second direction across the tiles of the processor 1800 (e.g., east-west, across the functional slices, as shown by the second arrow) that is perpendicular to the first direction.

Different functional slices of the processor may correspond to MEM (memory), VXM (vector execution module), MXM (matrix execution module), NIM (numerical interpretation module), and SXM (switching and permutation module). Each slice may include N tiles that may all be controlled by the same instruction control unit (ICU) (not shown). Each of the slices may operate completely independently and can only be coordinated using barrier-like synchronization primitives or through the compiler by exploiting “tractable determinism.” Each tile of the processor can correspond to an execution unit organized as an ×M SIMD tile. For example, each tile of the on-chip memory of the processor may be organized to store an L-element vector atomically. As such, a MEM slice having N tiles may work together to store or process a large vector (e.g., having a total of N×M elements).

The tiles in the same slice may execute instructions in a “staggered” fashion where instructions may be issued tile-by-tile within the slice over a period of N cycles. Functional slices may be arranged physically on-chip to allow efficient data-flow for pipelined execution across hundreds of cycles for common patterns. Data flows can perform a single “u-turn” (change in direction) corresponding to a single matrix operation before being written back to memory, in some embodiments, a particular data flow may change direction multiple times (due to multiple matrix and vector operations) before the resulting data is written back into memory.

To get good single-thread performance, a conventional multi-core processor design (e.g., as illustrated in FIG. 18A) typically needs to dedicate a significant portion of silicon area for exposing and exploiting instruction-level parallelism (ILP). This usually involves register renaming schemes and large instruction windows over which the instructions have no explicit understanding of the hardware on which it will execute, all the while maintaining the illusion of in-order program execution. In contrast, when using a processor (e.g., TSP) having a functional slice architecture, the TSP compiler generates an explicit plan for how the processor will execute the microprogram. The compiler specifies when each operation will be executed, which functional slices will perform the work, and which STREAM registers hold the operands. The compiler maintains a high-fidelity (cycle accurate) model of the TSP's hardware state so the microprogram can orchestrate the data flow.

Processor 1800 (e.g., TSP) can use a Web-hosted compiler that takes as its input a model (e.g., an ML model such as, but not limited to, a TensorFlow model) and emits a proprietary instruction stream targeting the processor TSP hardware. The compiler is responsible for coordinating the control and data flow of the program, and specifies any instruction-level parallelism by explicitly bundling instructions that can and should execute concurrently so that they may be dispatched together. The primary hardware structure is the architecturally-visible streaming register file (STREAMs), described in greater detail below, which serves as the conduit through which operands flow from MEM slices (e.g., SRAM) to functional slices and vice versa.

The MEM unit of the processor serves as: (1) storage for model parameters, microprograms and the data on which they operate, and (2) network-on-chip (NoC) for communicating data operands from MEM to the functional slices and computed results back to MEM. In some embodiments, the on-chip memory consumes ≈75% of the chip area of the processor. In some embodiments, due to the bandwidth requirements of the processor, the on-chip memory of the MEM tiles may comprise SRAM, and not DRAM. The on-chip memory capacity of the processor determines (i) the number of ML models that can simultaneously reside on-chip, (ii) size of any given model, and (iii) partitioning of large models to fit into multi-chip systems. In some embodiments, the MEM system of the processor provides a plurality of memory slices organized into two different hemispheres (referred to as “MEM WEST” and “MEM EAST”, respectively).

The memory slices of each hemisphere may mirrored, such that the slices may be physically numbered {0, . . . L} in the East hemisphere 410, and {L, . . . 0} in the West hemisphere 405, such that the memory slice 0 for each hemisphere corresponds to the slice closest to the VXM slices 415 between the hemispheres, where each hemisphere comprises L slices. The direction of data transfer towards the center of the chip may be referred to as inwards, while data transfer toward the outer (Eastern or Western most) edge of the chip may be referred to as outwards. Although the hemispheres of memory of the processor may be referred to as east and west, it is understood that in other embodiments, other names may be used to refer to the different hemispheres of memory.

In some embodiments, a streaming register file, referred to as STREAMS, transfers operands and results between SRAM of the MEM slices and the functional slices of the processor. In some embodiments, a plurality of MEM slices (e.g., between 2 and 10 adjacent MEM slices) may be physically organized as a set. Each set of slices may be located between a pair of STREAM register files, such that each slice is able to read or write to the STREAM registers in either direction. By placing STREAM register files between sets of MEM slices, a number of cycles needed for data operands to be transmitted across a hemisphere is decreased (e.g., by a factor corresponding to the number of slices per set). The number of slices per set may be configured based upon a distance over which data may be transmitted over a single clock cycle.

With respect to any of the processors in FIG. 18 and any components described above or elsewhere herein, one or more of APIs or equivalents described herein can, for example, get compiled into instructions or equivalents, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of the processor (e.g., in cache and/or memory). A result of API(s) can then be stored in storage within or outside of the processor, including registers, DRAM, flash, SRAM, cache, or other memory equivalents.

In at least one embodiment, processor 1800 can include one or more circuits to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. One or more circuits can be configured by software to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein.

### Software Constructions

The following figures set forth, without limitation, examples of software constructs for implementing at least one embodiment.

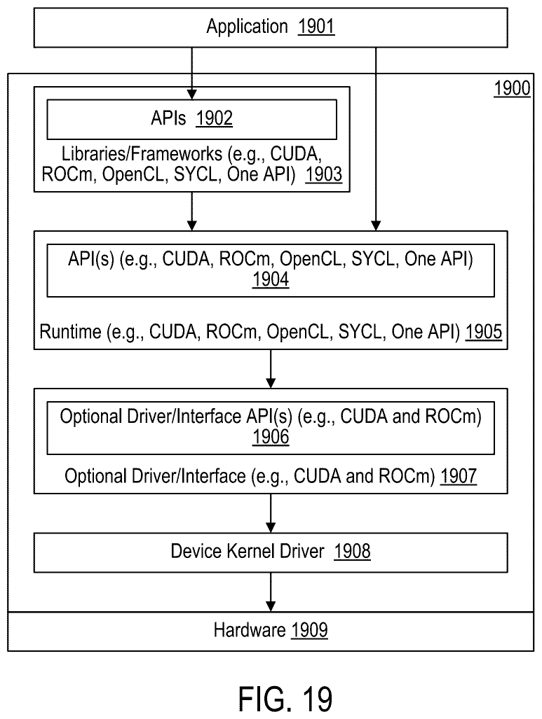

FIG. 19 illustrates a software stack of a programming platform, in accordance with at least one embodiment. A programming platform can include a platform for leveraging hardware on a computing system to accelerate computational tasks. A programming platform may be accessible to software developers through libraries, compiler directives, and/or extensions to programming languages, in at least one embodiment. A programming platform may be CUDA, Radeon Open Compute Platform (“ROCm”), OpenCL (OpenCL™ is developed by Khronos group), SYCL, or Intel oneAPI.

A software stack 1900 of a programming platform can provide an execution environment for an application 1901. Application 1901 may include any computer software capable of being launched on software stack 1900. Application 1901 may include an artificial intelligence (“AI”)/machine learning (“ML”) application, a high performance computing (“HPC”) application, a virtual desktop infrastructure (“VDI”), or a data center workload.

Application 1901 and software stack 1900 run on hardware 1908. Hardware 1908 may include one or more GPUs, CPUs, FPGAs, AI engines, and/or other types of compute devices that support a programming platform. Software stack 1900 may be vendor specific and compatible with only devices from particular vendor(s), such as CUDA, ROCm, OneAPI, OpenCL, or other implementations. Hardware 1908 can include a host connected to one more devices that can be accessed to perform computational tasks via application programming interface (“API”) calls. A device within hardware 1908 may include a GPU, FPGA, AI engine, or other compute device (but may also include a CPU) and its memory, as opposed to a host within hardware 1908 that may include a CPU (but may also include a compute device) and its memory, in at least one embodiment. With respect to any of the hardware 1908 described above or elsewhere herein, one or more of APIs described herein can, for example, get compiled into instructions, which may be fetched by instruction fetch logic, decoded by a processor decoder, scheduled (e.g., in order or out of order) for execution by a scheduler, executed by execution logic, reordered, and then retired by the retirement logic. API(s) (and/or compiled instructions including API(s)) can be stored in any storage outside or inside of the processor (e.g., in cache and/or memory). A result of API(s) can then be stored in storage within or outside of the processor, including registers, DRAM, flash, SRAM, cache, or other memory. One or more of APIs described herein can include a call. One or more of APIs described herein can include a library or a portion of a library to perform a function described by the call. One or more of APIs described herein can include a call and a library or portion of a library to perform a function described by the call.

Software stack 1900 of a programming platform can include a number of libraries 1903, a runtime 1905, an optional driver/interface 1907, and a device kernel driver 1908. Each of libraries 1903 may include data and programming code that can be used by computer programs and leveraged during software development. Libraries 1903 may include pre-written code and subroutines, classes, values, type specifications, configuration data, documentation, help data, and/or message templates. Libraries 1903 can include functions that may be optimized for execution on one or more types of devices. Libraries 1903 may include functions for performing mathematical, deep learning, and/or other types of operations on devices. Libraries 1903 can be associated with corresponding APIs 1902, which may include one or more APIs, that expose functions implemented in libraries 1903. A processor (e.g. CPU, GPU) may perform, call, or otherwise use one or more APIs to prioritize kernels. For example, a first kernel (e.g., parent) can launch a second kernel (e.g., child kernel), and said second kernel can be used by a processor to launch additional kernels (e.g., grandchildren kernels) independent of said first kernel. A processor may perform an API or calls an API from memory to be performed to support dynamic stream priority (e.g., updating priority while a stream is being used to perform operations). For example, when a processor performs said API, it allows a programmer to copy stream priority from one stream to one or more other streams.

Software stack 1900 may include an API to support dynamic stream priority (e.g., updating priority while a stream is being used to perform operations), which can allow a programmer to set priority of a stream at any time after creation. Software stack 1900 can include an API to support dynamic stream priority (e.g., updating priority while the stream is being used to perform operations), which may allow a programmer to obtain current priority of a stream, where the priority is one of a plurality of attributes of a stream. Software stack 1900 can include an API to support dynamic stream priority (e.g., updating priority while the stream is being used to perform operations), which may allow a programmer to obtain current priority of a stream as a single attribute. Software stack 1900 can include an API to support dynamic stream priority (e.g., updating priority while the stream is being used to perform operations), which allows a programmer to launch a kernel to perform operations on a stream at a set priority, which may be different from the stream priority. Software stack 1900 may include an API to indicate whether an object (e.g., a thread synchronization object such as, but not limited to, a barrier) tracks whether all data movement operations for a set of threads operating on a GPU may be complete has a specified state after a specified period of time, where a specified state can be a state indicating that data has been moved and is ready for use, and is specified using an expected parity value as an input to the API.

Software stack 1900 can include one or more APIs to updated kernels. A processor can perform an API or call an API from memory to be performed to update to an existing API is to support context-free kernels, which may allow a programmer to add a kernel node to a graph without a graphics context, so that a graphics context can be dynamically associated with a kernel at runtime. Software stack 1900 may include one or more APIs to allow a programmer to obtain a kernel identifier and a graphics context as separate parameters from a kernel node, so that parameters to be obtained from kernels and from context-free kernels. Software stack 1900 can include one or more APIs to use parallel processor(s), such as, but not limited to, one or more graphics processing units, to launch task graphs (e.g., task graphs) and to execute one or more task graphs (e.g., including one or more programs).

Software stack 1900 may include one or more APIs to associate one or more instructions with one or more memory ordering operations, such as, but not limited to, a fence or membar operation. Instructions can be associated with one or more domains such that a memory ordering operation is executed in association to one or more particular domains without interfering with instructions of other domains. An API can indicate a thread has arrived (e.g., at a thread synchronization barrier), or finished a stage of work in relation to asynchronous data movement operations on a GPU. Software stack 1900 may include one or more to allow programmers to manually indicate an expected transaction count when a thread has finished a stage of work, which can be used to update an object that tracks whether all data movement operations for a set of threads may be complete.

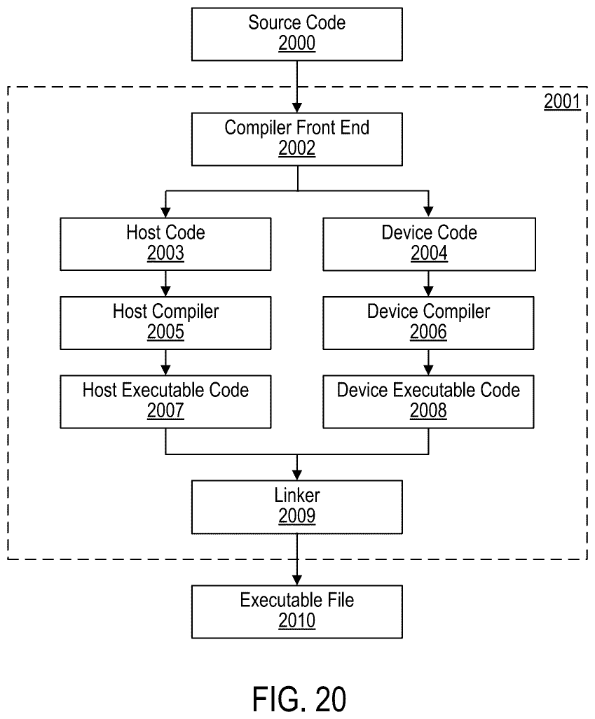

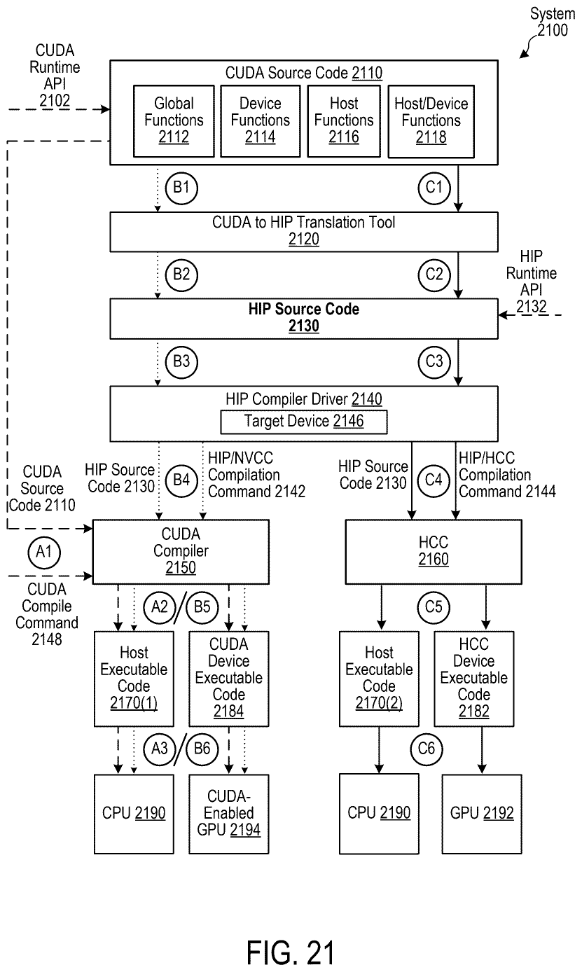

Application 1901 can be written as source code that is compiled into executable code, as discussed in greater detail below in conjunction with FIGS. 20 and 21. Executable code of application 1901 may run, at least in part, on an execution environment provided by software stack 1900. During execution of application 1901, code may be reached that needs to run on a device, as opposed to a host. In such a case, runtime 1905 may be called to load and launch requisite code on the device. Runtime 1905 may include any technically feasible runtime system that is able to support execution of application 1901.

Runtime 1905 can be implemented as one or more runtime libraries associated with corresponding APIs, which are shown as API(s) 1904. One or more of such runtime libraries may include functions for memory management, execution control, device management, error handling, and/or synchronization, among other things. Memory management functions may include functions to allocate, deallocate, and copy device memory, as well as transfer data between host memory and device memory. Execution control functions may include functions to launch a function (sometimes referred to as a “kernel” when a function is a global function callable from a host) on a device and set attribute values in a buffer maintained by a runtime library for a given function to be executed on a device.

Runtime libraries and corresponding API(s) 1904 may be implemented in any technically feasible manner. One (or any number of) API may expose a low-level set of functions for fine-grained control of a device, while another (or any number of) API may expose a higher-level set of such functions. A high-level runtime API may be built on top of a low-level API. One or more of runtime APIs may be language-specific APIs that may be layered on top of a language-independent runtime API.

An optional driver or interface 1907 may be implemented, e.g., for CUDA and ROCm implementations, that are described further below. Optional driver/interface 1907 may be associated with optional driver or interface API(s), such as, but not limited to, CUDA and/or ROCm API(s).

One or more processors disclosed in “processing systems” can perform, access, or otherwise use software stack 1900. For example, system-on-a-chip 700, parallel processor 800, graphics multiprocessor 834, processor 900, processor 1000, accelerator 1100, neuromorphic processor 1105, supercomputer 1200, acceleration processing unit 1300, processor 1400, processor 1500, tensor processing unit 1600, processor 1700, and language processing unit 1800 can perform, use, call, or otherwise implement (e.g., through accessing a memory) one or more APIs included in software stack 1900.

Device kernel driver 1908 can be configured to facilitate communication with an underlying device. Device kernel driver 1908 may provide low-level functionalities upon which APIs, such as, but not limited to, API(s) 1904, and/or other software relies. Device kernel driver 1908 may be configured to compile intermediate representation (“IR”) code into binary code at runtime. For CUDA or other implementations such as, but not limited to, ROCm, OneAPI, or OpenCL, device kernel driver 1908 may compile Parallel Thread Execution (“PTX”) IR code that is not hardware specific into binary code for a specific target device at runtime (with caching of compiled binary code), which is also sometimes referred to as “finalizing” code. Doing so may permit finalized code to run on a target device, which may not have existed when source code was originally compiled into PTX code. Alternatively, device source code may be compiled into binary code offline, without requiring device kernel driver 1908 to compile IR code at runtime.

Processors described elsewhere herein, such as, but not limited to, processors in FIGS. 7-18 can include one or more circuits to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. One or more circuits can be configured by software, e.g., software stack 1900 to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein.

In accordance with at least one embodiment, software stack 1900 of FIG. 19 can be performed in a CUDA implementation. A CUDA software stack 1900, on which an application 1901 may be launched, may include CUDA libraries 1903, a CUDA runtime 1905, a CUDA driver 1907, and a device kernel driver 1908. CUDA software stack 1900 can execute on hardware 2209, which may include a GPU that supports CUDA and is developed by NVIDIA Corporation of Santa Clara, CA.

Application 1901, CUDA runtime 1905, and device kernel driver 1908 can perform functionalities that are described above and elsewhere herein. CUDA driver 1907 can include a library (libcuda.so) that may implement a CUDA driver API 1906. Similar to a CUDA runtime API 1904 implemented by a CUDA runtime library (cudart), CUDA driver API 1906 may expose functions for memory management, execution control, device management, error handling, synchronization, and/or graphics interoperability, among other things. CUDA driver API 1906 can differ from CUDA runtime API 1904 in that CUDA runtime API 1904 simplifies device code management by providing implicit initialization, context (analogous to a process) management, and module (analogous to dynamically loaded libraries) management. In contrast to high-level CUDA runtime API 1904, CUDA driver API 1906 can be a low-level API providing more fine-grained control of the device, particularly with respect to contexts and module loading. CUDA driver API 1906 may expose functions for context management that may be not exposed by CUDA runtime API 1904. CUDA driver API 1906 may also be language-independent and support, e.g., OpenCL, in addition to CUDA runtime API 1904. Further, development libraries, including CUDA runtime 1905, may be considered as separate from driver components, including user-mode CUDA driver 1907 and kernel-mode device driver 1908 (also sometimes referred to as a “display” driver).

CUDA libraries 1903 may include mathematical libraries, deep learning libraries, parallel algorithm libraries, and/or signal/image/video processing libraries, which parallel computing applications such as, but not limited to, application 1901 may utilize. CUDA libraries 1903 may include mathematical libraries such as, but not limited to, a cuBLAS library that is an implementation of Basic Linear Algebra Subprograms (“BLAS”) for performing linear algebra operations, a cuFFT library for computing fast Fourier transforms (“FFTs”), and a cuRAND library for generating random numbers, among others. CUDA libraries 1903 may include deep learning libraries such as, but not limited to, a cuDNN library of primitives for deep neural networks and a TensorRT platform for high-performance deep learning inference, among others.

In at least one embodiment, processors described elsewhere herein, such as, but not limited to, processors in FIGS. 7-18 can include one or more circuits to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. One or more circuits can be configured by software, e.g., software stack 1900 to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein.

In accordance with at least one embodiment, software stack 1900 of FIG. 19 can be performed in a ROCm implementation. A ROCm software stack 1900, on which an application 1901 may be launched, includes a language runtime 1903, a system runtime 1905, a thunk 1907, and a ROCm kernel driver 1908. ROCm software stack 1900 executes on hardware 1909, which may include a GPU that supports ROCm and is developed by AMD Corporation of Santa Clara, CA.

Application 1901 may perform similar functionalities as discussed above in conjunction with FIG. 19. In addition, language runtime 1903 and system runtime 1905 may perform similar functionalities as runtime 1905 discussed above in conjunction with FIG. 19. Language runtime 1903 and system runtime 1905 may differ in that system runtime 1905 is a language-independent runtime that implements a ROCr system runtime API 1904 and makes use of a Heterogeneous System Architecture (“HSA”) Runtime API. HSA runtime API can include a thin, user-mode API that exposes interfaces to access and interact with an AMD GPU, including functions for memory management, execution control via architected dispatch of kernels, error handling, system and agent information, and runtime initialization and shutdown, among other things. In contrast to system runtime 1905, language runtime 1903 can be an implementation of a language-specific runtime API 1902 layered on top of ROCr system runtime API 1904. Language runtime API may include a Heterogeneous compute Interface for Portability (“HIP”) language runtime API, a Heterogeneous Compute Compiler (“HCC”) language runtime API, or an OpenCL API, among others. HIP language in particular is an extension of C++ programming language with functionally similar versions of CUDA mechanisms, and a HIP language runtime API may include functions that may be similar to those of CUDA runtime API discussed above in conjunction with FIG. 19, such as, but not limited to, functions for memory management, execution control, device management, error handling, and synchronization, among other things.

Thunk (ROCt) 1907 can be an interface 1906 that can be used to interact with underlying ROCm driver 1908. ROCm driver 1908 can be a ROCk driver, which is a combination of an AMDGPU driver and a HSA kernel driver (amdkfd). AMDGPU driver can be a device kernel driver for GPUs developed by AMD that performs similar functionalities as device kernel driver 1909 discussed above in conjunction with FIG. 19. HSA kernel driver can be a driver permitting different types of processors to share system resources more effectively via hardware features.

Various libraries (not shown) may be included in ROCm software stack 1900 above language runtime 1903 and provide functionality similar to CUDA libraries 1903, discussed above in conjunction with FIG. 19. Various libraries may include mathematical, deep learning, and/or other libraries such as, but not limited to, a hipBLAS library that implements functions similar to those of CUDA cuBLAS, a rocFFT library for computing FFTs that is similar to CUDA cuFFT, among others.

Processors described elsewhere herein, such as, but not limited to, processors in FIGS. 7-18 can include one or more circuits to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. One or more circuits can be configured by software, e.g., software stack 1900 to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein.

In accordance with at least one embodiment, software stack 1900 of FIG. 19 can be performed in a OpenCL implementation. An OpenCL software stack 1900, on which an application 1901 may be launched, can include an OpenCL framework 1903, an OpenCL runtime 1905, and a driver 1908. OpenCL software stack 1900 may execute on hardware 1909 that is not vendor-specific. As OpenCL is supported by devices developed by different vendors, specific OpenCL drivers may be required to interoperate with hardware from such vendors.

Application 1901, OpenCL runtime 1905, device kernel driver 1908, and hardware 1909 may perform similar functionalities as other implementations of application 1901, runtime 1905, device kernel driver 1908, and hardware 1909, respectively, that are discussed above in conjunction with FIG. 19. Application 1901 can further include an OpenCL kernel (not shown) with code that is to be executed on a device.

OpenCL may define a “platform” that allows a host to control devices connected to the host. An OpenCL framework can provide a platform layer API and a runtime API, shown as platform API 1902 and runtime API 1904. Runtime API 1904 can use contexts to manage execution of kernels on devices. Each identified device may be associated with a respective context, which runtime API 1904 may use to manage command queues, program objects, and kernel objects, share memory objects, among other things, for that device. Platform API 1902 can expose functions that permit device contexts to be used to select and initialize devices, submit work to devices via command queues, and enable data transfer to and from devices, among other things. In addition, OpenCL framework can provide various built-in functions (not shown), including math functions, relational functions, and image processing functions, among others.

A compiler (not shown) can also be included in OpenCL framework 1903. Source code may be compiled offline prior to executing an application or online during execution of an application. In contrast to CUDA and ROCm, OpenCL applications may be compiled online by a compiler that is representative of any number of compilers that may be used to compile source code and/or IR code, such as, but not limited to, Standard Portable Intermediate Representation (“SPIR-V”) code, into binary code. Alternatively, OpenCL applications may be compiled offline, prior to execution of such applications.

In at least one embodiment, processors described elsewhere herein, such as, but not limited to, processors in FIGS. 7-18 can include one or more circuits to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. One or more circuits can be configured by software, e.g., software stack 1900 to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein.

In accordance with at least one embodiment, software can be supported by a programming platform that is configured to support various programming models, middlewares and/or libraries, and frameworks that an application may rely upon. Application may be an AI/ML application implemented using, for example, a deep learning framework such as, but not limited to, MXNet, PyTorch, or TensorFlow, which may rely on libraries such as, but not limited to, cuDNN, NVIDIA Collective Communications Library (“NCCL”), and/or NVIDA Developer Data Loading Library (“DALI”) CUDA libraries to provide accelerated computing on underlying hardware.

Programming platform may be one of a CUDA, ROCm, or OpenCL platform described above in conjunction with FIG. 19. Programming platform can support multiple programming models, which may be abstractions of an underlying computing system permitting expressions of algorithms and data structures. Programming models may expose features of underlying hardware in order to improve performance. Programming models may include CUDA, HIP, OpenCL, C++ Accelerated Massive Parallelism (“C++ AMP”), Open Multi-Processing (“OpenMP”), Open Accelerators (“OpenACC”), and/or Vulcan Compute.

Libraries and/or middlewares may provide implementations of abstractions of programming models. Such libraries can include data and programming code that may be used by computer programs and leveraged during software development. Such middlewares can include software that provides services to applications beyond those available from programming platform. Libraries and/or middlewares may include cuBLAS, cuFFT, cuRAND, and other CUDA libraries, or rocBLAS, rocFFT, rocRAND, and other ROCm libraries. In addition, libraries and/or middlewares may include NCCL and ROCm Communication Collectives Library (“RCCL”) libraries providing communication routines for GPUs, a MIOpen library for deep learning acceleration, and/or an Eigen library for linear algebra, matrix and vector operations, geometrical transformations, numerical solvers, and related algorithms.

Application frameworks may depend on libraries and/or middlewares. Each of application frameworks can be a software framework used to implement a standard structure of application software. Returning to the AI/ML example discussed above, an AI/ML application may be implemented using a framework such as, but not limited to, Caffe, Caffe2, TensorFlow, Keras, PyTorch, or MxNet deep learning frameworks, for example.

In at least one embodiment, processors described elsewhere herein, such as, but not limited to, processors in FIGS. 7-18 can include one or more circuits to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. One or more circuits can be configured by software, e.g., programming platforms described herein, to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein.

FIG. 20 illustrates compiling code to execute on one of programming platforms of FIG. 19 described above, in accordance with at least one embodiment. A compiler 2001 is configured to receive source code 2000, compile source code 2000, and output an executable file 2010. Complier 2001 can be configured to convert source code 2000 into host executable code 2007 for execution on a host and device executable code 2008 for execution on a device. Source code 2000 may either be compiled offline prior to execution of an application, or online during execution of an application. Source code 2000 may include code in any programming language supported by compiler 2001, such as, but not limited to, C++, C, Fortran, etc. Source code 2000 may be included in a single-source file having a mixture of host code and device code, with locations of device code being indicated therein. A single-source file may be a .cu file that includes CUDA code or a .hip.cpp file that includes HIP code or a file in another format that includes both host code and device code. Alternatively, source code @25@00 may include multiple source code files, rather than a single-source file, into which host code and device code may be separated. Compiler 2001 includes or has access to one or more libraries to recognize a sequence of API calls to perform a single fused API, where a single fused API is a combined API for two or more APIs. In at least one embodiment, compiler 2001 may be an NVIDIA CUDA compiler (“NVCC”) for compiling CUDA code in .cu files, or a HCC compiler for compiling HIP code in .hip.cpp files, or other compilers.

Compiler 2001 can be configured to compile source code 2000 into host executable code 2007 for execution on a host and device executable code 2008 for execution on a device. Compiler 2001 performs operations including parsing source code 2000 into an abstract system tree (AST), performing optimizations, and generating executable code. When source code 2000 includes a single-source file, compiler 2001 may separate device code from host code in such a single-source file, compile device code and host code into device executable code 2008 and host executable code 2007, respectively, and link device executable code 2008 and host executable code 2007 together in a single file.

Compiler 2001 can include a compiler front end 2002, a host compiler 2005, a device compiler 2006, and a linker 2009. Compiler front end 2002 can be configured to separate device code 2004 from host code 2003 in source code 2000. Device code 2004 may be compiled by device compiler 2006 into device executable code 2008, which as described may include binary code or IR code, in at least one embodiment. Separately, host code 2003 may be compiled by host compiler 2005 into host executable code 2007. For NVCC other compilers, such as, but not limited to, those for oneAPI, ROCm, and OpenCL, host compiler 2005 may be a general purpose C/C++ compiler that outputs native object code, while device compiler 2006 may be a Low Level Virtual Machine (“LLVM”)-based compiler that forks a LLVM compiler infrastructure and outputs PTX code or binary code. For HCC, both host compiler 2005 and device compiler 2006 may be LLVM-based compilers that output target binary code.

Subsequent to compiling source code 2000 into host executable code 2007 and device executable code 2008, linker 2009 can link host and device executable code 2007 and 2008 together in executable file 2010. Native object code for a host and PTX or binary code for a device may be linked together in an Executable and Linkable Format (“ELF”) file, which is a container format used to store object code. Host executable code 2007 and device executable code 2008 may be in any suitable format, such as, but not limited to, binary code and/or IR code. In the case of CUDA, host executable code 2007 may include native object code and device executable code 2008 may include code in PTX intermediate representation, in at least one embodiment. In the case of ROCm, both host executable code 2007 and device executable code 2008 may include target binary code, in at least one embodiment. Other implementations, such as, but not limited to, oneAPI, OpenCL are contemplated and can be performed similarly to the CUDA and ROCm implementations above.

Source code 2000 may be translated prior to compiling source code. Source code is passed through a translation tool (not shown), which translates source code 2000 into translated source code. A compiler 2001 can be used to compile translated source code into host executable code 2007 and device executable code 2008 in a process that is similar to compilation of source code 2000 by compiler 2001 into host executable code 2007 and device executable code 2008, as discussed above in conjunction with FIG. 20.

A translation performed by translation tool can be used to port source code 2000 for execution in a different environment than that in which it was originally intended to run. Translation tool may include a HIP translator that is used to “hipify” CUDA code intended for a CUDA platform into HIP code that can be compiled and executed on a ROCm platform. Translation of source code 2000 may include parsing source code 2000 and converting calls to API(s) provided by one programming model (e.g., CUDA) into corresponding calls to API(s) provided by another programming model (e.g., HIP), as discussed in greater detail below in conjunction with FIG. 21. Returning to the example of hipifying CUDA code, calls to CUDA runtime API, CUDA driver API, and/or CUDA libraries may be converted to corresponding HIP API calls. Automated translations performed by translation tool 2001 may sometimes be incomplete, requiring additional, manual effort to fully port source code 2000.

One or more techniques described herein may utilize other methods of converting one type of code to another type of code to enable interchangeability between different device architectures. In at least one embodiment, an application for one platform (e.g., a CUDA application) can be compiled into code for implementation on another platform (e.g., an AMD processor, Intel processor, or other processor). For example, source code 2000 can include source code for one platform (e.g., CUDA). Compiler 2001 can compile the source 2000 into an executable file 2010 that can be used by another platform (e.g., AMD or Intel). Programming toolkits can allow applications for one platform (e.g., CUDA) to be compiled (e.g., natively) for another platform (e.g., AMD or Intel). For example, a GPGPU programming toolkit can allow for CUDA applications to be natively compiled for AMD GPUs. Programs (e.g., CUDA programs) or its build system do not have to be modified or translated to another language before compiling to code for another platform. A compiler may accept the same command-line options and programming dialect (e.g., CUDA dialect) as another compiler (e.g., nvcc for CUDA), serving as a drop-in replacement to impersonate an installation of a toolkit (e.g., NVIDIA CUDA Toolkit), so existing build tools and scripts (e.g., like cmake) work without further modification. In at least one embodiment, an nvcc-compatible compiler can be used to compile nvcc-dialect CUDA for AMD GPUs, including PTX asm. Implementations of CUDA runtime and driver APIs for AMD GPUs can be used. Libraries (e.g., open source wrapper libraries) can provide APIs, such as “CUDA-X” APIs by delegating to the corresponding ROCm libraries. An example implementation includes SCALE from Spectral Compute in London, England. Instead of providing a new way to write GPGPU software, SCALE allows programs written using the widely-popular CUDA language to be directly compiled for AMD GPUs. Additional implementations can include a Clang compiler that provides a language front-end and tooling infrastructure for languages in the C language family (C, C++, Objective C/C++, OpenCL, CUDA, and RenderScript). In at least one embodiment, compilers described herein, such as, but not limited to compiler 2001, compiler 2005, and/or compiler 2006 can include one or more circuits to compile code (e.g., CUDA, HIP, OpenCL, OneAPI, or others) to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription and/or perform any of the operations described above or elsewhere herein.

FIG. 21 illustrates a system 2100 configured to compile and execute CUDA source code 2110 using different types of processing units, in accordance with at least one embodiment. System 2100 includes CUDA source code 2110, a CUDA compiler 2150, host executable code 2170(1), host executable code 2170(2), CUDA device executable code 2184, a CPU 2190, a CUDA-enabled GPU 2194, a GPU 2192, a CUDA to HIP translation tool 2120, HIP source code 2130, a HIP compiler driver 2140, an HCC 2160, and HCC device executable code 2182.

CUDA source code 2110 may be a collection of human-readable code in a CUDA programming language. A CUDA programming language can be an extension of the C++ programming language that includes mechanisms to define device code and distinguish between device code and host code. Device code can include source code that, after compilation, is executable in parallel on a device. A device may be a processor that is optimized for parallel instruction processing, such as, but not limited to, CUDA-enabled GPU 2190, GPU 2192, or another GPGPU, etc. Host code is source code that, after compilation, is executable on a host. A host is a processor that is optimized for sequential instruction processing, such as, but not limited to, CPU 2190.

CUDA source code 2110 can include any number (including zero) of global functions 2112, any number (including zero) of device functions 2114, any number (including zero) of host functions 2116, and any number (including zero) of host/device functions 2118. Global functions 2112, device functions 2114, host functions 2116, and host/device functions 2118 may be mixed in CUDA source code 2110. Each of global functions 2112 may be executable on a device and callable from a host. One or more of global functions 2112 may therefore act as entry points to a device. Each of global functions 2112 can be a kernel. In a technique known as dynamic parallelism, one or more of global functions 2112 can define a kernel that is executable on a device and callable from such a device. A kernel can be executed N (where N is any positive integer) times in parallel by N different threads on a device during execution.

Each of device functions 2114 can be executed on a device and callable from such a device only. Each of host functions 2116 can be executed on a host and callable from such a host only. Each of host/device functions 2116 may define both a host version of a function that is executable on a host and callable from such a host only and a device version of the function that is executable on a device and callable from such a device only.

CUDA source code 2110 may also include any number of calls to any number of functions that may be defined via a CUDA runtime API 2102. CUDA runtime API 2102 may include any number of functions that execute on a host to allocate and deallocate device memory, transfer data between host memory and device memory, manage systems with multiple devices, etc. CUDA source code 2110 may also include any number of calls to any number of functions that may be specified in any number of other CUDA APIs. A CUDA API may be any API that is designed for use by CUDA code. CUDA APIs can include CUDA runtime API 2102, a CUDA driver API, APIs for any number of CUDA libraries, etc, including any API(s) described elsewhere herein. Relative to CUDA runtime API 2102, a CUDA driver API can be a lower-level API but can provide finer-grained control of a device. Examples of CUDA libraries include cuBLAS, cuFFT, cuRAND, cuDNN, etc.

CUDA compiler 2150 may compile input CUDA code (e.g., CUDA source code 2110) to generate host executable code 2170(1) and CUDA device executable code 2184. CUDA compiler 2150 may be, but is not limited to, NVCC. Host executable code 2170(1) can be a compiled version of host code included in input source code that is executable on CPU 2190. CPU 2190 may be any processor that is optimized for sequential instruction processing.

CUDA device executable code 2184 may be a compiled version of device code included in input source code that is executable on CUDA-enabled GPU 2194. CUDA device executable code 2184 may include binary code. CUDA device executable code 2184 can include IR code, such as, but not limited to, PTX code, that is further compiled at runtime into binary code for a specific target device (e.g., CUDA-enabled GPU 2194) by a device driver. CUDA-enabled GPU 2194 may include any processor that is optimized for parallel instruction processing and that supports CUDA. CUDA-enabled GPU 2194 may be developed by NVIDIA Corporation of Santa Clara, CA.

CUDA to HIP translation tool 2120 can be configured to translate CUDA source code 2110 to functionally similar HIP source code 2130. HIP source code 2130 may include a collection of human-readable code in a HIP programming language. HIP code can include human-readable code in a HIP programming language. A HIP programming language can include an extension of the C++ programming language that includes functionally similar versions of CUDA mechanisms to define device code and distinguish between device code and host code. A HIP programming language may include a subset of functionality of a CUDA programming language. For example, a HIP programming language includes mechanism(s) to define global functions 2112, but such a HIP programming language may lack support for dynamic parallelism and therefore global functions 2112 defined in HIP code may be callable from a host only.

HIP source code 2130 may include any number (including zero) of global functions 2112, any number (including zero) of device functions 2114, any number (including zero) of host functions 2116, and any number (including zero) of host/device functions 2118. HIP source code 2130 may also include any number of calls to any number of functions that may be specified in a HIP runtime API 2132. HIP runtime API 2132 may include functionally similar versions of a subset of functions included in CUDA runtime API 2102. HIP source code 2130 may also include any number of calls to any number of functions that may be specified in any number of other HIP APIs. A HIP API may be any API that is designed for use by HIP code and/or ROCm. HIP APIs may include HIP runtime API 2132, a HIP driver API, APIs for any number of HIP libraries, APIs for any number of ROCm libraries, etc.

CUDA to HIP translation tool 2120 can convert each kernel call in CUDA code from a CUDA syntax to a HIP syntax and can convert any number of other CUDA calls in CUDA code to any number of other functionally similar HIP calls. A CUDA call can include a call to a function specified in a CUDA API, and a HIP call can include a call to a function specified in a HIP API. CUDA to HIP translation tool 2120 may convert any number of calls to functions specified in CUDA runtime API 2102 to any number of calls to functions specified in HIP runtime API 2132.

CUDA to HIP translation tool 2120 can include a tool known as hipify-perl that executes a text-based translation process. CUDA to HIP translation tool 2120 can include a tool known as hipify-clang that, relative to hipify-perl, executes a more complex and more robust translation process that involves parsing CUDA code using clang (a compiler front-end) and then translating resulting symbols. Converting CUDA code to HIP code may include modifications (e.g., manual edits) in addition to those performed by CUDA to HIP translation tool 2120.

HIP compiler driver 2140 can include a front end that determines a target device 2146 and then configures a compiler that is compatible with target device 2146 to compile HIP source code 2130. Target device 2146 can include a processor that is optimized for parallel instruction processing. HIP compiler driver 2140 may determine target device 2146 in any technically feasible fashion.

If target device 2146 is compatible with CUDA (e.g., CUDA-enabled GPU 2194), then HIP compiler driver 2140 can generate a HIP/NVCC compilation command 2142. HIP/NVCC compilation command 2142 can configure CUDA compiler 2150 to compile HIP source code 2130 using a HIP to CUDA translation header and a CUDA runtime library. In response to HIP/NVCC compilation command 2142, CUDA compiler 2150 may generate host executable code 2170(1) and CUDA device executable code 2184.

If target device 2146 is not compatible with CUDA, then HIP compiler driver 2140 may generate a HIP/HCC compilation command 2144. HIP/HCC compilation command 2144 can configure HCC 2160 to compile HIP source code 2130 using an HCC header and a HIP/HCC runtime library. In response to HIP/HCC compilation command 2144, HCC 2160 may generate host executable code 2170(2) and HCC device executable code 2182. HCC device executable code 2182 may be a compiled version of device code included in HIP source code 2130 that is executable on GPU 2192. GPU 2192 may be any processor that is optimized for parallel instruction processing, is not compatible with CUDA, and is compatible with HCC. GPU 2192 can be developed by AMD Corporation of Santa Clara, CA. GPU 2192 can include a non-CUDA-enabled GPU 2192.

For explanatory purposes only, three different flows that may be implemented in at least one embodiment to compile CUDA source code 2110 for execution on CPU 2190 and different devices are depicted in FIG. 21. A direct CUDA flow can compile CUDA source code 2110 for execution on CPU 2190 and CUDA-enabled GPU 2194 without translating CUDA source code 2110 to HIP source code 2130. An indirect CUDA flow can translate CUDA source code 2110 to HIP source code 2130 and then compiles HIP source code 2130 for execution on CPU 2190 and CUDA-enabled GPU 2194. A CUDA/HCC flow can translate CUDA source code 2110 to HIP source code 2130 and then can compile HIP source code 2130 for execution on CPU 2190 and GPU 2192.

A direct CUDA flow that may be implemented is depicted via dashed lines and a series of bubbles annotated A1-A3. As depicted with bubble annotated A1, CUDA compiler 2150 can receive CUDA source code 2110 and a CUDA compile command 2148 that can configure CUDA compiler 2150 to compile CUDA source code 2110. CUDA source code 2110 that can be used in a direct CUDA flow can be written in a CUDA programming language that is based on a programming language other than C++(e.g., C, Fortran, Python, Java, etc.). In response to CUDA compile command 2148, CUDA compiler 2150 can generate host executable code 2170(1) and CUDA device executable code 2184 (depicted with bubble annotated A2). As depicted with bubble annotated A3, host executable code 2170(1) and CUDA device executable code 2184 may be executed on, respectively, CPU 2190 and CUDA-enabled GPU 2194. CUDA device executable code 2184 can include binary code. CUDA device executable code 2184 can include PTX code and can be further compiled into binary code for a specific target device at runtime.

An indirect CUDA flow that may be implemented is depicted via dotted lines and a series of bubbles annotated B1-B6. As depicted with bubble annotated B1, CUDA to HIP translation tool 2120 can receive CUDA source code 2110. As depicted with bubble annotated B2, CUDA to HIP translation tool 2120 can translate CUDA source code 2110 to HIP source code 2130. As depicted with bubble annotated B3, HIP compiler driver 2140 can receive HIP source code 2130 and can determine that target device 2146 is CUDA-enabled.

As depicted with bubble annotated B4, HIP compiler driver 2140 can generate HIP/NVCC compilation command 2142 and can transmit both HIP/NVCC compilation command 2142 and HIP source code 2130 to CUDA compiler 2150. HIP/NVCC compilation command 2142 can configure CUDA compiler 2150 to compile HIP source code 2130 using a HIP to CUDA translation header and a CUDA runtime library. HIP to CUDA translation header can translate any number of mechanisms (e.g., functions) specified in any number of HIP APIs to any number of mechanisms specified in any number of CUDA APIs. CUDA compiler 2150 may use HIP to CUDA translation header in conjunction with a CUDA runtime library corresponding to CUDA runtime API 2102 to generate host executable code 2170(1) and CUDA device executable code 2184. In response to HIP/NVCC compilation command 2142, CUDA compiler 2150 can generate host executable code 2170(1) and CUDA device executable code 2184 (depicted with bubble annotated B5). As depicted with bubble annotated B6, host executable code 2170(1) and CUDA device executable code 2184 may be executed on, respectively, CPU 2190 and CUDA-enabled GPU 2194. CUDA device executable code 2184 can include binary code. CUDA device executable code 2184 can include PTX code and can be further compiled into binary code for a specific target device at runtime.

A CUDA/HCC flow that may be implemented is depicted via solid lines and a series of bubbles annotated C1-C6. As depicted with bubble annotated C1, CUDA to HIP translation tool 2120 can receive CUDA source code 2110. As depicted with bubble annotated C2, CUDA to HIP translation tool 2120 can translate CUDA source code 2110 to HIP source code 2130. As depicted with bubble annotated C3, HIP compiler driver 2140 can receive HIP source code 2130 and can determine that target device 2146 is not CUDA-enabled.

HIP compiler driver 2140 may generate HIP/HCC compilation command 2144 and may transmit both HIP/HCC compilation command 2144 and HIP source code 2130 to HCC 2160 (depicted with bubble annotated C4). HIP/HCC compilation command 2144 can configure HCC 2160 to compile HIP source code 2130 using an HCC header and a HIP/HCC runtime library. HIP/HCC runtime library can correspond to HIP runtime API 2132. HCC header may include any number and type of interoperability mechanisms for HIP and HCC. In response to HIP/HCC compilation command 2144, HCC 2160 can generate host executable code 2170(2) and HCC device executable code 2182 (depicted with bubble annotated C5). As depicted with bubble annotated C6, host executable code 2170(2) and HCC device executable code 2182 may be executed on, respectively, CPU 2190 and GPU 2192.

After CUDA source code 2110 is translated to HIP source code 2130, HIP compiler driver 2140 may subsequently be used to generate executable code for either CUDA-enabled GPU 2194 or GPU 2192 without re-executing CUDA to HIP translation tool 2120. CUDA to HIP translation tool 2120 can translate CUDA source code 2110 to HIP source code 2130 that is then stored in memory. HIP compiler driver 2140 can then configure HCC 2160 to generate host executable code 2170(2) and HCC device executable code 2182 based on HIP source code 2130. In at least one embodiment, HIP compiler driver 2140 subsequently configures CUDA compiler 2150 to generate host executable code 2170(1) and CUDA device executable code 2184 based on stored HIP source code 2130.

An example kernel may be translated by CUDA-to-HIP translation tool 2120 of FIG. 21, in accordance with at least one embodiment. CUDA source code 2110 partitions an overall problem that a given kernel is designed to solve into relatively coarse sub-problems that can independently be solved using thread blocks. Each thread block includes any number of threads. Each sub-problem can be partitioned into relatively fine pieces that can be solved cooperatively in parallel by threads within a thread block. Threads within a thread block can cooperate by sharing data through shared memory and by synchronizing execution to coordinate memory accesses.

CUDA source code 2110 can organize thread blocks associated with a given kernel into a one-dimensional, a two-dimensional, or a three-dimensional grid of thread blocks. Each thread block includes any number of threads, and a grid includes any number of thread blocks.

A kernel can be a function in device code that is defined using a “_global_” declaration specifier. The dimension of a grid that executes a kernel for a given kernel call and associated streams may be specified using a CUDA kernel launch syntax. CUDA kernel launch syntax is specified as “KernelName<<<GridSize, BlockSize, SharedMemorySize, Stream>>>(KernelArguments);”. An execution configuration syntax can include a “<<< . . . >>>” construct that is inserted between a kernel name (“KernelName”) and a parenthesized list of kernel arguments (“KernelArguments”). CUDA kernel launch syntax can include a CUDA launch function syntax instead of an execution configuration syntax.

“GridSize” can be of a type dim3 and specify the dimension and size of a grid. Type dim3 may be a CUDA-defined structure that includes unsigned integers x, y, and z. If z is not specified, then z may default to one. If y is not specified, then y may default to one. The number of thread blocks in a grid can be equal to the product of GridSize.x, GridSize.y, and GridSize.z. “BlockSize” can be of type dim3 and specify the dimension and size of each thread block. The number of threads per thread block may be equal to the product of BlockSize.x, BlockSize.y, and BlockSize.z. Each thread that executes a kernel may be given a unique thread ID that is accessible within the kernel through a built-in variable (e.g., “threadIdx”).

With respect to CUDA kernel launch syntax, “SharedMemorySize” may be an optional argument that may specify a number of bytes in a shared memory that is dynamically allocated per thread block for a given kernel call in addition to statically allocated memory. With respect to CUDA kernel launch syntax, SharedMemorySize may default to zero. With respect to CUDA kernel launch syntax, “Stream” may be an optional argument that specifies an associated stream and defaults to zero to specify a default stream. A stream may be a sequence of commands (possibly issued by different host threads) that execute in order. Different streams may execute commands out of order with respect to one another or concurrently.

CUDA source code 2110 may include a kernel definition for an example kernel “MatAdd” and a main function. Main function may be host code that executes on a host and includes a kernel call that causes kernel MatAdd to execute on a device. Kernel MatAdd can add two matrices A and B of size N×N, where N is a positive integer, and store the result in a matrix C. Main function can define a threadsPerBlock variable as 16 by 16 and a numBlocks variable as N/16 by N/16. Main function can then specify kernel call “MatAdd<<21 numBlocks, threadsPerBlock>>>(A, B, C);”. As per CUDA kernel launch syntax, kernel MatAdd can be executed using a grid of thread blocks having a dimension N/16 by N/16, where each thread block has a dimension of 16 by 16. Each thread block can include 256 threads, a grid can be created with enough blocks to have one thread per matrix element, and each thread in such a grid may execute kernel MatAdd to perform one pair-wise addition.

While translating CUDA source code 2110 to HIP source code 2130, CUDA to HIP translation tool 2120 may translate each kernel call in CUDA source code 2110 from CUDA kernel launch syntax to a HIP kernel launch syntax and may convert any number of other CUDA calls in source code 2110 to any number of other functionally similar HIP calls. HIP kernel launch syntax can be specified as “hipLaunchKernelGGL(KernelName,GridSize, BlockSize, SharedMemorySize, Stream, KernelArguments);”. Each of KernelName, GridSize, BlockSize, ShareMemorySize, Stream, and KernelArguments can have the same meaning in HIP kernel launch syntax as in CUDA kernel launch syntax (described previously herein). Arguments SharedMemorySize and Stream can be required in HIP kernel launch syntax and can be optional in CUDA kernel launch syntax.

A portion of HIP source code 2130 can be identical to a portion of CUDA source code 2110 depicted except for a kernel call that causes kernel MatAdd to execute on a device. Kernel MatAdd may be defined in HIP source code 2130 with the same “_global_” declaration specifier with which kernel MatAdd is defined in CUDA source code 2110. A kernel call in HIP source code 2130 may be “hipLaunchKernelGGL(MatAdd, numBlocks, threadsPerBlock, 0, 0, A, B, C);”, while a corresponding kernel call in CUDA source code 2110 is “MatAdd<<<numBlocks, threadsPerBlock>>>(A, B, C);”.

Other implementations are contemplated and can be performed similarly to the CUDA and HIP implementations above, such as oneAPI, OpenCL, and other programming platforms. Code can be translated in any direction. For example, CUDA can be translated to HIP, and CUDA can be translated to OpenCL. SnuCL-Tr and CUCL can be used to translate OpenCL to CUDA or CUDA to OpenCL, respectively. Compiled code or intermediate representations (e.g., CUDA PTX code) can also be translated to run on other processor platforms (e.g., AMD or Intel). For example, PTX code can be translated to run on Intel or AMD processors using a translation tool, such as ZLUDA.

One or more techniques described herein can utilize a oneAPI programming model. A oneAPI programming model can refer to a programming model for interacting with various compute accelerator architectures. OneAPI may refer to an application programming interface (API) designed to interact with various compute accelerator architectures. A oneAPI programming model may utilize a DPC++ programming language. A DPC++ programming language may refer to a high-level language for data parallel programming productivity. A DPC++ programming language can be based at least in part on C and/or C++ programming languages. A oneAPI programming model can be a programming model such as, but not limited to, those developed by Intel Corporation of Santa Clara, CA.

OneAPI and/or oneAPI programming model can be utilized to interact with various accelerator, GPU, processor, and/or variations thereof, architectures. OneAPI may include a set of libraries that implement various functionalities. OneAPI may include at least a oneAPI DPC++ library, a oneAPI math kernel library, a oneAPI data analytics library, a oneAPI deep neural network library, a oneAPI collective communications library, a oneAPI threading building blocks library, a oneAPI video processing library, and/or variations thereof.

A oneAPI DPC++ library, also referred to as oneDPL, can be a library that implements algorithms and functions to accelerate DPC++ kernel programming. OneDPL may implement one or more standard template library (STL) functions. OneDPL can implement one or more parallel STL functions. OneDPL can provide a set of library classes and functions such as, but not limited to, parallel algorithms, iterators, function object classes, range-based API, and/or variations thereof. OneDPL can implement one or more classes and/or functions of a C++ standard library. OneDPL can implement one or more random number generator functions.

A oneAPI math kernel library, also referred to as oneMKL, can be a library that implements various optimized and parallelized routines for various mathematical functions and/or operations. OneMKL can implement one or more basic linear algebra subprograms (BLAS) and/or linear algebra package (LAPACK) dense linear algebra routines. OneMKL may implement one or more sparse BLAS linear algebra routines. OneMKL can implement one or more random number generators (RNGs). OneMKL may implement one or more vector mathematics (VM) routines for mathematical operations on vectors. OneMKL may implement one or more Fast Fourier Transform (FFT) functions.

A oneAPI data analytics library, also referred to as oneDAL, can include a library that implements various data analysis applications and distributed computations. OneDAL can implement various algorithms for preprocessing, transformation, analysis, modeling, validation, and decision making for data analytics, in batch, online, and distributed processing modes of computation. OneDAL can implement various C++ and/or Java APIs and various connectors to one or more data sources. OneDAL may implement DPC++ API extensions to a traditional C++ interface and enables GPU usage for various algorithms.

A oneAPI deep neural network library, also referred to as oneDNN, can include a library that implements various deep learning functions. OneDNN may implement various neural network, machine learning, and deep learning functions, algorithms, and/or variations thereof.

A oneAPI collective communications library, also referred to as oneCCL, can include a library that implements various applications for deep learning and machine learning workloads. OneCCL can be built upon lower-level communication middleware, such as, but not limited to, message passing interface (MPI) and libfabrics. OneCCL can enable a set of deep learning specific optimizations, such as, but not limited to, prioritization, persistent operations, out of order executions, and/or variations thereof. OneCCL can implement various CPU and GPU functions.

A oneAPI threading building blocks library, also referred to as oneTBB, can include a library that implements various parallelized processes for various applications. OneTBB can be utilized for task-based, shared parallel programming on a host. OneTBB may implement generic parallel algorithms. OneTBB may implement concurrent containers. OneTBB may implement a scalable memory allocator. OneTBB may implement a work-stealing task scheduler. OneTBB may implement low-level synchronization primitives. OneTBB may be compiler-independent and usable on various processors, such as, but not limited to, GPUs, PPUs, CPUs, and/or variations thereof.

A oneAPI video processing library, also referred to as oneVPL, can include a library that is utilized for accelerating video processing in one or more applications. OneVPL can implement various video decoding, encoding, and processing functions. OneVPL can implement various functions for media pipelines on CPUs, GPUs, and other accelerators. OneVPL can implement device discovery and selection in media centric and video analytics workloads. OneVPL can implement API primitives for zero-copy buffer sharing.

A oneAPI programming model may utilize a DPC++ programming language. A DPC++ programming language can include a programming language that can include functionally similar versions of CUDA mechanisms to define device code and distinguish between device code and host code. A DPC++ programming language may include a subset of functionality of a CUDA programming language. One or more CUDA programming model operations may be performed using a oneAPI programming model using a DPC++ programming language.

Any application programming interface (API) described herein can be compiled into one or more instructions, operations, or any other signal by a compiler, interpreter, or other software tool. Compilation can include generating one or more machine-executable instructions, operations, or other signals from source code. An API compiled into one or more instructions, operations, or other signals, when performed, can cause one or more processors such as, but not limited to, processors described, e.g., in FIGS. 7-18, or any other logic circuit further described herein to perform one or more computing operations.

In at least one embodiment, translation tools described elsewhere herein, such as, but not limited to, can include one or more circuits to translate CUDA code to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription to HIP, oneAPI, OpenCL, or any other language used to perform any of the operations described above or elsewhere herein. One or more circuits can be configured by software to translate CUDA code to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription to HIP, oneAPI, OpenCL, or any other language used to perform any of the operations described above or elsewhere herein.

### Cloud and Web-Based Services

The following description sets forth, without limitation, cloud-based and/or web-based services and/or systems that can be used to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform some or all of processes, operations and/or and techniques described elsewhere herein. cloud-based and/or web-based services and/or systems can be configured by software to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein.

Cloud computing can include a style of computing in which dynamically scalable and often virtualized resources are provided as a service over the Internet. Users need not have knowledge of, expertise in, or control over technology infrastructure, which can be referred to as “in the cloud,” that supports them. Cloud computing may incorporate infrastructure as a service, platform as a service, software as a service, and other variations that have a common theme of reliance on the Internet for satisfying computing needs of users. A typical cloud deployment, such as in a private cloud (e.g., enterprise network), or a data center (DC) in a public cloud (e.g., Internet) can include thousands of servers (or alternatively, VMs), hundreds of Ethernet, Fiber Channel or Fiber Channel over Ethernet (FCoE) ports, switching and storage infrastructure, etc. A cloud can also include network services infrastructure like IPsec VPN hubs, firewalls, load balancers, wide area network (WAN) optimizers etc. Remote subscribers can access cloud applications and services securely by connecting via a VPN tunnel, such as an IPsec VPN tunnel.

Cloud computing may include a model for enabling convenient, on-demand network access to a shared pool of configurable computing resources (e.g., networks, servers, storage, applications, and services) that can be rapidly provisioned and released with minimal management effort or service provider interaction.

Cloud computing may be characterized by on-demand self-service, in which a consumer can unilaterally provision computing capabilities, such as server time and network storage, as needed automatically without requiring human inter-action with each service's provider. Cloud computing may be characterized by broad network access, in which capabilities are available over a network and accessed through standard mechanisms that promote use by heterogeneous thin or thick client platforms (e.g., mobile phones, laptops, and PDAs). Cloud computing may be characterized by resource pooling, in which a provider's computing resources are pooled to serve multiple consumers using a multi-tenant model, with different physical and virtual resources dynamically as-signed and reassigned according to consumer demand. In at least one embodiment, there is a sense of location independence in that a customer generally has no control or knowledge over an exact location of provided resources, but may be able to specify location at a higher level of abstraction (e.g., country, state, or datacenter). Examples of resources include storage, processing, memory, network bandwidth, and virtual machines. Cloud computing may be characterized by rapid elasticity, in which capabilities can be rapidly and elastically provisioned, in some cases automatically, to quickly scale out and rapidly released to quickly scale in. In at least one embodiment, to a consumer, capabilities available for provisioning often appear to be unlimited and can be purchased in any quantity at any time. Cloud computing may be characterized by measured service, in which cloud systems automatically control and optimize resource use by leveraging a metering capability at some level of abstraction appropriate to a type of service (e.g., storage, processing, bandwidth, and active user accounts). Resource usage can be monitored, controlled, and reported providing transparency for both a provider and consumer of a utilized service.

Cloud computing may be associated with various services. Cloud Software as a Service (SaaS) may refer to as service in which a capability provided to a consumer is to use a provider's applications running on a cloud infrastructure. Applications can be accessible from various client devices through a thin client interface such as a web browser (e.g., web-based email). In at least one embodiment, consumer does not manage or control underlying cloud infrastructure including network, servers, operating systems, storage, or even individual application capabilities, with a possible exception of limited user-specific application configuration settings.

Cloud Platform as a Service (PaaS) may refer to a service in which a capability provided to consumer is to deploy onto cloud infrastructure consumer-created or acquired applications created using programming languages and tools supported by a provider. In at least one embodiment, a consumer does not manage or control underlying cloud infrastructure including networks, servers, operating systems, or storage, but has control over deployed applications and possibly application hosting environment configurations.

Cloud Infrastructure as a Service (IaaS) may refer to a service in which a capability provided to a consumer is to provision processing, storage, networks, and other fundamental computing resources where a consumer is able to deploy and run arbitrary software, which can include operating systems and applications. In at least one embodiment, consumer does not manage or control underlying cloud infrastructure, but has control over operating systems, storage, deployed applications, and possibly limited control of select networking components (e.g., host firewalls).

Cloud computing may be deployed in various ways. A private cloud may refer to a cloud infrastructure that is operated solely for an organization. A private cloud may be managed by an organization or a third party and may exist on-premises or off-premises. A community cloud may refer to a cloud infrastructure that is shared by several organizations and supports a specific community that has shared concerns (e.g., mission, security requirements, policy, and compliance considerations). A community cloud may be managed by organizations or a third party and may exist on-premises or off-premises. A public cloud may refer to a cloud infrastructure that is made available to a general public or a large industry group and is owned by an organization providing cloud services. A hybrid cloud may refer to a cloud infrastructure that is a composition of two or more clouds (private, community, or public) that remain unique entities, but are bound together by standardized or proprietary technology that enables data and application portability (e.g., cloud bursting for load-balancing between clouds). A cloud computing environment is service oriented with a focus on statelessness, low coupling, modularity, and semantic interoperability.

### Logic and Neural Network Training and Deployment

The following figures set forth, without limitation, examples of logic and artificial intelligence-based systems that can be used to implement functionality and/or operations described herein.

FIG. 22A illustrate logic 2215 which, as described elsewhere herein, can be used in one or more devices or systems (e.g., such as any of the processors, data centers, cloud or web-based services described herein) to perform operations such as, but not limited to, those discussed herein, in accordance with at least one embodiment. Logic can refer to any combination of software logic, hardware logic, and/or firmware logic to provide functionality and/or operations described herein, wherein logic may be, collectively or individually, embodied as circuitry that forms part of a larger system, for example, an integrated circuit (IC), an application-specific integrated circuit (ASIC), a field programmable array (FPGA), system-on-chip (SoC), or one or processors (e.g., CPU, GPU). Logic 2215 illustrated in FIG. 22A may be used in conjunction with an application-specific integrated circuit (“ASIC”), such as, but not limited to, a TensorFlow® Processing Unit from Google, an inference processing unit (IPU) from Graphcore™, or a Nervana® (e.g., “Lake Crest”) processor from Intel Corp. Logic 2215 illustrated in FIG. 22A may be used in conjunction with central processing unit (“CPU”) hardware, graphics processing unit (“GPU”) hardware or other hardware, such as, but not limited to, field programmable gate arrays (“FPGAs”).

FIG. 22A illustrates inference and/or training logic 2215, in accordance with at least one embodiment. Inference and/or training logic 2215 may include hardware logic in which computational resources may be dedicated or otherwise exclusively used in conjunction with weight values or other information corresponding to one or more layers of neurons within a neural network. Inference and/or training logic 2215 illustrated in FIG. 22A may be used in conjunction with an application-specific integrated circuit (ASIC), such as, but not limited to, TensorFlow® Processing Unit from Google, an inference processing unit (IPU) from Graphcore™, or a Nervana® (e.g., “Lake Crest”) processor from Intel Corp. Inference and/or training logic 2215 illustrated in FIG. 22A may be used in conjunction with central processing unit (CPU) hardware, graphics processing unit (GPU) hardware or other hardware, such as, but not limited to, field programmable gate arrays (FPGAs). Inference and/or training logic 2215 can include code and/or data storage 2201 and code and/or data storage 2205, which may be used to store code (e.g., graph code), weight values and/or other information, including bias values, gradient information, momentum values, and/or other parameter or hyperparameter information. In FIG. 22A, for example, each of code and/or data storage 2201 and code and/or data storage 2205 is associated with a dedicated computational resource, such as, but not limited to, computational hardware 2202 and computational hardware 2206, respectively. Each of computational hardware 2202 and computational hardware 2206 can include one or more ALUs that perform mathematical functions, such as, but not limited to, linear algebraic functions, only on information stored in code and/or data storage 2201 and code and/or data storage 2205, respectively, result of which is stored in activation storage 2220.

Each of code and/or data storage 2201 and 2205 and corresponding computational hardware 2202 and 2206, respectively, correspond to different layers of a neural network, such that resulting activation from one storage/computational pair 2201/2202 of code and/or data storage 2201 and computational hardware 2202 is provided as an input to a next storage/computational pair 2205/2206 of code and/or data storage 2205 and computational hardware 2206, in order to mirror a conceptual organization of a neural network. Each of storage/computational pairs 2201/2202 and 2205/2206 may correspond to more than one neural network layer. Additional storage/computation pairs (not shown) subsequent to or in parallel with storage/computation pairs 2201/2202 and 2205/2206 may be included in inference and/or training logic 2215.

In at least one embodiment, logic 2215 described elsewhere herein, can include one or more circuits to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. One or more circuits in logic 2215 can be configured by software described herein, to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein.

FIG. 22B illustrates training and deployment of a deep neural network, in accordance with at least one embodiment. An untrained neural network 2226 can be trained using a training dataset 2222. Training framework 2224 can be a PyTorch framework, and/or a training framework 2204 can include a TensorFlow, Boost, Caffe, Microsoft Cognitive Toolkit/CNTK, MXNet, Chainer, Keras, Deeplearning4j, or other training framework. Training framework 2224 can train an untrained neural network 2226 and enables it to be trained using processing resources described herein to generate a trained neural network 2228. Weights may be chosen randomly or by pre-training using a deep belief network. Training may be performed in either a supervised, partially supervised, or unsupervised manner.

Untrained neural network 2226 can be trained using supervised learning, wherein training dataset 2222 includes an input paired with a desired output for an input, or where training dataset 2222 includes input having a known output and an output of neural network 2226 is manually graded. Untrained neural network 2226 can be trained in a supervised manner and processes inputs from training dataset 2222 and compares resulting outputs against a set of expected or desired outputs. Errors can then be propagated back through untrained neural network 2226. Training framework 2224 can adjust weights that control untrained neural network 2226. Training framework 2224 can include tools to monitor how well untrained neural network 2226 is converging towards a model, such as, but not limited to, trained neural network 2228, suitable to generating correct answers, such as, but not limited to, in result 2232, based on input data such as, but not limited to, a new dataset 2230. Training framework 2224 can train untrained neural network 2226 repeatedly while adjust weights to refine an output of untrained neural network 2226 using a loss function and adjustment algorithm, such as, but not limited to, stochastic gradient descent. Training framework 2224 can train untrained neural network 2226 until untrained neural network 2226 achieves a desired accuracy. Trained neural network 2228 can then be deployed to implement any number of machine learning operations.

Untrained neural network 2226 can be trained using unsupervised learning, wherein untrained neural network 2226 attempts to train itself using unlabeled data. Unsupervised learning training dataset 2222 can include input data without any associated output data or “ground truth” data. Untrained neural network 2226 can learn groupings within training dataset 2222 and can determine how individual inputs may be related to untrained dataset 2222. Unsupervised training can be used to generate a self-organizing map in trained neural network 2228 capable of performing operations useful in reducing dimensionality of new dataset 2230. Unsupervised training can also be used to perform anomaly detection, which allows identification of data points in new dataset 2230 that deviate from normal patterns of new dataset 2230.

Semi-supervised learning may be used, which is a technique in which in training dataset 2222 includes a mix of labeled and unlabeled data. Training framework 2224 may be used to perform incremental learning, such as, but not limited to, through transferred learning techniques. Incremental learning can enable trained neural network 2228 to adapt to new dataset 2230 without forgetting knowledge instilled within trained neural network 2228 during initial training.

Training framework 2224 can include a framework processed in connection with a software development toolkit such as, but not limited to, an OpenVINO (Open Visual Inference and Neural network Optimization) toolkit. An OpenVINO toolkit can include a toolkit such as, but not limited to, those developed by Intel Corporation of Santa Clara, CA.

OpenVINO can include a toolkit for facilitating development of applications, specifically neural network applications, for various tasks and operations, such as, but not limited to, human vision emulation, speech recognition, natural language processing, recommendation systems, and/or variations thereof. OpenVINO can support neural networks such as, but not limited to, convolutional neural networks (CNNs), recurrent and/or attention-based neural networks, and/or various other neural network models. OpenVINO can support various software libraries such as, but not limited to, OpenCV, OpenCL, and/or variations thereof.

OpenVINO can support neural network models for various tasks and operations, such as, but not limited to, classification, segmentation, object detection, face recognition, speech recognition, pose estimation (e.g., humans and/or objects), monocular depth estimation, image inpainting, style transfer, action recognition, colorization, and/or variations thereof.

OpenVINO can include one or more software tools and/or modules for model optimization, also referred to as a model optimizer. A model optimizer can include a command line tool that facilitates transitions between training and deployment of neural network models. A model optimizer may optimize neural network models for execution on various devices and/or processing units, such as, but not limited to, a GPU, CPU, PPU, GPGPU, and/or variations thereof. A model optimizer can generate an internal representation of a model, and can optimize said model to generate an intermediate representation. A model optimizer may reduce a number of layers of a model. A model optimizer can remove layers of a model that may be utilized for training. A model optimizer may perform various neural network operations, such as, but not limited to, modifying inputs to a model (e.g., resizing inputs to a model), modifying a size of inputs of a model (e.g., modifying a batch size of a model), modifying a model structure (e.g., modifying layers of a model), normalization, standardization, quantization (e.g., converting weights of a model from a first representation, such as, but not limited to, floating point, to a second representation, such as, but not limited to, integer), and/or variations thereof.

OpenVINO can include one or more software libraries for inferencing, also referred to as an inference engine. An inference engine can include a C++ library, or any suitable programming language library. An inference engine can be utilized to infer input data. An inference engine may implement various classes to infer input data and generate one or more results. An inference engine can implement one or more API functions to process an intermediate representation, set input and/or output formats, and/or execute a model on one or more devices.

OpenVINO may provide various abilities for heterogeneous execution of one or more neural network models. Heterogeneous execution, or heterogeneous computing, can refer to one or more computing processes and/or systems that utilize one or more types of processors and/or cores. OpenVINO can provide various software functions to execute a program on one or more devices. OpenVINO may provide various software functions to execute a program and/or portions of a program on different devices. OpenVINO may provide various software functions to, for example, run a first portion of code on a CPU and a second portion of code on a GPU and/or FPGA. OpenVINO may provide various software functions to execute one or more layers of a neural network on one or more devices (e.g., a first set of layers on a first device, such as, but not limited to, a GPU, and a second set of layers on a second device, such as, but not limited to, a CPU).

OpenVINO can include various functionality similar to functionalities associated with a CUDA programming model, such as, but not limited to, various neural network model operations associated with frameworks such as, but not limited to, TensorFlow, PyTorch, and/or variations thereof. One or more CUDA programming model operations may be performed using OpenVINO. Various systems, methods, and/or techniques described herein may be implemented using OpenVINO.

In at least one embodiment, one or more circuits can be used to cause one or more neural networks and training frameworks described elsewhere herein to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein. One or more neural networks and training frameworks can be configured by software to generate respective document transcriptions of one or more document images using one or more neural networks, wherein the respective document transcriptions comprise document content and descriptive information of the document content; and detect an error in the document content of at least one document transcription of the respective document transcriptions based, at least in part, on a syntax error identified in the descriptive information of the at least one document transcription or otherwise perform any of the operations described above or elsewhere herein.

At least one embodiment of the disclosure can be described in view of the following clauses:

1. A processor, comprising:
one or more circuits to:
generate respective document transcriptions of one or more document images using one or more neural networks, wherein the respective document transcriptions comprise document content and descriptive information of the document content; and
detect an error in the document content of at least one document transcription of the respective document transcriptions based, at least in part, on a syntax error identified in the descriptive information of the at least one document transcription.

2. The processor of clause 1, wherein the syntax error is identified according to at least one of
structural information in the descriptive information; or
a semantic class label in the descriptive information.

3. The processor of any one of clauses 1-2, wherein the at least one document transcription comprises a sequence of tokens, the sequence of tokens including one or more content tokens that comprise an encoded representation of the document content, and one or more description tokens that comprise an encoded representation of the descriptive information of the document content.

4. The processor of clause 3, wherein the syntax error is identified according to a missing description token in the sequence of tokens.

5. The processor of clause 3, wherein the syntax error is found in one of the one or more description tokens.

6. The processor of any one of clauses 1-5, wherein error evaluation of the at least one document transcription continues after the detection of the error.

7. The processor of clause 1, wherein the one or more neural networks are a Multimodal Large Language Model (MLLM) comprising at least one of an encoder, a compressor, or a decoder.

8. A method, comprising:
generating, by one or more processors, respective document transcriptions of one or more document images using one or more neural networks, wherein the respective document transcriptions comprise document content and descriptive information of the document content; and
detecting, by the one or more processors, an error in the document content of at least one document transcription of the respective document transcriptions based, at least in part, on a syntax error identified in the descriptive information of the at least one document transcription.

9. The method of clause 8, wherein the syntax error is identified according to at least one of
structural information in the descriptive information; or
a semantic class label in the descriptive information.

10. The method of any one of clauses 8-9, wherein the at least one document transcription comprises a sequence of tokens, the sequence of tokens including one or more content tokens that comprise an encoded representation of the document content, and one or more description tokens that comprise an encoded representation of the descriptive information of the document content.

11. The method of clause 10, wherein the syntax error is identified according to a missing description token in the sequence of tokens.

12. The method of clause 10, wherein the syntax error is found in one of the one or more description tokens.

13. The method of any one of clauses 8-12, wherein error evaluation of the at least one document transcription continues after the detection of the error.

14. The method of any one of clauses 8-13, wherein the one or more neural networks are a Multimodal Large Language Model (MLLM) comprising at least one of an encoder, a compressor, or a decoder.

15. A system, comprising:
one or more processors to:
generate respective document transcriptions of one or more document images using one or more neural networks, wherein the respective document transcriptions comprise document content and descriptive information of the document content; and
detect an error in the document content of at least one document transcription of the respective document transcriptions based, at least in part, on a syntax error identified in the descriptive information of the at least one document transcription.

16. The system of clause 15, wherein the syntax error is identified according to at least one of
structural information in the descriptive information; or
a semantic class label in the descriptive information.

17. The system of any one of clauses 15-16, wherein the at least one document transcription comprises a sequence of tokens, the sequence of tokens including one or more content tokens that comprise an encoded representation of the document content, and one or more description tokens that comprise an encoded representation of the descriptive information of the document content.

18. The system of clause 17, wherein the syntax error is identified according to a missing description token in the sequence of tokens.

19. The system of clause 17, wherein the syntax error is found in one of the one or more description tokens.

20. The system of any one of clauses 15-19, wherein error evaluation of the at least one document transcription continues after the detection of the error.

As will be apparent to one of ordinary skill in the art, other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Use of “may” and/or “can” is intended to indicate by way of example without limiting any particular embodiment or component or other function described above, below, or elsewhere herein. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as, but not limited to, phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). Number of items in a plurality can be at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. A process such as, but not limited to, those processes described herein (or variations and/or combinations thereof) can be performed under control of one or more computer systems configured with executable instructions and is implemented as code (e.g., executable instructions, one or more computer programs or one or more applications) executing collectively on one or more processors, by hardware or combinations thereof. Code can be stored on a computer-readable storage medium, for example, in form of a computer program comprising a plurality of instructions executable by one or more processors. A computer-readable storage medium can be a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. Code (e.g., executable code or source code) can be stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media can include multiple non-transitory computer-readable storage media and one or more of individual non-transitory storage media of multiple non-transitory computer-readable storage media lack all of code while multiple non-transitory computer-readable storage media collectively store all of code. Executable instructions can be executed such that different instructions are executed by different processors—for example, a non-transitory computer-readable storage medium store instructions and a main central processing unit (“CPU”) executes some of instructions while a graphics processing unit (“GPU”) executes other instructions. Different components of a computer system can have separate processors and different processors execute different subsets of instructions.

An arithmetic logic unit can include a set of combinational logic circuitry that takes one or more inputs to produce a result. An arithmetic logic unit can be used by a processor to implement mathematical operation such as, but not limited to, addition, subtraction, or multiplication. An arithmetic logic unit is used to implement logical operations such as, but not limited to, logical AND/OR or XOR. An arithmetic logic unit can be stateless, and made from physical switching components such as, but not limited to, semiconductor transistors arranged to form logical gates. An arithmetic logic unit may operate internally as a stateful logic circuit with an associated clock. An arithmetic logic unit may be constructed as an asynchronous logic circuit with an internal state not maintained in an associated register set. An arithmetic logic unit can be used by a processor to combine operands stored in one or more registers of the processor and produce an output that can be stored by the processor in another register or a memory location.

As a result of processing an instruction retrieved by the processor, the processor may present one or more inputs or operands to an arithmetic logic unit, causing the arithmetic logic unit to produce a result based at least in part on an instruction code provided to inputs of the arithmetic logic unit. The instruction codes provided by the processor to the ALU may be based at least in part on the instruction executed by the processor. Combinational logic in the ALU may process the inputs and produces an output which is placed on a bus within the processor. A processor can select a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

One or more components of systems and/or processors disclosed above can communicate with one or more CPUs, ASICs, GPUs, FPGAs, or other hardware, circuitry, or integrated circuit components that include, e.g., an upscaler or upsampler to upscale an image, an image blender or image blender component to blend, mix, or add images together, a sampler to sample an image (e.g., as part of a DSP), a neural network circuit that is configured to perform an upscaler to upscale an image (e.g., from a low resolution image to a high resolution image), or other hardware to modify or generate an image, frame, or video to adjust its resolution, size, or pixels; one or more components of systems and/or processors disclosed above can use components described in this disclosure to perform methods, operations, or instructions that generate or modify an image.

Computer systems can be configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or example language (e.g., “such as, but not limited to,”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as, but not limited to, “processing,” “computing,” “calculating,” “determining,” or like, refer to action and/or processes of a computer or computing system, or similar electronic computing device, that manipulate and/or transform data represented as physical, such as, but not limited to, electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as, but not limited to, tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

References may be made to obtaining, acquiring, receiving, or inputting analog or digital data into a subsystem, computer system, or computer-implemented machine. Processes of obtaining, acquiring, receiving, or inputting analog and digital data can be accomplished in a variety of ways such as, but not limited to, by receiving data as a parameter of a function call or a call to an application programming interface. Processes of obtaining, acquiring, receiving, or inputting analog or digital data can be accomplished by transferring data via a serial or parallel interface. Processes of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as example forms of implementing the claims.

What is claimed is:

1. A processor, comprising:
one or more circuits to:
generate respective document transcriptions of one or more document images using one or more neural networks, wherein the respective document transcriptions comprise document content and descriptive information of the document content; and
detect an error in the document content of at least one document transcription of the respective document transcriptions based, at least in part, on a syntax error identified in the descriptive information of the at least one document transcription.

2. The processor of claim 1, wherein the syntax error is identified according to at least one of:
structural information in the descriptive information; or
a semantic class label in the descriptive information.

3. The processor of claim 1, wherein the at least one document transcription comprises a sequence of tokens, the sequence of tokens including one or more content tokens that comprise an encoded representation of the document content, and one or more description tokens that comprise an encoded representation of the descriptive information of the document content.

4. The processor of claim 3, wherein the syntax error is identified according to a missing description token in the sequence of tokens.

5. The processor of claim 3, wherein the syntax error is found in one of the one or more description tokens.

6. The processor of claim 1, wherein error evaluation of the at least one document transcription continues after the detection of the error.

7. The processor of claim 1, wherein the one or more neural networks are a Multimodal Large Language Model (MLLM) comprising at least one of an encoder, a compressor, or a decoder.

8. A method, comprising:
generating, by one or more processors, respective document transcriptions of one or more document images using one or more neural networks, wherein the respective document transcriptions comprise document content and descriptive information of the document content; and
detecting, by the one or more processors, an error in the document content of at least one document transcription of the respective document transcriptions based, at least in part, on a syntax error identified in the descriptive information of the at least one document transcription.

9. The method of claim 8, wherein the syntax error is identified according to at least one of:
structural information in the descriptive information; or
a semantic class label in the descriptive information.

10. The method of claim 8, wherein the at least one document transcription comprises a sequence of tokens, the sequence of tokens including one or more content tokens that comprise an encoded representation of the document content, and one or more description tokens that comprise an encoded representation of the descriptive information of the document content.

11. The method of claim 10, wherein the syntax error is identified according to a missing description token in the sequence of tokens.

12. The method of claim 10, wherein the syntax error is found in one of the one or more description tokens.

13. The method of claim 8, wherein error evaluation of the at least one document transcription continues after the detection of the error.

14. The method of claim 8, wherein the one or more neural networks are a Multimodal Large Language Model (MLLM) comprising at least one of an encoder, a compressor, or a decoder.

15. A system, comprising:
one or more processors to:
generate respective document transcriptions of one or more document images using one or more neural networks, wherein the respective document transcriptions comprise document content and descriptive information of the document content; and
detect an error in the document content of at least one document transcription of the respective document transcriptions based, at least in part, on a syntax error identified in the descriptive information of the at least one document transcription.

16. The system of claim 15, wherein the syntax error is identified according to at least one of:
structural information in the descriptive information; or
a semantic class label in the descriptive information.

17. The system of claim 15, wherein the at least one document transcription comprises a sequence of tokens, the sequence of tokens including one or more content tokens that comprise an encoded representation of the document content, and one or more description tokens that comprise an encoded representation of the descriptive information of the document content.

18. The system of claim 17, wherein the syntax error is identified according to a missing description token in the sequence of tokens.

19. The system of claim 17, wherein the syntax error is found in one of the one or more description tokens.

20. The system of claim 15, wherein error evaluation of the at least one document transcription continues after the detection of the error.
